(19) United States
(12) Patent Application Publication
(10) Pub. No.: US 2004/0157176 A1
(43) Pub. Date: Aug. 12, 2004

(54) Silver halide emulsion, preparation method thereof and silver halide photographic material

(75) Inventors: Toshiya Kondo, Tokyo (JP); Shuji Murakami, Matsuda-machi (JP); Koichiro Kuroda, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/769,782

(22) Filed: Feb. 3, 2004

(30) Foreign Application Priority Data
Feb. 6, 2003 (JP) JP2003-029472

(51) Int. Cl. G03C 1/06

(52) U.S. Cl. 430/605; 430/604; 430/607; 430/609; 430/610; 430/600; 430/603

(57) ABSTRACT

A silver halide emulsion which exhibits superior latent image stability when subjected to subjected to digital exposure at a high intensity for a short time is disclosed, comprising silver halide gains containing at least 90 mol % chloride, 0.02 to 5.0 mol % bromide and 0 to 2.0 mol % iodide, based on silver and occluding at least one Group 8 metal compounds and at least one iridium compound, and the silver halide grains are subjected to selenium sensitization which is undergone in the presence of at least one of compounds represented by the following formulas and silver or gold sulfide grains. A preparation method of the emulsion is also disclosed.

R—SO₂S—M

R₁—SO₂S—R₂

R₃—SO₂S—Lₘ—SSO₂—R

R₁₁—(S)ₘ₁—R₁₂

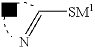

### FIELD OF THE INVENTION

The present invention relates to a silver halide photographic emulsion exhibiting enhanced sensitivity, relatively high contrast, improved coating solution stability and superior latent image stability, specifically when subjected to high intensity, short time exposure and leading to stable high quality prints, a preparation method thereof, and a silver halide photographic material by the use thereof.

### BACKGROUND OF THE INVENTION

Recent rapid tendency toward to digitization has led to increased opportunities of subjecting silver halide photographic materials to digital exposure. Along with such a trend, photographic color paper, as a photographic material for color prints, is desired with respect to suitability for exposure at a relatively high intensity for an extremely short time at the level of milli-seconds to nano-seconds and an aptitude for scanning exposure. Further advancements of photographic materials which are advantageous in image quality, cost and mass productivity have been desired along with rapid progress of other non-silver output media such as ink-jet printing systems.

There have been employed silver chloride emulsions or high chloride silver halide emulsions in color paper to achieve rapid processability. Further, it is commonly known that doping iridium compounds is effective to improve reciprocity law failure characteristics as a matter of properties of silver halide emulsions. There are disclosed silver high chloride halide emulsion grains having a high bromide region in the vicinity of the corners of the grains, as described in JP-A No. 64-26837 (hereinafter, the term JP-A refers to Japanese Patent Application publication; silver high chloride halide emulsion grains in which a bromide-localized region is selectively doped with an iridium compound, thereby leading to superior latent image stability and reciprocity law failure characteristics, as described in JP-A No. 1-105940. There is also disclosed a method of forming a bromide-localized region by using fine silver bromide grains doped with an iridium compound, as described in U.S. Pat. No. 5,627,020. However, neither of the foregoing methods was sufficient for improving latent image stability in the initial stage after exposure. JP-A Nos. 6-235992 and 6-235993 disclose techniques for improving contrast using a silver halide emulsion containing a Group 8 metal compound and a nitrosyl or thionitrosyl complex of Groups 5 to 10 elements, JP-A No. 10-293377 discloses a silver halide emulsion using an imidazole complex or other organic ligand complex of ruthenium, and JP-A No. 11-202440 discloses a silver halide emulsion using an iridium complex containing an aquo ligand. However, knowledge regarding fogging and latent image stability is still insufficient.

In a digital exposure system of the recent subject, it was proved that sufficient practical qualities were not achievable only by known techniques for improving latent image stability, and in exposure suitability at a high intensity for an extremely short time. Techniques adaptable to such a digital exposure system include, for examples, chemical sensitization and spectral sensitization suitable for formation of a bromide-localized phase, as described in JP-A No. 11-109534, and the use of a silver iodochloride emulsion, as described in JP-A Nos. 9-166836 and 9-101587. However, it was proved by studies of the inventors of this application that the foregoing techniques for improving aptitude for digital exposure was not only insufficient for improving latent image stability but also resulted in marked deteriorated pressure resistance and pre-exposure storage stability of photographic materials. Therefore, the foregoing techniques disclosed were still insufficient.

JP-A No. 2001-188311 discloses a method for improving reciprocity law failure and coating solution stability, in which silver halide grains contain a bromide-rich or iodide-rich phase in the vicinity of the grain surface and introduction of such a rich phase is separated into two occasions, before and after addition of mercapto compounds. However, it was proved that using only this method was insufficient for improving storage stability of silver halide emulsions.

JP-A Nos. 6-19024 and 6-19026 disclose that adding non-labile di-chalcogen compounds before or during formation of silver halide grains, or during spectral/chemical sensitization of a silver halide emulsion improves fresh fog or aging fog. Further, JP-A No. 6-19037 discloses adding such compounds in the form of a solid particle dispersion and JP-A No. 6-35147 discloses that a silver chloride emulsion containing a diaminodisulfide compound and a sulfonate compound at a weight ratio of 1:1 to 1:20 improves storage stability and performance variation caused by temperature fluctuation at the time of exposure on color photographic materials. JP-A No. 6-202265 discloses that adding a specific disulfide compound and a specific sulfionate or seleninate compound among the compounds represented by formula (3) of this invention before or during spectral/chemical sensitization results in reduced fogging and enhanced sensitivity. There is also disclosed a photographic element comprising a silver chloride emulsion including a water-soluble disulfide compound, leading to reduced fogging, reduced variation in fog density and sensitivity after pre-exposure storage and reduced variation in sensitivity due to temperature fluctuation at the time of exposure, as described in JP-A No. 7-72580.

However, neither of the foregoing methods was sufficient in description and effectiveness with respect to latent image stability, storage stability and pressure resistance, specifically latent image stability, storage stability and pressure resistance of emulsions exposed at a high intensity.

Although there are disclosures mainly concerning fundamental manufacturing techniques of fine grains of silver sulfide, gold sulfide and gold-silver sulfide, and silver sulfide sol, for example, in JP-A No. 2-198443 and JP-B No. 2929325 (hereinafter, the term JP-B refers to Japanese Patent Publication), information is still insufficient regarding application to recent practical photographic emulsions and practical photographic materials, and improvements in performance.

There is disclosed a photographic element comprising silver chloride grains containing a selenium compound on the grain surface, for example in JP-A No. 5-66513 and U.S. Pat. No. 5,240,827. However, these disclosures are unclear with regard to improvement effects in photographic performance other than sensitivity and, in particular, having no description regarding halide composition and dopants which are supposed to be indispensable for enhancing contrast, latent image stability and other required photographic performance in photographic materials for prints, so that it has been difficult to provide a practical silver halide photographic material satisfying photographic performances recently desired. JP-A Nos. 5-313293, 9-5922 and 9-5924 disclose silver halide photographic materials in which selenium or tellurium sensitization has been applied to high chloride silver halide grains or silver chlorobromide grains and which are unclear with respect to an improvement in performance such as latent image stability or coating solution stability and insufficient in sensitivity and contrast to respond to the recent demand for improved photographic material.

### SUMMARY OF THE INVENTION

Accordingly, it is an object of the present invention to provide a silver halide photographic emulsion exhibiting enhanced sensitivity, relatively high contrast, improved coating solution stability and superior latent image stability specifically when subjected to subjected to digital exposure at a relatively high intensity for a short time and leading to stable high quality prints, a preparation method thereof, and a silver halide photographic material by the use thereof.

In one aspect the present invention is directed to a method of preparing a silver halide emulsion comprising silver halide grains containing at least 90 mol % chloride, 0.02 to 5.0 mol % bromide and 0 to 2.0 mol % iodide, based on silver and occluding at least two Group 8 metal compounds including at least one iridium compound in the interior of the grains, the method comprising the steps of (i) forming the silver halide grains by mixing a silver salt and a halide salt and (ii) subjecting the silver formed silver halide grains to selenium sensitization, wherein in the step (ii), the selenium sensitization is performed in the presence of at least one selected from the group of a compound represented by formula (1), (2) or (3), a compound represented by formula (4), fine grains of at least one of silver sulfide, gold sulfide and silver-gold sulfide, and a compound represented by formula (S):

R—SO₂S—M formula (1)

R₁—SO₂S—R₂ formula (2)

R₃—SO₂S—Lₘ—SSO₂—R₄ formula (3)

wherein R, R₁, R₂, R₃, and R₄ are each an aliphatic group, an aromatic group or a heterocyclic group; M is a cation; L is a divalent linkage group; and m is 0 or 1;

R₁₁—(S)ₘ₁—R₁₂ formula (4)

wherein R₁₁ and R₁₂ are each an aliphatic group, an aromatic group or a heterocyclic group, or R₁₁ and R₁₂ are atomic groups which combine with each other to form a ring; m1 is an integer of 2 to 6;

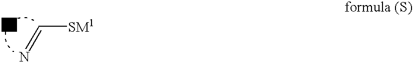

wherein Q is an atomic group necessary to form a 5- or 6-membered nitrogen-containing ring; M¹ is a hydrogen atom, an alkali metal or a cation group.

In another aspect the present invention is directed to a silver halide emulsion comprising silver halide grains (a) containing at least 90 mol % chloride, 0.02 to 5.0 mol % bromide and 0 to 2.0 mol % iodide, based on silver, (b) occluding at least two Group 8 metal compounds including at least one iridium compound in the interior of the grains and (c) the silver halide emulsion being prepared by a process comprising (i) forming the silver halide grains and (ii) subjecting the silver halide grains to selenium sensitization, wherein in the step (ii), the selenium sensitization is performed in the presence of at least one selected from the group of a compound represented by formula (1), (2) or (3), a compound represented by formula (4), fine grains of at least one of silver sulfide, gold sulfide and silver-gold sulfide, and a compound represented by formula (S) as described above.

In another aspect, the present invention is directed to a silver halide photographic material comprising on a support at least one image forming layer, wherein the image forming layer comprises a silver halide emulsion as described above.

### DETAILED DESCRIPTION OF THE INVENTION

Silver halide grains included in the silver halide emulsion relating to this invention have an average chloride content of at least 90 mol %, preferably at least 95 mol %, and more preferably at least 97 mol %, based on silver. The silver halide grains also have an average iodide content of 0 to 2.0 mol %, preferably 0.01 to 1.0 mol % and more preferably 0.02 to 0.5 mol %, based on silver.

The silver halide grains relating to this invention preferably have at least one iodide-localized silver halide phase in the interior of the grains. In the invention, the interior of the grains refers to a silver halide phase, except for the grain surface. The iodide-localized silver halide phase (hereinafter, also denoted as iodide-localized phase) is a silver halide phase having at least two times the average iodide content of the grains, preferably at least three times the average iodide content, and more preferably at least 5 times the average iodide content. The iodide-localized phase is located in a portion external to 60% (preferably 70%, and more preferably 80%) of the grain volume within the grain. In other words, the iodide-localized phase is located in an exterior region outside the interior region accounting for at least 60% of the total silver forming the grains. The iodide-localized phase is located in a portion external to preferably 70%, and more preferably 80% of the grain volume within the grain.

In one embodiment of this invention, the iodide-localized phase is in a layer form in the interior of the grains (which is, hereinafter, referred to as iodized localized layer). It is preferred to introduce at least two of such iodide-localized layers. In this case, the main layer is introduced under the conditions described above and at least a layer having an iodide content less than the maximum iodide content (also denoted as a sub-layer) is introduced so that the sub-layer is located nearer to the grain surface than the main layer. Iodide contents of the main layer and sub-layer can be optionally selected according to the object. It is preferred in terms of latent image stability that the main layer has an iodide content as high as possible and the sub-layer has an iodide content less than that of the main phase.

In another preferred embodiment of this invention, a iodide-localized phase is located near the corners, at edges or on the outermost surface of the grain. The iodide-localized phase can be introduced using a variety of iodine compounds. Examples thereof include the use of an aqueous iodide salt solution, such as an aqueous potassium iodide solution, the use of a polyiodide compound, as described in S. Nakahara “Mukikagobutsu-Sakutai Jiten” (Dictionary of Inorganic Compound and Complex, page 944, published by Kodan-sha) and the use of fine iodide-containing silver halide grains or iodide ion-releasing agents, as disclosed in JP-A No. 2-68538. The use of potassium iodide or a polyiodide of I₄ or higher is preferred, and the use of a polyiodide of I₄ or higher is more preferred in terms of rapid processability and process stability. The iodide content of the iodide-localized phase can be controlled by arbitrarily adjusting a concentration or a quantity of an iodide containing solution.

Silver halide grains included in a silver halide emulsion relating to this invention usually have an average bromide content of 0.02 to 5.0 mol %, preferably 0.03 to 3.0 mol %, and more preferably 0.05 to 2.0 mol %, based on silver. In the silver halide grains, the bromide containing silver halide phase preferably accounts for 50 to 100%, and more preferably 70 to 100% of the grain volume.

A silver halide emulsion comprising silver halide grains having a high bromide portion within the grain is also preferred in this invention. The high bromide portion may be formed by an epitaxial junction or by forming a core/shell structure. Alternatively, there may exist regions partially differing in bromide composition without forming a complete layer. The bromide composition may be continuously varied or discontinuously varied, and silver halide grains having a bromide-localized phase in the vicinity of corners of the grain are preferred. The expression bromide-localized phase herein means a silver halide phase having a relatively high bromide content. Thus, the bromide-localized phase has a bromide content of at least two times the average overall bromide content of the grains, preferably at least three times and more preferably at least 5 times the average overall bromide content. The bromide-localized phase preferably contains a Group 8 metal compound, as described later. The Group 8 metal compound is preferably an iridium complex compound.

Silver halide grains relating to this invention each occludes at least two kinds of compounds each containing a metal in Group 8 of the periodical table of elements (which is hereinafter also denoted simply as a Group 8 metal compound), which include at least one iridium compound. Thus, it is preferred to occlude at least one Group 8 metal compound and at least one iridium compound. It is more preferred to occlude at least three kinds of Group 8 metal compounds including at least two iridium compounds. Inclusion of at least three iridium compounds is still more preferred. The iridium compound is preferably an iridium coordination complex containing at least one water (or aqua) ligand and/or an organic ligand, as described below. It is still more preferred that silver halide grains occlude at least four kinds of Group 8 metal compounds, and furthermore preferably at least five kinds of Group 8 metal compounds in the interior of the grains.

The silver halide emulsion grains relating to this invention preferably occlude at least one Group 8 metal cyano complex, besides the foregoing iridium compound.

The Group 8 metal compounds usable in this invention is preferably a compound containing a metal selected from iron iridium, rhodium, osmium, ruthenium, cobalt and platinum, which are chosen from metal atoms, metal ions, their complexes or salts (complex salts), and compounds including the foregoing, and preferably from metal complexes. Of metal complexes, six-coordinate complex, five-coordinate complex, four-coordinate complex and two-coordinate complex are preferred and six-coordinate complex and four-coordinate complex are more preferred. Any ligand is usable and examples of a ligand include carbonyl ligand, fulminate ligand, thiocyanate ligand, nitrosyl ligand, thionitrosyl ligand, cyano ligand, water (or aquo-) ligand, halogen ligand, ligands of ammonia, a hydroxide, nitrous acid, sulfurous acid and a peroxide and organic ligands. Of these, it is preferred to contain at least one ligand selected from nitrosyl ligand, thionitrosyl ligand, cyano ligand, water ligand, halogen ligand and an organic ligand. In this invention, the organic ligand refers to a compound containing at least one of H—C, C—C and C—N—H bonds and capable of being coordinated with a metal ion. Preferred organic ligands usable in this invention include a compound selected from pyridine, pyrazine, pyrimidine, pyrane, pyridazine, imidazole, thiazole, isothiazole, triazole, pyrazole, furan, furazane, oxazole, isooxazole, thiophene, phenthroline, bipyridine and ethylenediamine, their ions and compounds substituted with the foregoing compounds.

Preferred in this invention is occlusion of at least a compound represented by the following formula (A):

R²¹ₙₐ[M²¹X²¹ₘₐY²¹₆₋ₘₐ] formula (A)

wherein M²¹ is a metal selected from Group 8 elements of the periodical table (which is preferably iron, cobalt, ruthenium, iridium, rhodium, osmium or platinum, and more preferably iron, ruthenium, iridium, rhodium, or osmium); R²¹ is an alkali metal (which is preferably cesium, sodium or potassium); “ma” is an integer of 0 to 6, and “na” is an integer of 0 to 4; X²¹ and Y²¹ are each a ligand, including carbonyl ligand, fulminate ligand, thiocyanate ligand, nitrosyl ligand, thionitrosyl ligand, cyano ligand, aqua ligand, halogen ligand, ligands of ammonia, a hydroxide, nitrous acid, sulfurous acid and a peroxide and organic ligands.

Specific examples of the Group 8 metal compound and Group 8 metal complex are shown below but are by no means limited to these. Any counter cation is usable, including potassium ion, calcium ion, sodium ion ammonium ion. Counter anions for the metal complex include nitrate ion, halide ion and perchlorate ion.

| | |
|---|---|
| A-1: K₂[IrCl₆] | A-2: K₃[IrCl₆] |
| A-3: K₂[Ir(CN)6] | A-4: K₃[Ir(CN)₆] |
| A-5: K₂[Ir(NO)Cl₅] | A-6: K₃[Ir(NO)Cl₅] |
| A-7: K₂[IrBr₆] | A-8: K₃[IrBr₆] |
| A-9: Na₂[IrBr₆] | A-10: Na₃[IrBr₆] |
| A-11: K₂[IrBr₄Cl₂] | A-12: K₃[IrBr₄Cl₂] |
| A-13: K₂[IrBr₃Cl₃] | A-14: K₃[IrBr₃Cl₃] |
| A-15: K₂[IRBr₅Cl] | A-16: K₃[IrBr₅Cl] |
| A-17: K₂[IrBr₅I] | A-18: K₃[IrBr₅I] |
| A-19: K₂[IrBr₅(H₂O)] | |
| A-20: K₃[IrBr₅(H₂O)] | |
| A-21: K₄[IrCl₆] | |
| A-22: K₄[Ir(H₂O)Cl₅] | |
| A-23: K₄[Ir(thiazole)Cl₅] | |
| A-24: K₄[Ir(imidazole)Cl₅] | |
| B-1: K₂[RuCl₆] | B-2: K₂[PtCl₆] |
| B-3: K₂[Pt(SCN)₄] | B-4: K₂[NiCl₄] |
| B-5: K₂[PdCl₆] | B-6: K₃[RhCl₆] |
| B-7: K₂[OsCl₆] | B-8: K₂[ReCl₆] |
| B-9: K₃[RhBr₆] | B-10: K₃[Mo(OCN)₆] |
| B-11: K₃[Re(CNO)₆] | B-12: K₄[Ru(CNO)₆] |
| B-13: K₄[Fe(CNO)₆] | B-14: K₂[Pt(CNO)₄] |
| B-15: K₃[Co(NH₃)₆] | B-16: K₅[Co₂(CNO)₁₁] |
| B-17: K₃[Re(CNO)₆] | B-18: K₄[Os(CNO)₆] |
| B-19: Cs₂[Os(NO)Cl₅] | |
| B-20: K₂[Ru(NO)Cl₅] | |
| B-21: K₂[Ru(CO)Cl₅] | |
| B-22: Cs₂[Os(CO)Cl₅] | |
| B-23: K₂[Fe(NO)Cl₅] | |
| B-24: K₂[Ru(NO)Br₅] | B-25: K₂[Ru(NO)I₅] |
| B-26: K₂[Re(NO)Br₅] | |
| B-27: K₂[Re(NO)Cl₅] | |
| B-28: K₂[Ru(NS)Cl₅] | |
| B-29: K₂[Os(NS)Br₅] | |
| B-30: K₂[Ru(NS)Br₅] | |
| B-31: K₂[Ru(NS) (SCN)₅] | |
| B-32: K₄[Fe(CN)₆] | B-33: K₃[Fe(CN)₆] |
| B-34: K₄[Ru(CN)₆] | B-35: K₂[RuBr(CN)₅] |
| B-36: K₄[Os(CN)₆] | |
| B-37: K₂[Os(NS) (CN)₅] | |
| B-38: K₄[Re(CN)₆] | B-39: K₂[ReCl(CN)₅] |

In addition to the foregoing, there are also preferably usable metal compounds and bipyridine complexes described in JP-A No. 5-341426 are also preferred. Furthermore, the following iridium complexes are preferably used.

C-1: [Ir(bipy)Cl₄]⁻

C-2: [Ir(bipy)₃]²⁺

C-3: [Ir(py)₆]²⁺

C-4: [Ir(phen)₃]²⁺

C-5: [IrCl₂(bipy)₂]⁰

C-6: [Ir(thia)₆]²⁺

C-7: [Ir(phen) (bipy)₃]²⁺

C-8: [Ir(im)₆]²⁺

C-9: [Ir(NCS) (bipy)₂]⁰

C-10: [Ir(CN)₂(bipy)₂]⁰

C-11: [IrCl₂(bipy)₃]⁰

C-12: [IrCl₂(bipy)₂]⁰

C-13: [Ir(phen) (bipy)₂]²⁺

C-14: [Ir(NCS)₂(bipy)₂]⁰

C-15: [Ir(NCS)₂(bipy)₂]⁰

C-16: [Ir(bipy) (H₂O)(bipy′)]²⁺

C-17: [Ir(bipy)₂(OH)(bipy′)]⁺

C-18: [Ir(bipy)Cl₄]²⁻

C-19: [Ir(bipy)₃]³⁺

C-20: [Ir(py)₆]³⁺

C-21: [Ir(phen)₃]³⁺

C-22: [IrCl₂(bipy)₂]⁺

C-23: [Ir(thia)₆]³⁺

C-24: [Ir(phen) (bipy)₃]³⁺

C-25: [Ir(im)₆]³⁺

C-26: [Ir(NCS)₂(bipy)₂]⁺

C-27: [Ir(CN)₂(bipy)₂]⁺

C-28: [IrCl₂(bipy)₃]⁺

C-29: [IrCl₂(bipy)₂]⁺

C-30: [Ir(phen) (bipy)₂]³⁺

C-31: [Ir(NCS)₂(bipy)₂]⁺

C-32: [Ir(NCS)₂(bipy)₂]⁺

C-33: [Ir(biph)₂(H₂O)(bipy′)]³⁺

C-34: [Ir(biph)₂(OH)(bipy′)]²⁺

To allow the foregoing Group 8 metal compounds to be included, doping may be conducted during physical ripening of silver halide grains or in the course of forming silver halide grains (in general, during addition of water-soluble silver salt and alkali halide). Alternatively, forming silver halide grains is interrupted and doping is carried out, then, the grain formation is continued. Doping can also be conducted by performing nucleation, physical ripening or grain formation in the presence of a Group 8 metal compound.

The Group 8 metal compound is used in an amount of 1×10⁻⁹ to 1×10⁻² mol, preferably 1×10⁻⁹ to 1×10⁻³ mol, and more preferably 2×10⁻⁹ to 1×10⁻⁴ mol per mol of silver halide. Commonly known methods of adding additives to a silver halide emulsion are applicable to allow the Group 8 metal compound to be included in silver halide grains, for example, the compound may be directly dispersed in an emulsion or incorporated through solution in solvents such as water, tmethanol and ethanol. A method of preparing a silver halide emulsion, in which fine silver halide grains including a Group 8 metal compound are added during grain formation can be referred to a method described in JP-A Nos. 11-212201 and 2000-89403.

In the preparation method of silver halide emulsions relating to this invention, selenium sensitization is conducted using selenium sensitizers. Selenium sensitizers usable in this invention preferably are labile selenium compounds which are capable of forming a silver selenide precipitate upon reaction with silver nitrate in aqueous solution, for example, as described in U.S. Pat. Nos. 1,574,944, 1,602,592 and 1,623,499; JP-A Nos. 60-150046, 4-25832, 4-109240 and 4-147250. Specific examples of selenium sensitizers usable in this invention include colloidal selenium metal, isoselenocyanates (e.g., allylisoselenocyanate), selenoureas (e.g., N,N-dimethylselenourea, N,N,N′-triethylselenourea, N,N,N′,N′-tetramethylselenourea, N,N,N′-trimethyl-N′-heptafluoroselenourea, N,N′-dimethyl-N,N′-bis(carboxymethyl)selenourea, N,N,N′-trimethyl-N′-heptafluoropropylcarbonylselenourea, N,N,N′-trimethyl-N′-4-nitrophenylcarbonylselenourea), selenoketones (e.g., selenoacetone, selenoacetophenone), selenoamides (e.g., selenoacetoamide, N,N-dimethylselenobenzamide, N,N-diethyl-4-octylaminosulfonylselenobenzamide), selenocarboxylic acids and their selenoesters (e.g., 2-selenopropionic acid, methyl-3-selenobutyrate), selenophosphates (e.g., tri-p-tolyl-selenophosphate, pentafluorophenyl-diphenylselenophosphate), and selenides (e.g., dimethylselenide, tributylphosphineselenide, triphenylphosphineselenide, tri-p-tolylphosphineselenide, pentafluorophenyl-diphenylphosphineselenide, trifurylphosphineselenide, tripyridylphosphineselenide). Of these, specifically preferred selenium sensitizers ar selenoureas, selenoamides and selenides. Specific examples of a technique of using selenium sensitizers are described in U.S. Pat. Nos. 1,574,944, 1,602,592, 1,623,499, 3,297,466, 3,297,447, 3,320,069, 3,408,196, 3,408,197, 3,442,653, 3,420,670, and 3,591,385; French Patent Nos. 2,693,038, and 2,093,209; JP-B Nos. 52-34491, 52-34492, 53-295, and 57-22090; JP-A Nos. 59-180536, 59-185330, 59-181337, 59-187338, 59-192241, 60-150046, 60-151637, 61-246738, 3-4221, 3-24537, 3-111838, 3-116132, 3-148648, 3-237450, 4-16838, 4-25832, 4-32831, 4-33043, 4-96059, 4-109240, 4-140738, 4-140739, 4-147250, 4-184331, 4-190225, 4-191729, 4-195035, 5-11385, 5-40324, 5-24332, 5-24333, 5-303157, 5-306268, 6-306269, 6-27573, 6-75328, 6-175259, 6-208184, 6-208186, 6-317867, 7-92599, 7-98483, 7-104415, 7-140579, 7-301879, 7-301880, 8-114882, 9-19760, 9-138475, 9-166841, 9-138475, 9-189979, 10-10666, and 2001-343721; British Patent Nos. 255,846, and 861,984; and H. E. Spencer et al., Journal of Photographic Science, 31, 158-169 (1983).

A selenium sensitizer is added preferably in an amount of 1×10⁻⁹ to 1×10⁻⁵ mol, and more preferably 1×10⁻⁸ to 1×10⁻⁵ mol per mol of silver halide. The selenium sensitizer can be added to a silver halide emulsion by commonly known methods used for adding photographic additives to a silver halide emulsion. For example, water-soluble compounds are added through aqueous solution at an appropriate concentration and water-insoluble or sparingly water-soluble compounds are added through solution in water-miscible organic solvents having no adverse effect on photographic performance, such as alcohols, glycols, ketones, esters and amides.

The selenium sensitizer can be used in combination with sulfur sensitizers. Examples of a preferred sulfur sensitizer include thioureas such as 1.3-diphenylthiourea, triethylthiourea and 1-ethyl-3-(2-thiazolyl)thiourea, rhodanine derivatives, dithiocarbamates, polysulfide organic compounds, thiosulfates and simple substances of sulfur such as rhombic α-sulfur. There are also usable sulfur sensitizers described in U.S. Pat. Nos. 1,574,944, 2,410,689, 2,278,947, 2,728,668, 3,501,313, and 3,656,955; West German Patent Application Publication (OLS) No. 1,422,869; and JP-A Nos. 56-24937 and 55-45016.

The use of salts of noble metals such as gold, platinum, palladium and iridium is also preferred and the combined use of a gold sensitizer with the foregoing selenium sensitizers is more preferred. Examples of a preferred gold sensitizer include chloroauric acid, gold thiosulfate, gold thiocyanate and organic gold compounds described in U.S. Pat. Nos. 2,597,856, and 5,049,485; JP-B No. 44-15748; and JP-A Nos. 1-147537 and 4-70650. In the sensitization using gold complexes, ligands for gold, such as thiosulfates, thiocyanates and thioethers are preferably used as an auxiliary ingredient and the use of thiocyanates are specifically preferred.

The amount of a sulfur or gold sensitizer added, depending on the composition of a silver halide emulsion, the kind of a compound used and ripening conditions, is preferably 1×10⁻⁹ to 1×10⁻⁵ mol, and more preferably 1×10⁻⁸ to 1×10⁻⁵ mol per mol of silver halide. The foregoing sensitizers can be added, according to the property of the sensitizer added, through solution in water or organic solvents, by mixing with an aqueous gelatin solution, or in the form of dispersion emulsified with a polymer soluble in organic solvent, as described in JP-A No. 4-140739.

Reduction sensitization is also usable in combination and there are usable reducing compounds described in Research Disclosure (hereinafter, also denoted simply as RD) 307105 and JP-A No. 7-78685. Specific examples of reduction sensitizers include aminoiminomethanesulfinic acid (or also called thiourea dioxide), borane compounds (e.g., dimethylaminoborane), hydrazine compounds (hydrazine, p-tolylhydrazine), polyamine compounds (e.g., diethylenetriamine, triethylenetetramine), stannous chloride, silane compounds, reductones (e.g., ascorbic acid), sodium sulfite, aldehyde compounds and hydrogen gas. Reduction sensitization can be undergone under an atmosphere at a relatively high pH or silver ion in excess, as described in Japanese Patent Application Nos. 8-277938, 8-251486 and 8-182035.

In this invention, at least one compound represented by the foregoing formula (1), (2) or (3) is allowed to be present concurrently with the selenium sensitizer to perform selenium sensitization. Thus, the silver halide emulsion relating to this invention is chemically sensitized using a selenium sensitizer together with the compound represented by formula (1), (2) or (3). The compound represented by formula (1), (2) or (3) may be added to the silver halide emulsion before or after, or simultaneously with adding the selenium sensitizer, and preferably before adding the selenium sensitizer.

In formulas (1) to (3), aliphatic groups represented by R, and R₁ through R₄ are each a saturated or unsaturated, straight chain, branched or cyclic aliphatic hydrocarbon group, and preferably an alkyl group having 1 to 22 carbon atoms, or an alkenyl or alkynyl group having 2 to 22 carbon atoms. Specific examples of the alkyl group include methyl, ethyl, propyl, butyl, pentyl, hexyl, octyl, 2-ethylhexyl, decyl, dodecyl, hexadecyl, octadecyl, cyclohexyl, isopropyl, and t-butyl; examples of the alkenyl group include allyl and butenyl; and examples of the alkynyl group include propargyl.

Aromatic groups represented by R, and R₁ through R₄ include monocyclic and condensed ring aromatic groups. Preferred aromatic groups are those having 6 to 20 carbon atoms, such as phenyl and naphthyl.

Heterocyclic groups represented by R, and R₁ through R₄ include monocyclic and condensed ring ones, which are groups derived from 3- to 10-membered heterocycles containing at least one atom selected from nitrogen atom, oxygen atom, sulfur atom, selenium atom tellurium atom and at least one carbon atom. Examples thereof include a pyrrolidine ring group, piperidine ring group, pyridine ring group, tetrahydrofuran ring group, thiophene ring group, oxazole ring group, thiazole ring group, imidazole ring group, benzothiazole ring group, benzoxazole ring group, benzimidazole ring group, selenazole ring group, benzoselenazole ring group, tetrazole ring group, triazole ring group, benzotriazole ring group, oxadiazole ring group and thiadiazole ring group.

The foregoing aliphatic group, aromatic group and heterocyclic group represented by R, and R₁ through R₄ may further be substituted. Specific examples of substituents include an alkyl group (e.g., methyl, ethyl, hexyl), alkoxy group (e.g., methoxy, ethoxy, octyloxy), aryl group (e.g., phenyl, naphthyl, tolyl), hydroxy group, halogen atom (e.g., fluorine atom, chlorine atom, bromine atom, iodine atom), aryloxy group (e.g., phenoxy), alkylthio group (e.g., methylthio, butylthio), arylthio group (e.g., phenylthio), acyl group (e.g., acetyl, propionyl, butylyl, valeryl), sulfonyl group (methylsulfinyl, phenylsulffonyl), acylamino group (e.g., acetylamino, benzoylamino), sulfonylamino group (e.g., methanesulfonylamino, benzenesulfonylamino), acyloxy group (e.g., acetoxy group, benzoxy group), carboxyl group, cyano group, sulfo group, amino group, —SO₂SM, and aliphatic, aromatic and heterocyclic groups represented by the foregoing R, and R₁ through R₄.

Divalent linkage group represented by L is an atom selected from carbon atom, nitrogen atom, sulfur atom and oxygen atom or an atomic group containing at least one atom selected from the foregoing atoms. Specific examples thereof include an alkylene group, alkenylene group, alkynylene group, arylene group, —O—, —S—, —NH—, —CO—, —SO₂— and their combinations. The divalent linkage group represented by L is preferably a divalent aliphatic or aromatic group, such as —(CH₂)ₙ— (in which n is 1-12), —CH₂—CH═CH—CH₂—, —CH₂—C≡C—CH₂—, xylene group, phenylene group, naphthylene group, and

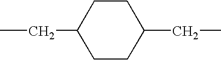

The divalent linkage group represented by L may be substituted by the substituent described above.

M is a cation, and preferably a metal ion, ammonium ion or an organic cation. Examples of a metal ion include lithium ion, sodium ion and potassium ion. Examples of an organic ion include an alkylammonium ion (e.g., tetramethylammonium, tetrabutylammonium), phosphonium ion (e.g., tetraphenylphosphonium) and guanidyl group.

The compound represented by the foregoing formula (1) to (3) may be included in a polymer, as a component element of the polymer. Thus, in cases where the compound represented by formula (1) to (3) is included in a polymer, repeating units forming the polymer are, for examples, as follows.

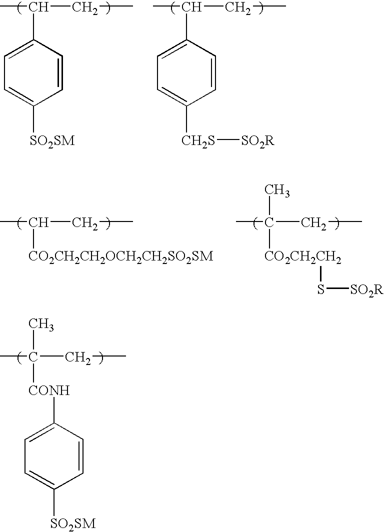

A polymer containing the foregoing repeating unit may be a homopolymer or may form its copolymer with other polymer(s).

Specific examples of the compound represented by formula (1) to (3) and specific examples of a polymer containing a compound represented by formula (1) to (3) as a component element of the polymer are shown below but are by no means limited to these.

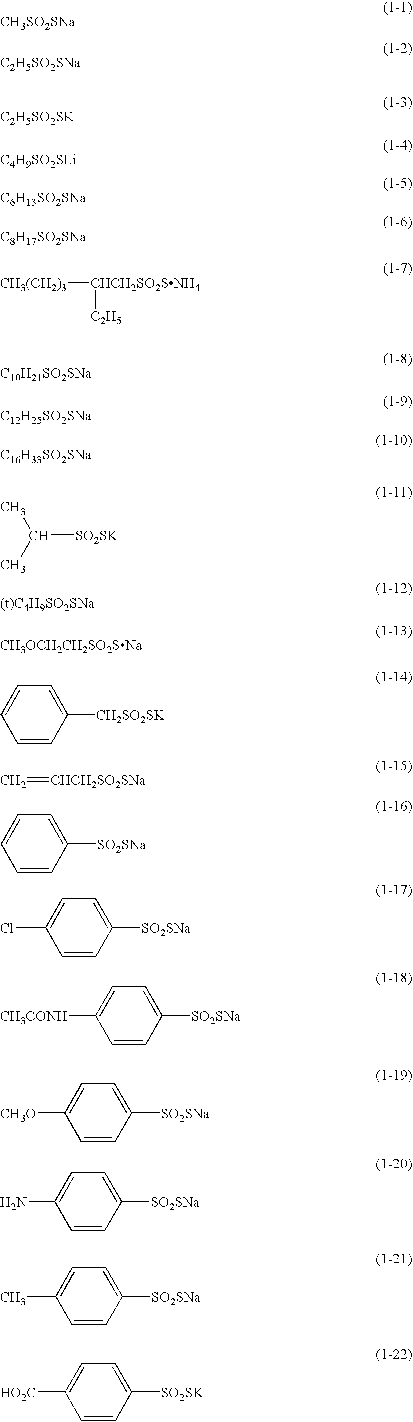

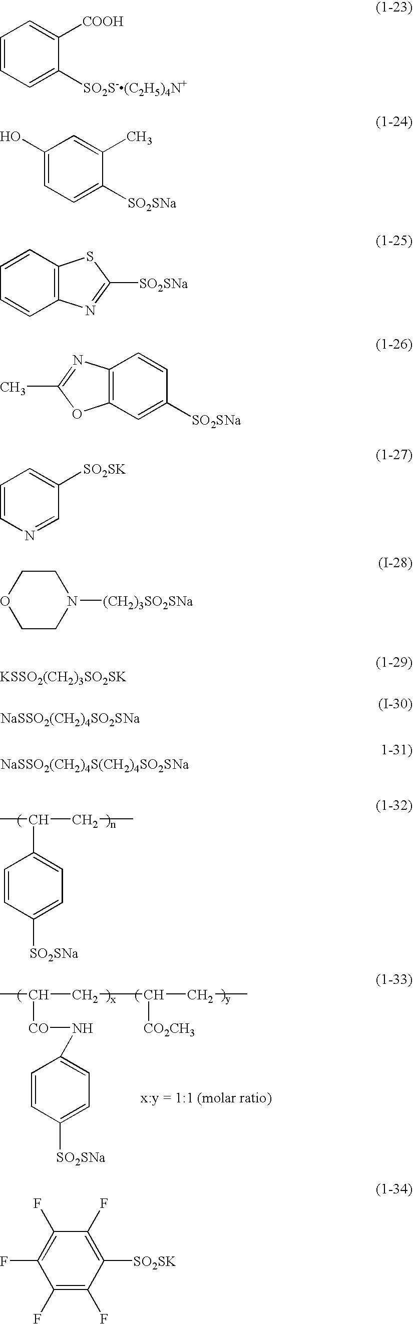

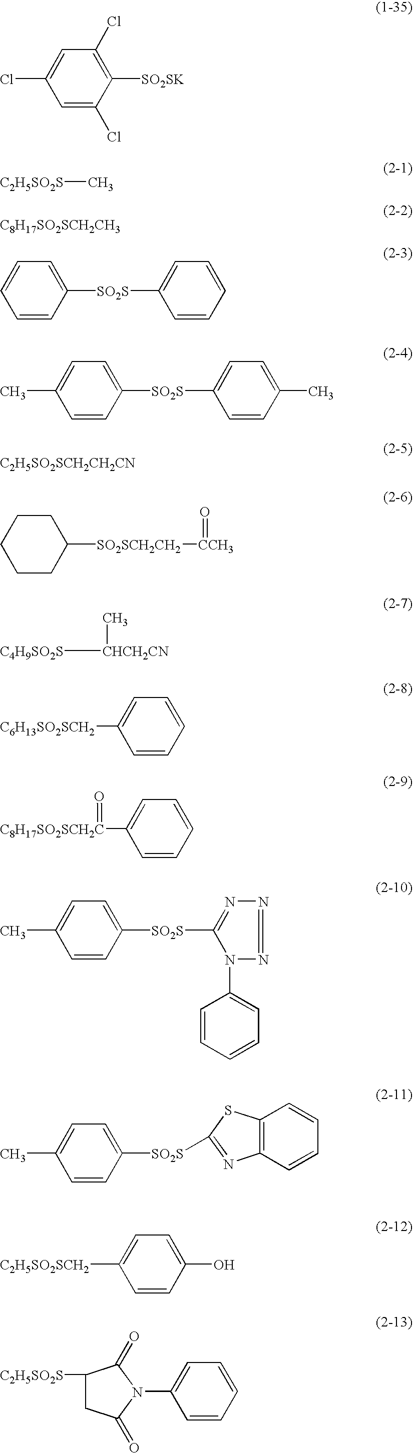

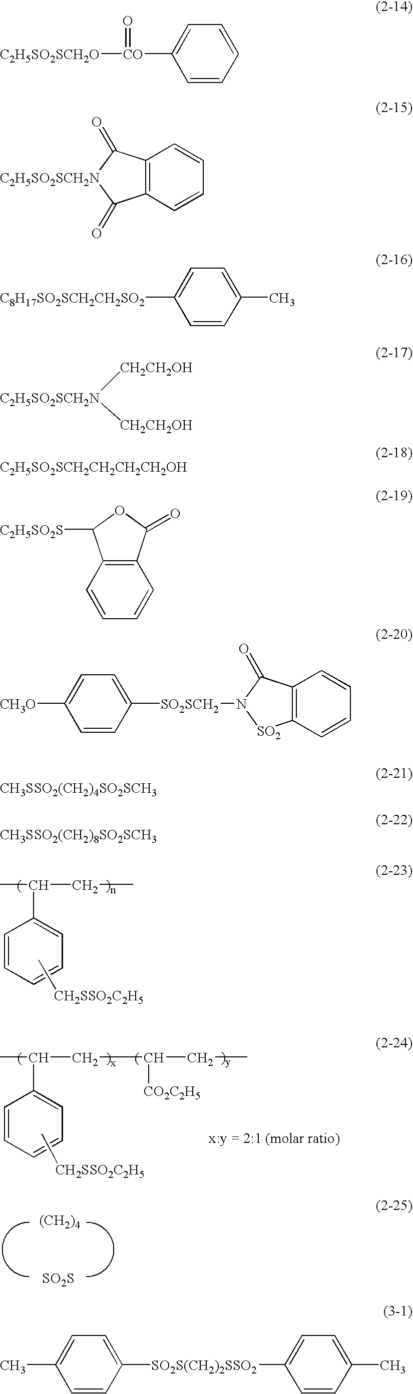

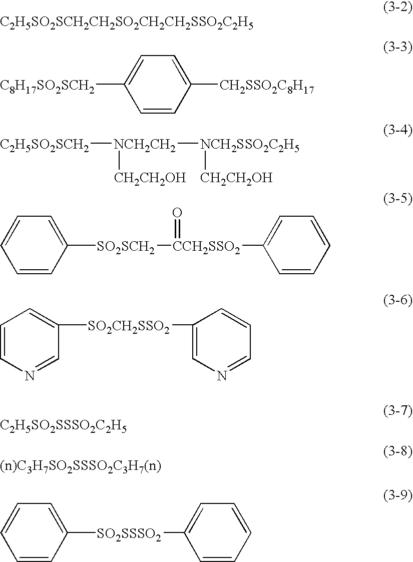

In this invention, at least one compound represented by the foregoing formula (4) is allowed to be present concurrently with the selenium sensitizer to perform selenium sensitization. Thus, the silver halide emulsion relating to this invention is chemically sensitized using a selenium sensitizer together with the compound represented by formula (4). The compound represented by formula (4) may be added to the silver halide emulsion before or after, or simultaneously with adding the selenium sensitizer, and preferably before adding the selenium sensitizer.

In formula (4), aliphatic groups represented by R₁₁ and R₁₂ include straight chain or branched alkyl, alkenyl or alkynyl group having 1 to 30 carbon atoms (preferably 1 to 20 carbon atoms) and a cycloalkyl group. Specific examples thereof include methyl, ethyl, propyl, butyl, hexyl, decyl, dodecyl, isopropyl, t-butyl, 2-ethylhexyl, allyl, 2-butenyl, 7-octenyl,propargyl, 2-butynyl, cyclopropyl, cyclopentyl, cyclohexyl and cyclododecyl. Aromatic groups represented by R₁₁ and R₁₂ include ones having 6 to 20 carbon atoms, such as phenyl, naphthyl and anthranyl. Heterocyclic groups represented by R₁₁ and R₁₂ may be a monocyclic one or a condensed ring one, including, for example, 5- or 6-membered heterocyclic group containing at least one of O, S and N atoms and amineoxide group within the ring. Specific examples of the heterocyclic group include groups derived from pyrrolidine, piperidine, tetrahydrofuran, tetrahydropyrane, oxirane, morpholine, thiomorpholine, thiopyrane, tetrahydrothiopyrane, pyrrole, pyridine, furan, thiophene, imidazole, pyrazole, oxazole, thiazole, isooxazole, isothiazole, triazole, tetrazole, thiadiazole, oxadiazole and their benzenelogs. Rings formed by R₁₁ and R₁₂ include 4- to 7-membered rings and 5- to 7-membered rings are preferred. R₁₁ and R₁₂ are preferably a heterocyclic group or aromatic group, and more preferably a heterocyclic group. The foregoing aliphatic, aromatic and heterocyclic groups represented by R₁₁ and R₁₂ may be substituted by a substituent. Specific examples of such a substituent include a halogen atom (e.g., chlorine atom, bromine atom), alkyl group (e.g., methyl, ethyl, propyl, hydroxyethyl, methoxymethyl, trifluoromethyl, t-butyl), cycloalkyl group (e.g., cyclopentyl, cyclohexyl, aralkyl group (e.g., benzyl, 2-phenethyl), aryl group (e.g., phenyl, naphthyl, p-tolyl, p-chlorophenyl), alkoxy group (e.g., methoxy, ethoxy, isopropoxy, butoxy), aryloxy group (e.g., phenoxy, 4-methoxyphenoxy), cyano group, acylamino group (e.g., acetylamino, propionylamino), alkylthio group (e.g., methylthio, ethylthio, butylthio), arylthio group (e.g., phenylthio, p-methylphenylthio), sulfonylamino group (e.g., methanesulfonylamino, benzenesulfonylamino), ureido group (e.g., 3-methylureido, 3,3-dimethylureido, 1,3-dimethylureido), sulfamoylamino (e.g., dimethylsulfamoylamino, diethylsulfamoylamino), carbamoyl group (e.g., methylcarbamoyl, ethylcarbamoyl, dimethylcarbamoyl), sulfamoyl group (e.g., ethylsulfamoyl, dimethylsulfamoyl), alkoxycarbonyl group (e.g., methoxycarbonyl, ethoxycarbonyl), aryloxycarbonyl group (e.g., phenoxycarbonyl, p-chlorophenoxycarbonyl), sulfonyl group (e.g., methanesulfonyl, butanesulfonyl, phenylsulfonyl), acyl group (e.g., acetyl, propanoyl, butyloyl), amino group (e.g., methylamino, etylamino, dimethylamino), hydroxy group, nitro group, nitroso group, amineoxide group (e.g., pyridine.oxide), imido group (e.g., phthalimido), and disulfide group (e.g., benzenesulfide, benzthiazolyl-2-disulfide).

Specific examples of the compound represented by formula (4) are shown below but are not limited to these.

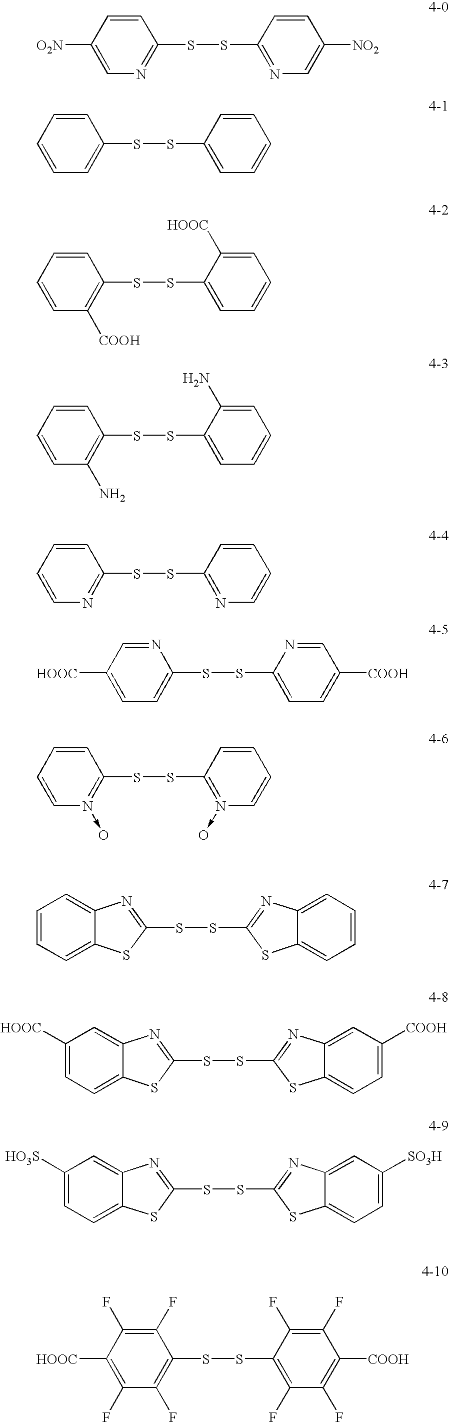

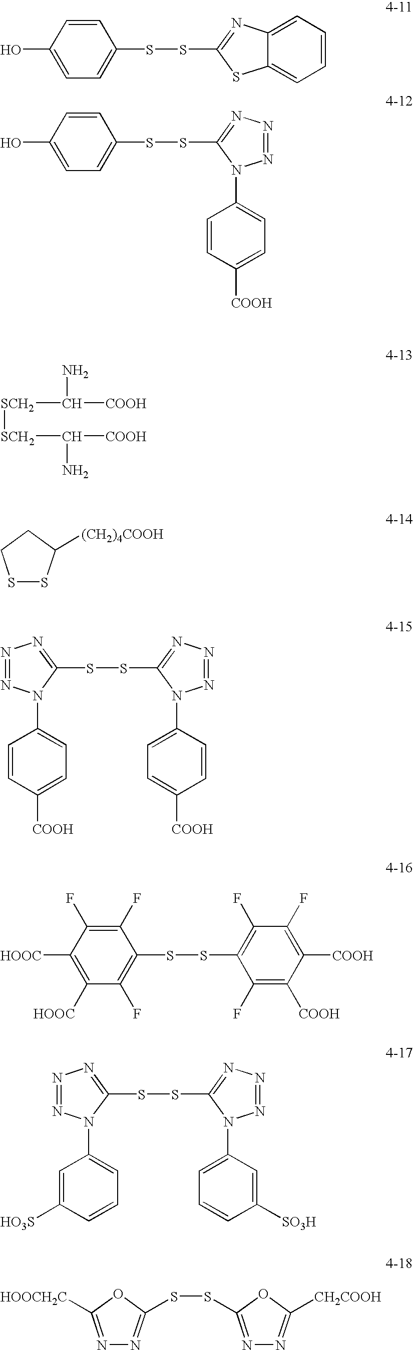

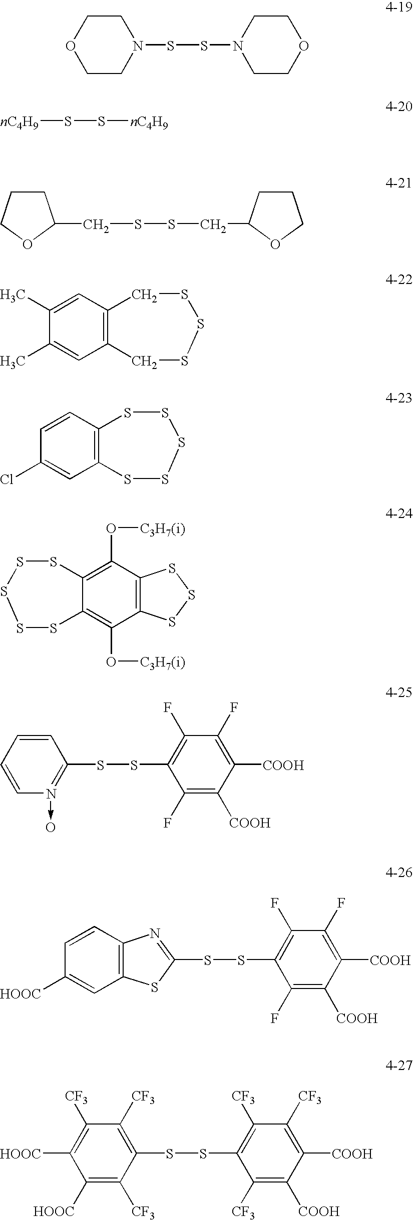

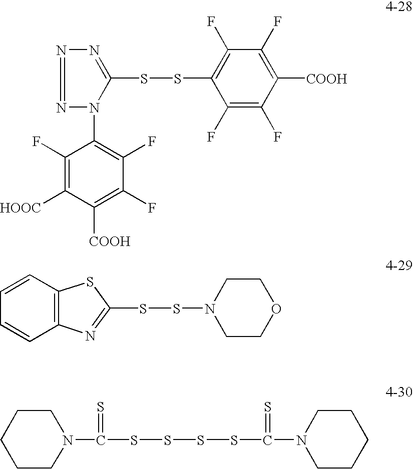

In addition to the foregoing compounds, disulfide compounds described in JP-A No. 2002-148750 are also preferably usable in this invention.

In the preparation process of a silver halide emulsion relating to this invention, the silver halide emulsion grains are chemically sensitized with a selenium compound and fine grains of at least one chosen from silver sulfide, gold sulfide and silver-gold sulfide. Thus, the silver halide emulsion relating to this invention is chemically sensitized using a selenium sensitizer together with fine grains of at least one chosen from silver sulfide, gold sulfide and silver-gold sulfide. The fine grains of at least one chosen from silver sulfide, silver gold and silver-gold sulfide may be added to the silver halide emulsion before or after, or simultaneously with adding the selenium sensitizer, and preferably before adding the selenium sensitizer. Of silver sulfide, gold sulfide and silver-gold sulfide, fine grains of gold sulfide is preferred.

The preparation method of fine grains of at least one chosen from silver sulfide, gold sulfide and silver-gold sulfide is not specifically limited. The fine grains may be prepared prior to the addition to the emulsion or may be desalted. It is preferred that an aqueous silver salt or gold salt solution and an aqueous sulfide solution are simultaneously supplied to react with each other in the presence of protective colloid with controlling reaction conditions to prepare fine grains. Specifically fine grains of silver-gold sulfide are obtained by allowing a silver salt and a gold salt to be concurrently present to react with a sulfide (or sulfide forming compound).

The fine grains of at least one chosen from silver sulfide, gold sulfide and silver-gold sulfide are those having an average circular equivalent diameter (hereinafter, also denoted as an average diameter) of 1 to 15 nm, preferably 1 to 10 nm, and more preferably 1 to 5 nm. A coefficient of variation of diameter is preferably not more than 0.30, and more preferably 0.20. The diameter or coefficient of variation of diameter can be determined in a manner that fine grains are sampled and desalted by means such as centrifugation, then, after dried on a mesh, the fine grains are observed by a transmission electron microscope and optionally subjected to image processing. At least two kinds of fine grains differing in particle diameter may be blended in any ratio.

Any reagent can be used in the preparation of fine grains of at least one chosen from silver sulfide, gold sulfide and silver-gold sulfide. In the preparation of silver sulfide, for example, an aqueous silver nitrate solution is generally used as an aqueous silver salt solution and as an aqueous sulfide solution is usable not only an aqueous solution containing salts such as sodium sulfide and sodium thiosulfate but also an aqueous solution containing thiourea or thiourea derivatives. In the preparation of gold sulfide or silver-gold sulfide, a gold salt solution such as an aqueous solution containing chloroauric acid is generally used and organic or inorganic gold complex compounds are also usable.

It is preferred to prepare fine grains of at least one selected from silver sulfide, gold sulfide and silver-gold sulfide in a manner that an aqueous sulfide solution and an aqueous silver salt, gold salt, or silver and gold (or silver-gold) salt solution (i.e., solution containing a silver salt and a gold salt) are simultaneously supplied by the double-jet addition with controlling reaction conditions to form fine grains. The foregoing reaction conditions depend on the composition, particle size and particle size distribution, and the temperature is preferably 5 to 80° C., more preferably 5 to 60° C. and still more preferably 5 to 50° C.; the pH is preferably 2.0 to 10.0, more preferably 4.0 to 9.0, and still more preferably 5.0 to 8.5; the pAg is preferably 4 to 11, more preferably 5 to 10, and still more preferably 6 to 9.

The fine grains are prepared preferably in the presence of hydrophilic protective colloid. Thus, a solution containing a hydrophilic protective colloid may be supplied simultaneously with the foregoing supply of an aqueous sulfide solution and an aqueous silver salt, gold salt, or silver-gold salt solution; when forming the fine grains in a reaction vessel, the hydrophilic protective colloid may be allowed to be present in the reaction vessel. Gelatin and other compounds are usable as a hydrophilic protective colloid. The concentration of hydrophilic protective colloid is preferably 0.01 to 10%, more preferably 0.03 to 5%, and still more preferably 0.05 to 3%.

When chemical sensitization is performed with adding fine grains of at least one chosen from silver sulfide, gold sulfide and silver-gold sulfide to a silver halide emulsion, the addition of the fine grains may be conducted singly or separately two or more times, instantaneously or continuously, and preferably separately two or more times and continuously. When continuously added, the addition time is preferably 10 sec. to 100 min., more preferably 10 sec. to 60 min., and still more preferably 10 sec. to 40 min. When chemical sensitization is performed with adding fine grains of at least one chosen from silver sulfide, gold sulfide and silver-gold sulfide to a silver halide emulsion, the reaction temperature is preferably 20 to 90° C., more preferably 30 to 80° C., and still more preferably 40 to 70° C.; the pH is preferably 2.0 to 10.0, more preferably 4.0 to 9.0, and still more preferably 5.0 to 8.0; and the pAg is preferably 4 to 11, more preferably 5 to 10, and still more preferably 6 to 9. The amount of fine grains added is preferably 1×10⁻¹⁰ to 1×10⁻⁴ mol, and more preferably 5×10⁻⁹ to 5×10⁻⁵ mol per mol of silver halide.

In the embodiment of this invention, at least one compound represented by the foregoing formula (S) is allowed to be present concurrently with the selenium sensitizer to perform selenium sensitization. Thus, the silver halide emulsion relating to this invention is chemically sensitized using a selenium sensitizer together with the compound represented by formula (S). The compound represented by formula (S) may be added to the silver halide emulsion before or after, or simultaneously with adding the selenium sensitizer, and preferably before adding the selenium sensitizer.

In the formula (S), examples of the 5-membered ring containing Q include an imidazole ring, tetrazole ring, thiazole ring, oxazole ring, selenazole ring, benzimiazole ring, naphthoimidazole ring, benzothiazole ring, naphthothiazole ring, benzoselenazole ring, naphthoselenazole ring, and benzoxazole ring. Examples of the 6-membered ring containing Q include a pyridine ring, pyrimidine ring and quinoline ring. The 5-membered or 6-membered ring may be substituted. Alkali metals represented by M¹ include, for example, sodium atom and potassium atom. Monovalent cation groups represented by M¹ include ammonium ion and organic cations.

The compound represented by the foregoing formula (S) is preferably mercapto compounds represented by the following formula (S-1), (S-2), (S-3) or (S-4):

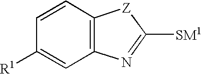

wherein R¹ is a hydrogen atom, an alkyl group, an alkoxy group, an aryl group, a halogen atom, a carboxyl group or its salt, a sulfo group or its salt or an amino group; Z is —NH—, —O— or —S—: and M¹ is the same as defined in the foregoing formula (S);

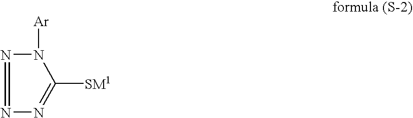

wherein Ar is a group represent by the following formula:

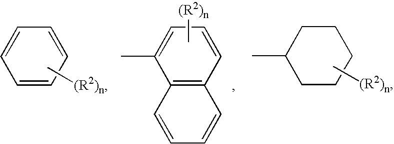

wherein R² is an alkyl group, an alkoxy group, a carboxy group or its salt, a sulfo group or its salt, a hydroxy group, an amino group, an acylamino group, a carbamoyl group or a sulfonamido group; n is an integer of 0 to 2; M¹ is the same as defined in the foregoing formula (S);

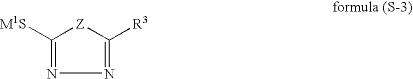

wherein Z is —NR³—, an oxygen atom or a sulfur atom, in which R³ is a hydrogen atom, alkyl group, aryl group, alkenyl group, cycloalkyl group, —SR³¹, —NR³²(R³³)—, —NHCOR³⁴, —NHSO₂R³⁵ or a heterocyclic group, in which R³¹ is a hydrogen atom, alkyl group, alkenyl group, cycloalkyl group, aryl group-COR³⁴, or —SO₂R³⁵, R³² and R³³ are each a hydrogen atom, alkyl group or aryl group, R³⁴ and R³⁵ are each an alkyl group or aryl group; M¹ is the same as defined in formula (S);

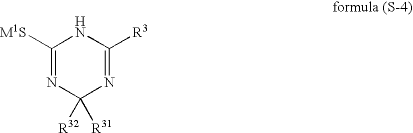

wherein R³ and M¹ are each the same as defined in the foregoing formula (S-3); R³¹ and R³² are each the same as defined in the foregoing formula (S-3).

In the foregoing formulas (S-1) and (S-2), the alkyl group represented by R¹ and R² includes, for example, methyl, ethyl and butyl; the alkoxy group includes methoxy and ethoxy, salts of the carboxy or sulfo group includes sodium and ammonium salts. In formula (S-1), the aryl group represented by R¹ includes, for example, phenyl and naphthyl, and the halogen atom includes, for example, chlorine atom and bromine atom. In formula (S-2), the acylamino group represented by R² includes, for example, methylcarbonylamino and benzoylamino; the carbamoyl group includes, for example, ethylcarbamoyl and phenylcarbamoyl; and the sulfonamido group includes, for example, methylsulfonamido and phenylsulfonamido. The foregoing alkyl, alkoxy, aryl, amino, acylamino, carbamoyl and sulfonamido groups may be substituted with substituents.

In the foregoing formula (S-3), the alkyl group represented by R³, R³¹, R³², R³³, R³⁴ and R³⁵ includes, for example, methyl, benzyl, ethyl and propyl; and the aryl group includes, for example, phenyl and naphthyl. The alkenyl group represented by R³ and R³¹ includes, for example, propenyl; the cycloalkyl group includes, for example, cyclohexyl. The heterocyclic group represented by R³ includes, for example, furyl and pyridinyl. The foregoing alkyl or aryl group represented by R³, R³¹, R³², R³³, R³⁴ and R³⁵, the alkenyl or cycloalkyl group represented by R³ and R³¹ and the heterocyclic group represented by R³ each may be substituted with substituents.

Specific examples of the compound represented by formula (S) are shown below but are by no means limited to these.

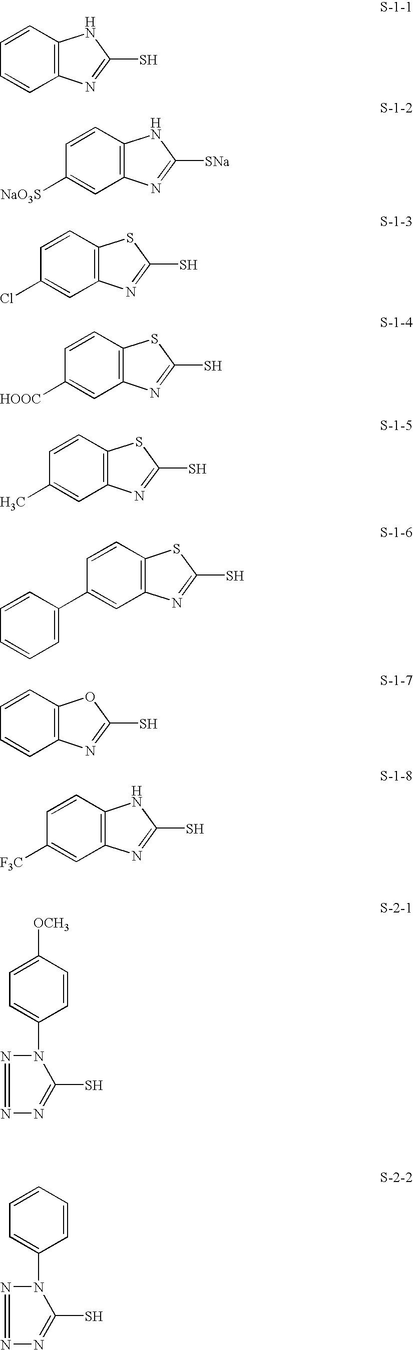

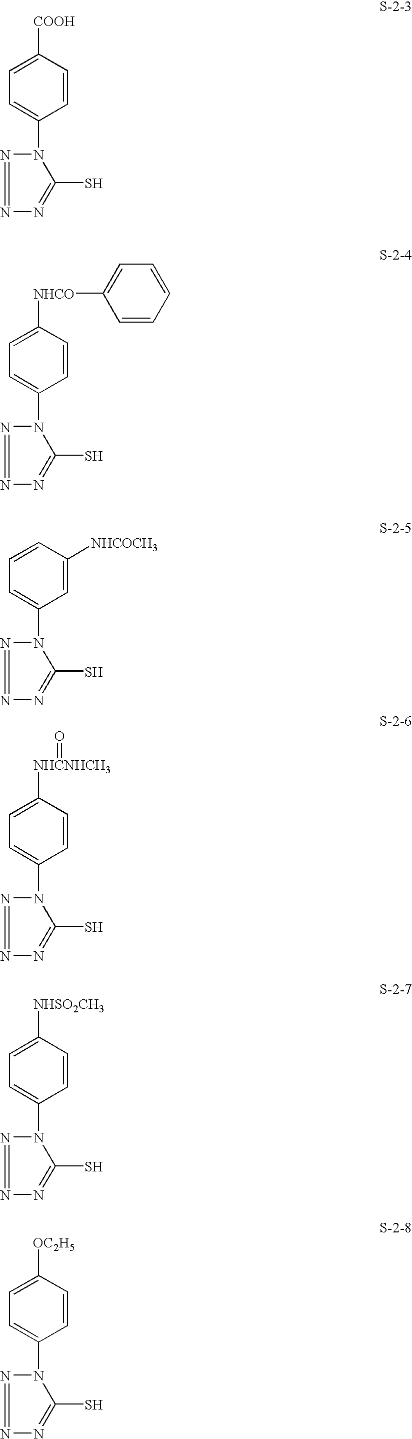

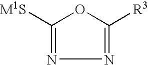

| Compound | R³ | M¹ |
|---|---|---|
| S-3-1 | —C₂H₅ | —H |
| S-3-2 | —CH₂—CH═CH₂ | —H |
| S-3-3 | —CH═CH—CH₂—CH₃ | —H |
| S-3-4 | —C₇H₁₅ | —H |
| S-3-5 | —C₉H₁₉ | —Na |
| S-3-6 | 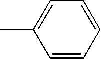 | —H |
| S-3-7 | —C₄H₉(t) | —H |
| S-3-8 | 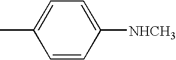 | —H |
| S-3-9 | 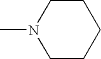 | —H |
| S-3-10 | 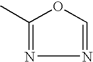 | —H |
| S-3-11 | 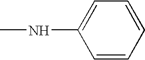 | —H |
| S-3-12 | 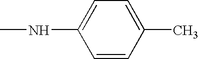 | —H |
| S-3-13 | —NHCOCH₃ | —H |
| S-3-14 | 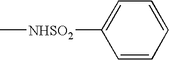 | —H |
| S-3-15 | —N(CH₃)₂ | —H |
| S-3-16 | 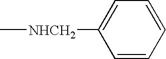 | —H |
| S-3-17 | 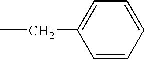 | —H |
| S-3-18 | —S—CH₃ | —H |
| S-3-19 | 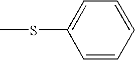 | —H |
| S-3-20 | —SH | —H |

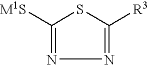

| Compound | R³ | M¹ |
|---|---|---|
| S-3-21 | —H | —H |
| S-3-22 | —C₂H₅ | —H |
| S-3-23 | —C₄H₉(t) | —H |
| S-3-24 | —C₆H₁₃ | —H |
| S-3-25 | 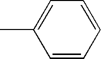 | —H |
| S-3-26 | 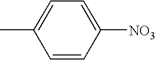 | —H |
| S-3-27 | 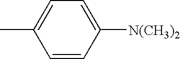 | —H |
| S-3-28 | 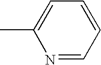 | —H |
| S-3-29 | 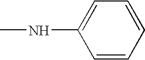 | —H |
| S-3-30 | —NH—N(CH₃)₂ | —H |
| S-3-31 | —CH₂CH═CH₂ | —H |
| S-3-32 | —SH | —H |
| S-3-33 | —NHCOC₂H₅ | —H |

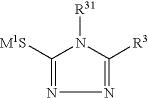

| Compound | R³ | R³¹ | M¹ |
|---|---|---|---|
| S-3-34 | —C₂H₅ | —H | —H |
| S-3-35 | —CH₃ | —CH₃ | —H |
| S-3-36 | —CH₃ | 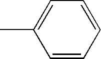 | —H |
| S-3-37 | —NHCOCH₃ | —CH₃ | —H |
| S-3-38 | 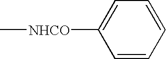 | 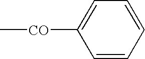 | —H |
| S-3-39 | —NHCOCH₃ | —COCH₃ | —H |
| S-3-40 | —NHCOCH₃ | 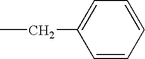 | —H |
| S-3-41 | —NHCOC₂H₅ | 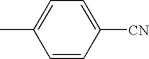 | Na |
| S-3-42 | 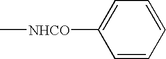 | 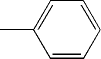 | H |
| S-3-43 | —NHSO₂CH₃ | —H | H |
| S-3-44 | 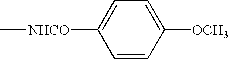 | —CH₃ | Na |
| S-3-45 | 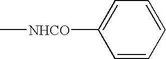 | —CH₂CH═CH₂ | H |
| S-3-46 | 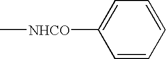 | 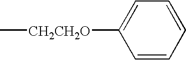 | —H |

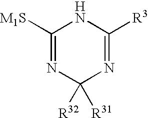

| Compound | R³ | R³¹ | R³² | M¹ |
|---|---|---|---|---|
| S-4-1 | —C₂H₅ | —CH₃ | —CH₃ | —H |
| S-4-2 | 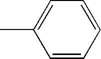 | —CH₃ | —CH₃ | —H |
| S-4-3 | —NH₂ | —H | 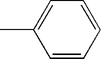 | —H |
| S-4-4 | 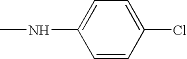 | —H | —C₄H₉ | —H |
| S-4-5 | —NHCOCH₃ | —CH₃ | —CH₃ | —H |
| S-4-6 | 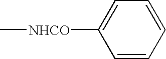 | —CH₃ | —CH₃ | —H |
| S-4-7 | 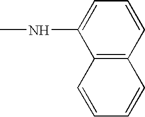 | —CH₃ | —C₃H₇(i) | —H |

| | |
|---|---|
| S-4-8 | 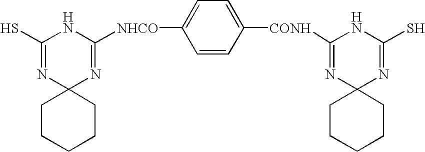 |

The compounds represented by formula (S) include compounds described, for example, in JP-B No. 40-28496, JP-A 50-89034; J. Chem. Soc. 49, 1748 (1927), ibid 4237 (1952); J. Org. Chem. 39, 2469 (1965); U.S. Pat. No. 2,824,001; J. Chem. Soc. 1723 (1951); JP-A No. 56-111846; U.S. Pat. Nos. 1,275,701, 3,266,897, 2,403,927, and can be synthesized in accordance with the synthesis described in the foregoing literature.

To allow the compound represented by formula (S), which is hereinafter also denoted simply as a compound (S), to be included in a silver halide emulsion layer relating to this invention, the compound (S) is incorporated through solution in water or water-miscible organic solvents (e.g., methanol, ethanol). The compound (S) may be used alone or in combination with another compound represented by formula (S), or a stabilizer or antifoggant other than the compounds represented by formula (S).

The compounds represented by formulas (1) through (4) and the compound (S) are each added preferably in an amount of 1×10⁻⁸ to 1 mol/mol·AgX, and more preferably 1×10⁻⁷ to 1×10⁻¹ mol/mol·AgX. Addition of the compounds represented by formulas (1) through (4) and the compound (S) to a silver halide emulsion can be conducted by applying methods which have been used in the art to incorporate additives to photographic emulsions. For example, a water-soluble compounds is dissolved in water to form an aqueous solution at an optimum concentration, and a water-insoluble or sparingly water-soluble compounds are incorporated through solution in water-miscible organic solvents which have no adverse effect on photographic characteristics, e.g., alcohols, glycols, ketones, esters and amides.

So long as selenium sensitization is performed in the presence of the compound represented by the foregoing formula (1) to (4) or formula (S), the time of adding these compounds is not specifically limited and preferably at any time between before starting the addition of chemical sensitizers and completion of chemical sensitization. It is more preferred that at least one of the compounds represented by formulas (1) to (4) and formula (S) is allowed to be present in a silver halide emulsion before addition of a selenium sensitizer. When a noble metal sensitizer such as gold or a sulfur sensitizer is used together with selenium sensitizer, it is more preferred that the foregoing compounds represented by formulas (1) to (4) or formula (S) are allowed to be present before adding the chemical sensitizers. In one preferred embodiment (a), the foregoing compounds are added before adding the chemical sensitizers; in another preferred embodiment (b), the foregoing compounds are added after completion of at least 50% of chemical sensitization (preferably at least 70%, and more preferably at least 90% of chemical sensitization) and before completion of the chemical sensitization. The foregoing embodiments (a) and (b) may be performed in combination.

Silver halide emulsion grains relating to this invention preferably include the foregoing compound represented by formula (S) [or compound (S)] in the interior of the grains, and preferably the compound represented by formula (S-2). The interior of the grains refers to a silver halide phase, except for the silver halide grain surface. The compound (S) is included in the interior of the grains, preferably in an amount of 1×10⁻⁸ to 1×10⁻¹ mol/mol·AgX, and more preferably 1×10⁻⁷ to 1×10⁻² mol/mol·AgX.

There may be any number of regions differing in concentration of compound (S) in the interior of the grains and the concentration is not specifically limited so long as intended grains are formed. It is preferred that at least two silver halide phases differing in concentration of compound (S) are in the interior of the grains, and it is more preferred that a silver halide phase having a less concentration of compound (S) than a silver halide phase having a maximum concentration of compound (S) is external to the silver halide phase having a maximum concentration of compound (S). In one preferred embodiment of this invention, for example, the outermost region (shell portion) within the grain has a concentration of compound (S) less than the internal region (core portion). The shell portion refers to the final region in the course of grain formation through grain growth and the outermost region of the grain including the grain surface. The average concentration of compound (S) in the shell portion is preferably less than 1.5×10⁻⁴ mol per mol of silver halide. The concentration of compound (S) may be 0 and is preferably 0.1 to 1×10⁻⁴ mol, and more preferably 0.1 to 0.5×10⁻⁴ mol per mol of silver halide. The concentration of compound (S) in the core portion is not specifically limited insofar as it is less than the shell portion, and preferably 0.5 to 3×10⁻⁴ mol per mol of silver halide.

There may be included plural compounds (S) in combination and plural silver halide phases, or the core portion and the shell portion are different in the kind or combination thereof. The compound (S) may be allowed to be present in a grain forming system using any method and preferably to be contained in a halide solution. In the silver halide grains relating to this invention, the volume of a shell portion is preferably not more than 50%, and more preferably not more than 30% of the grain volume. In one preferred embodiment, the shell portion accounts for not more than 10% of the grain volume and is located in a sub-surface region near the grain surface.

Silver halide emulsions relating to this invention preferably contain gelatin substantially free of calcium ions. The gelatin substantially free of calcium ions (hereinafter, also denoted as calcium-free gelatin) is a gelatin having a calcium content of not more than 100 ppm, preferably not more than 50 ppm, and more preferably not more than 30 ppm. A calcium-free gelatin usable in this invention can be obtained by a cation exchange treatment using ion exchange resin and the like. In a silver halide emulsion relating to this invention, a calcium-free gelatin is preferably used in at least one stage of the process of preparing a silver halide emulsion, including silver halide grain formation, desalting, dispersion, chemical sensitization and/or spectral sensitization, and preferably prior to chemical sensitization and/or spectral sensitization. At least 10% by weight (preferably at least 30% and more preferably at least 50% by weight) of the total dispersing medium contained in the silver halide emulsion prepared is preferably accounted for by a calcium-free gelatin.

It is preferred that amino group-substituted, chemically modified gelatin is used in grain formation and/or desalting of a silver halide emulsion relating to this invention. There are preferably used chemically modified gelatins in which an amino group of the gelatin is substituted, as described in JP-A Nos. 5-72658, 9-197595 and 9-251193. The chemically modified gelatin is used in the grain formation and/or desalting, preferably in an amount of at least 10% by weight, more preferably at least 30% by weight, and still more preferably at least 50% by weight of the total dispersing medium. The substituted amino group percentage is preferably at least 30%, more preferably at least 50%, and still more preferably at least 80%.

One feature of preparation of silver halide emulsions relating to this invention is that desalting is conducted after formation of the silver halide host grains. In this invention, silver halide host grains refer to silver halide grains having formed a silver halide phase corresponding to at least 90% of the total silver forming the final grains.

Desalting can be carried out according to methods described in Research Disclosure (hereinafter, also denoted simply as RD) 17643, section II. Thus, to remove unnecessary (or unwanted) soluble salts from a precipitation product or an emulsion which has been subjected to physical ripening, a noodle washing may be employed by allowing gelatin to be gelled or there may be used inorganic salts, anionic surfactants or anionic polymers (e.g., polystyrene-sulfonic acid). In particular, coagulation desalting using gelatin derivatives or chemically modified gelatin (such as acylated gelatin or carbamoylated gelatin) and ultrafiltration desalting employing membrane separation are preferred.

Ultrafiltration employing membrane separation can be conducted with reference to methods described in “Kagaku Kogaku Binran” (Chemical Engineering Handbook, edited by Kagaku Kogaku Kyokai, published by Maruzen) page 924-954; RD 10208 and RD 13122; JP-B Nos. 59-43727 and 62-27008 (hereinafter, the term JP-B refers to Japanese Patent publication); JP-A Nos. 62-113137, 57-209823, 59-43727, 61-219948, 62-23035, 63-40137, 63-40039, 3-140946, 2-172816, 2-172817 and 4-22942. Ultrafiltration can also be carried out employing apparatuses or methods described in JP-A Nos. 11-339923 and 11-231448.

Dispersing medium used in the preparation of silver halide emulsions relating to this invention is a compound exhibiting a protective-colloidal property. The dispersing medium is preferably allowed to be present over the stage of nucleation and grain growth in the grain formation process. Preferred dispersing medium usable in this invention is gelatin and hydrophilic colloids. There are preferably used alkali-treated or acid-treated gelatin having a molecular weight of ca. 100,000, oxidized gelatin, and enzyme-treated gelatin described in Bull. Soc. Sci. Photo. Japan No. 16, page 30 (1966). Gelatin having an average molecular eight of 10,000 to 70,000 is preferably used in the stage of nucleation of the grain formation process and gelatin having an average molecular weight of 10,000 to 50,000 is more preferred. Gelatin degradation can be done using proteinase or hydrogen peroxide. It is preferred to use gelatin having a relatively low methionine content in the nucleation stage, specifically when forming tabular silver halide grains. The methionine content is not more than 50 μmol, and more preferably not more than 20 μmol per unit weight (g) of dispersing medium. A methionine content of gelatin can be reduced by oxidizing gelatin with hydrogen peroxide or the like.

Examples of hydrophilic colloid include gelatin derivatives, graft polymer of gelatin with other polymers, proteins such as albumin or casein, cellulose derivatives such as hydroxyethyl cellulose, carboxymethyl cellulose and cellulose sulfate ester, sodium alginate, saccharide derivatives such as starch derivatives, and hydrophilic synthetic polymer material such as polyvinyl alcohol, polyvinyl alcohol partial acetal, poly-N-vinyl pyrrolidone, polyacrylic acid, polyacrylamide, polyvinyl imidazole, polyvinyl pyrazole, and copolymers of the foregoing polymers. Besides lime-processed gelatin, acid-treated gelatin and enzyme-treated gelatin described in Bull. Soc. Sci. Photo. Japan No. 16, page 30 (1966) are usable, and hydrolysis product or enzymatic degradation product of gelatin are also usable.

Silver halide grains relating to the invention may be of any form so long as having a high chloride composition. One of preferred grain forms is a cubic grain having a (100) crystal surface. Octahedral, tetradecahedral or dodecahedral grains, which can be prepared according to methods described in U.S. Pat. Nos. 4,183,756 and 4,225,666, JP-A No. 55-26589 and JP-B No. 55-42737 (hereinafter, the term, JP-B refers to published Japanese Patent), and J. Photogr. Sci. 21, 39 (1973) are also usable. Silver halide twinned crystal grains may be used. Silver halide grains having a single form are preferred and it is specifically preferred that at least two kinds of monodisperse grain emulsions be included in the same layer.

Silver halide grains used in the invention are not limited with respect to grain size but when cubic grains are used, the grain size is preferably 0.1 to 1.2 μm, and more preferably 0.15 to 1.0 μm in terms of rapid processability and sensitivity. The grain size can be determined using an approximate value of projection area or diameter. In the case when grains are substantially uniform, the grain size distribution can be represented by in terms of diameter or projection area. With regard to the grain size distribution is preferred monodisperse silver halide grains having a coefficient of variation of not more than 0.22, and more preferably not more than 0.15. The coefficient of variation is referred to as a coefficient representing a width of the grain size distribution and defined according to the following equation:

Coefficient of variation=S/R

where S is a standard deviation of grain size distribution and R is a mean grain size. Herein, the grain size is a diameter in the case of spherical grain, and in the case of being cubic, or shape other than spherical form, the grain size is a diameter of a circle having an area equivalent to the grain projected area.

There can be employed a variety of apparatuses and methods for preparing silver halide emulsions, which are generally known in the art. The silver halide can be prepared according to any of acidic precipitation, neutral precipitation and ammoniacal precipitation. Silver halide grains can formed through a single process, or through forming seed grains and growing them. A process for preparing seed grains and a growing process thereof may be the same with or different from each other.

Normal precipitation, reverse precipitation, double jet precipitation or a combination thereof is applicable as a reaction mode of a silver salt and halide salt, and the double jet precipitation is preferred. As one mode of the double jet precipitation is applicable a pAg-controlled double jet method described in JP-A 54-48521. There can be employed a apparatus for supplying a silver salt aqueous solution and a halide aqueous solution through an adding apparatus provided in a reaction mother liquor, as described in JP-A 57-92523 and 57-92524; an apparatus for adding silver salt and halide solutions with continuously varying the concentration thereof, as described in German Patent 2,921,164; and an apparatus for forming grains in which a reaction mother liquor is taken out from the reaction vessel and concentrated by ultra-filtration to keep constant the distance between silver halide grains.

Solvents for silver halide such as thioethers are optionally employed. A compound containing a mercapto group, nitrogen containing heterocyclic compound or a compound such as a sensitizing dye can also be added at the time of forming silver halide grains or after completion thereof.

In the silver halide emulsion of the invention, sensitization with a gold compound and sensitization with a chalcogen sensitizer can be employed in combination. The chalcogen sensitizer include a sulfur sensitizer, selenium sensitizer and tellurium sensitizer and of these is preferred the sulfur sensitizer. Exemplary examples of sulfur sensitizers include thiosulfates, triethylthiourea, allylthiocarbamide, thiourea, allylisothiocyanate, cystine, p-toluenethiosulfonate, rhodanine, and sulfur single substance. The amount of the sulfur sensitizer to be added to a silver halide emulsion layer, depending of the kind of a silver halide emulsion and expected effects, is preferably 5×10⁻¹⁰ to 5×10⁻⁵, and more preferably 5×10⁻⁸ to 3×10⁻⁵ mole per mole of silver halide. The gold sensitizer such as chloroauric acid or gold sulfide is added in the form of a complex. Compounds, such as dimethylrhodanine, thiocyanic acid, mercaptotetrazole and mercaptotriazole are used as a ligand. The amount of the gold compound to be added, depending of the kind of a silver halide emulsion, the kind of the compound and ripening conditions, is preferably 1×10⁻⁸ to 1×10⁴, and more preferably 1×10⁻⁸ to 1×10⁻⁵ mole per mole of silver halide. Silver halide emulsions used in the invention may be chemically sensitized by reduction sensitization.

A antifoggant or a stabilizer known in the art are incorporated into the photographic material, for the purpose of preventing fog produced during the process of preparing the photographic material, reducing variation of photographic performance during storage or preventing fog produced in development. Examples of preferred compounds for the purpose include compounds represented by formula (II) described in JP-A 2-146036 at page 7, lower column. These compounds are added in the step of preparing a silver halide emulsion, the chemical sensitization step or during the course of from completion of chemical sensitization to preparation of a coating solution. In cases when chemical sensitization is undergone in the presence of these compounds, the amount thereof is preferably 1×10⁻⁵ to 5×10⁻⁴ mole per mole of silver halide. In cases when added after chemical sensitization, the amount thereof is preferably 1×10⁻⁶ to 1×10⁻², and more preferably 1×10⁻⁵ to 5×10⁻³ mol per mole of silver halide. In cases when added at the stage of preparing a coating solution, the amount is preferably 1×10⁻⁶ to 1×10⁻¹, and more preferably 1×10⁻⁵ to 1×10⁻² mole per mol of silver halide. In case where added to a layer other than a silver halide emulsion layer, the amount is preferably 1×10⁻⁹ to 1×10⁻³ mole/m².

There are employed dyes having absorption at various wavelengths for anti-irradiation and anti-halation in the photographic material relating to the invention. A variety of dyes known in the art can be employed, including dyes having absorption in the visible range described in JP-A 3-251840 at page 30, AI-1 to 11, and JP-A No. 6-3770; infra-red absorbing dyes described in JP-A No. 1-280750 at page 2, left lower column, formula (I), (II) and (III). These dyes do not adversely affect photographic characteristics of a silver halide emulsion and there is no stain due to residual dyes. For the purpose of improving sharpness, the dye is preferably added in an amount that gives a reflection density at 680 nm of not less than 0.7 and more preferably not less than 0.8.

Fluorescent brightening agents are also incorporated into the photographic material to improve whiteness. Examples of preferred compounds include those represented by formula II described in JP-A No. 2-232652.

In cases when a silver halide photographic light sensitive material according to the invention is employed as a color photographic material, the photographic material comprises layer(s) containing silver halide emulsion(s) which are spectrally sensitized in the wavelength region of 400 to 900 nm, in combination with a yellow coupler, a magenta coupler and a cyan coupler. The silver halide emulsion contains one or more kinds of sensitizing dyes, singly or in combination thereof.

In the silver halide emulsions can be employed a variety of spectral-sensitizing dyes known in the art. Compounds BS-1 to 8 described in JP-A 3-251840 at page 28 are preferably employed as a blue-sensitive sensitizing dye. Compounds GS-1 to 5 described in JP-A 3-251840 at page 28 are preferably employed as a green-sensitive sensitizing dye. Compounds RS-1 to 8 described in JP-A 3-251840 at page 29 are preferably employed as a red-sensitive sensitizing dye. In cases where exposed to infra-red ray with a semiconductor laser, infrared-sensitive sensitizing dyes are employed. Compounds IRS-1 to 11 described in JP-A 4-285950 at pages 6-8 are preferably employed as a blue-sensitive sensitizing dye. Supersensitizers SS-1 to SS-9 described in JP-A 4-285950 at pages 8-9 and compounds S-1 to S-17 described in JP-A 5-66515 at pages 5-17 are preferably included, in combination with these blue-sensitive, green-sensitive and red-sensitive sensitizing dyes. The sensitizing dye is added at any time during the course of silver halide grain formation to completion of chemical sensitization. The sensitizing dye is incorporated through solution in water-miscible organic solvents such as methanol, ethanol, fluorinated alcohol, acetone and dimethylformamide or water, or in the form of solid particle dispersion.

As couplers used in silver halide photographic materials relating to the invention is usable any compound capable of forming a coupling product exhibiting an absorption maximum at the wavelength of 340 nm or longer, upon coupling with an oxidation product of a developing agent. Representative examples thereof include yellow dye forming couplers exhibiting an absorption maximum at the wavelength of 350 to 500 nm, magenta dye forming couplers exhibiting an absorption maximum at the wavelength of 500 to 600 nm and cyan dye forming couplers exhibiting an absorption maximum at the wavelength of 600 to 750 nm.

Examples of preferred cyan couplers include those which are represented by general formulas (C-I) and (C-II) described in JP-A 4-114154 at page 5, left lower column. Exemplary compounds described therein (page 5, right lower column to page 6, left lower column) are CC-1 to CC-9.

Examples of preferred magenta couplers include those which are represented by general formulas (M-I) and (M-II) described in JP-A No. 4-114154 at page 4, right upper column. Exemplary compounds described therein (page 4, left lower column to page 5, right upper column) are MC-1 to M

C-11. Of these magenta couplers are preferred couplers represented by formula (M-I) described in ibid, page 4, right upper column; and couplers in which R_{M} in formula (M-I) is a tertiary alkyl group are specifically preferred. Further, couplers MC-8 to MC-11 are superior in color reproduction of blue to violet and red, and in representation of details. Examples of the foregoing coupler represented by formula (M-1) include exemplary compounds 1 through 64, described in JP-A No. 63-253943, page 5-9; compounds M-1 through M-29 described in JP-A No. 2-100048, page 5-6; compound (1) through (36) described in JP-A No. 7-175186, page 5-12; compound M-1 through M-33 described in JP-A No. 7-219170, page 14-22; compound M-1 through M-16. described in JP-A No. 8-304972, page 5-9; compound M-1 through M-26 described in JP-A No. 10-207024, page 5-10; compound M-1 through M-36 described in JP-A No. 10-207025, page 5-22; compound M-1 through M-24 described in U.S. Pat. No. 5,576,150, page 3-6; compound M-1 through M-48 escribed in U.S. Pat. No. 5,609,996, page 3-9; compound M-1 through M-23 described in U.S. Pat. No. 5,667,952, page 3-5; and compound M-1 through M-26 described in U.S. Pat. No. 5,698,386, page 3-6.

Examples of preferred yellow couplers include those which are represented by general formula (Y-I) described in JP-A No. 4-114154 at page 3, right upper column. Exemplary compounds described therein (page 3, left lower column) are YC-1 to YC-9. Of these yellow couplers are preferred couplers in which RY1 in formula (Y-I) is an alkoxy group are specifically preferred or couplers represented by formula [I] described in JP-A No. 6-67388. Specifically preferred examples thereof include YC-8 and YC-9 described in JP-A No. 4-114154 at page 4, left lower column and Nos. (1) to (47). described in JP-A No. 6-67388 at pages 13-14. Still more preferred examples include compounds represented by formula [Y-1] described in JP-A No. 4-81847 at page 1 and pages 11-17.

When an oil-in-water type-emulsifying dispersion method is employed for adding couplers and other organic compounds used for the photographic material of the present invention, in a water-insoluble high boiling organic solvent, whose boiling point is 150° C. or more, a low boiling and/or a water-soluble organic solvent are combined if necessary and dissolved. In a hydrophilic binder such as an aqueous gelatin solution, the above-mentioned solutions are emulsified and dispersed by the use of a surfactant. As a dispersing means, a stirrer, a homogenizer, a colloidal mill, a flow jet mixer and a supersonic dispersing machine may be used. Preferred examples of the high boiling solvents include phthalic acid esters such as dioctyl phthalate, diisodecyl phthalate, and dibutyl phthalate; and phosphoric acid esters such as tricresyl phosphate and trioctyl phosphate. High boiling solvents having a dielectric constant of 3.5 to 7.0 are also preferred. These high boiling solvents may be used in combination. Instead of or in combination with the high boiling solvent is employed a water-insoluble and organic solvent-soluble polymeric compound, which is optionally dissolved in a low boiling and/or water-soluble organic solvent and dispersed in a hydrophilic binder such as aqueous gelatin using a surfactant and various dispersing means. In this case, examples of the water-insoluble and organic solvent-soluble polymeric compound include poly(N-t-butylacrylamide).

As a surfactant used for adjusting surface tension when dispersing or coating photographic additives, the preferable compounds are those containing a hydrophobic group having 8 through 30 carbon atoms and a sulfonic acid group or its salts in a molecule. Exemplary examples thereof include A-1 through A-11 described in JP-A No. 64-26854. In addition, surfactants, in which a fluorine atom is substituted to an alkyl group, are also preferably used. The dispersion is conventionally added to a coating solution containing a silver halide emulsion. The elapsed time from dispersion until addition to the coating solution and the time from addition to the coating solution until coating are preferably short. They are respectively preferably within 10 hours, more preferably within 3 hours and still more preferably within 20 minutes.

To each of the above-mentioned couplers, to prevent color fading of the formed dye image due to light, heat and humidity, an anti-fading agent may be added singly or in combination. The preferable compounds or a magenta dye are phenyl ether type compounds represented by Formulas I and II in JP-A No. 2-66541, phenol type compounds represented by Formula IIIB described in JP-A No. 3-174150, amine type compounds represented by Formula A described in JP-A No. 64-90445 and metallic complexes represented by Formulas XII, XIII, XIV and XV described in JP-A No. 62-182741. The preferable compounds to form a yellow dye and a cyan dye are compounds represented by Formula I′ described in JP-A No. 1-196049 and compounds represented by Formula II described in JP-A No. 5-11417.

A compound (d-11) described in JP-A No. 4-114154 at page 9, left lower column and a compound (A′-1) described in the same at page 10, left lower column are also employed for allowing the absorption wavelengths of a dye to shift. Besides can also be employed a compound capable of releasing a fluorescent dye described in U.S. Pat. No. 4,774,187.

It is preferable that a compound reacting with the oxidation product of a color developing agent be incorporated into a layer located between light-sensitive layers for preventing color staining and that the compound is added to the silver halide emulsion layer to decrease fogging. As a compound for such purposes, hydroquinone derivatives are preferable, and dialkylhydroquinone such as 2,5-di-t-octyl hydroquinone are more preferable. The specifically preferred compound is a compound represented by Formula II described in JP-A No. 4-133056, and compounds II-1 through II-14 described in the above-mentioned specification pp. 13 through 14 and compound 1 described on page 17.

In the photographic material according to the present invention, it is preferable that static fogging is prevented and light-durability of the dye image is improved by adding a UV absorber. The preferable UV absorbent is benzotriazoles. The specifically preferable compounds are those represented by Formula III-3 in JP-A No. 1-250944, those represented by Formula III described in JP-A No. 64-66646, UV-1L through UV-27L described in JP-A No. 63-187240, those represented by Formula I described in JP-A No. 4-1633 and those represented by Formulas (I) and (II) described in JP-A No. 5-165144.

In the photographic materials used in the invention is advantageously employed gelatin as a binder. Furthermore, there can be optionally employed other hydrophilic colloidal materials, such as gelatin derivatives, graft polymers of gelatin with other polymers, proteins other than gelatin, saccharide derivatives, cellulose derivatives and synthetic hydrophilic polymeric materials. A vinylsulfone type hardening agent or a chlorotriazine type hardening agent is employed as a hardener of the binder, and compounds described in JP-A 61-249054 and 61-245153 are preferably employed. An antiseptic or antimold described in JP-A 3-157646 is preferably incorporated into a hydrophilic colloid layer to prevent the propagation of bacteria and mold which adversely affect photographic performance and storage stability of images. A lubricant or a matting agent is also preferably incorporated to improve surface physical properties of raw or processed photographic materials.

A variety of supports are employed in the photographic material used in the invention, including paper coated with polyethylene or polyethylene terephthalate, paper support made from natural pulp or synthetic pulp, polyvinyl chloride sheet, polypropylene or polyethylene terephthalate supports which may contain a white pigment, and baryta paper. Of these supports a paper support coated, on both sides, with water-proof resin layer. As the water-proof resin are preferably employed polyethylene, ethylene terephthalate and a copolymer thereof. Inorganic and/or organic white pigments are employed, and inorganic white pigments are preferably employed. Examples thereof include alkaline earth metal sulfates such as barium sulfate, alkaline earth metal carbonates such as calcium carbonate, silica such as fine powdery silicate and synthetic silicate, calcium silicate, alumina, alumina hydrate, titanium oxide, zinc oxide, talc, and clay. Preferred examples of white pigments include barium sulfate and titanium oxide. The amount of the white pigment to be added to the water-proof resin layer on the support surface is preferably not less than 13% by weight, and more preferably not less than 15% by weight to improve sharpness. The dispersion degree of a white pigment in the water-proof resin layer of paper support can be measured in accordance with the procedure described in JP-a 2-28640. In this case, the dispersion degree, which is represented by a coefficient of variation, is preferably not more than 020, and more preferably not more than 0.15.

Supports having a center face roughness (Sra) of 0.15 nm or less (preferably, 0.12 nm or less) are preferably employed in terms of glossiness. Trace amounts of a blueing agent or reddening agent such as ultramarine or oil-soluble dyes are incorporated in a water-proof resin layer containing a white pigment or hydrophilic layer(s) of a reflection support to adjust the balance of spectral reflection density in a white portion of processed materials and improve its whiteness. The surface of the support may be optionally subjected to corona discharge, UV light exposure or flame treatment and further thereon, directly or through a sublayer (i.e., one or more sublayer for making improvements in surface properties of the support, such as adhesion property, antistatic property, dimensional stability, friction resistance, hardness, anti halation and/or other characteristics), are coated component layers of the photographic material relating to the invention. In coating of the photographic material, a thickening agent may be employed to enhance coatability of a coating solution. As a coating method are useful extrusion coating and curtain coating, in which two or more layers are simultaneously coated.

To form photographic images using a photographic material relating to the invention, an image recorded on the negative can optically be formed on a photographic material to be printed. Alternatively, the image is converted to digital information to form the image on a CRT (anode ray tube), and the resulting image can be formed on a photographic material to be printed by projecting or scanning with varying the intensity and/or exposing time of laser light, based on the digital information.

It is preferable to apply the present invention to a photographic material wherein a developing agent is not incorporated in the photographic material. Examples of such a photographic material include color paper, color reversal paper, positive image forming photographic material, photographic material used for display, and photographic material used for color proof. Application to photographic material having a reflective support is specifically preferred.

Commonly known aromatic primary amine developing agents are employed in the invention. Examples thereof include:

CD-1) N,N-diethyl-p-phenylendiamine,

CD-2) 2-amino-5-diethylaminotoluene,

CD-3) 2-amino-S-(N-ethyl-N-laurylamino)toluene,

CD-4) 4-(N-ethyl-N-(β-hydroxyethyl)amino)-aniline,

CD-5) 2-methyl-4- (N-ethyl-N-(β-hydroxyethyl)amino)aniline,

CD-6) 4-amino-3-methyl-N-ethyl-N-(β-methanesulfoneamidoethyl)aniline,

CD-7) 4-amino-3-β-methanesulfoneamidoethyl-N,N-diethyl-aniline

CD-8) N,N-dimethyl-p-phenylenediamine,

CD-9) 4-amino-3-methyl-N-ethyl-N-metoxyethylaniline,

CD-10) 4-amino-3-methyl-N-ethyl-N-(β-ethoxyethyl)aniline,

CD-11) 4-amino-3-methyl-N-ethyl-N-(γ-hydroxypropyl)-aniline.

The pH of a color developing solution is optional, but preferably 9.5 to 13.0, and more preferably 9.8 to 12.0 in terms of rapid access. The higher color development temperature enables more rapid access, but the temperature is preferably 35 to 70° C., and more preferably 37 to 60° C. in terms of stability of processing solutions. The color developing time is conventionally 3 min. 30 sec. but the developing time in the invention is preferably not longer than 40 sec., and more preferably not longer than 25 sec.

In addition to the developing agents described above, the developing solution is added with commonly known developer component compounds, including an alkaline agent having pH-buffering action, a development inhibiting agent such as chloride ion or benzotriazole, a preservative, and a chelating agent.

In the image forming method according to the invention, photographic materials, after color-developed, may be optionally subjected to bleaching and fixing. The bleaching and fixing may be carried out currently. After fixing, washing is conventionally carried out. Stabilizing may be conducted in place of washing. As a processing apparatus used in the invention is applicable a roller transport type processor in which a photographic material is transported with being nipped by rollers and an endless belt type processor in which a photographic material is transported with being fixed in a belt. Further thereto are also employed a method in which a processing solution supplied to a slit-formed processing bath and a photographic material is transported therethrough, a spraying method, a web processing method by contact with a carrier impregnated with a processing solution and a method by use of viscous processing solution. A large amount of photographic materials are conventionally processed using an automatic processor. In this case, the less replenishing rate is preferred and an environmentally friendly embodiment of processing is replenishment being made in the form of a solid tablet, as described in KOKAI-GIHO (Disclosure of Techniques) 94-16935.

### EXAMPLES

The present invention will be further described based on examples but are by no means limited to these examples.

### Example 1

### Preparation of Silver Halide Emulsion

Preparation of Silver Halide Emulsion (R-1)

To 1 liter of an aqueous 2% solution of deionized ossein gelatin (containing 10 ppm calcium), maintained at 40° C. were solutions (A1) and (B1) for 30 min, while controlling the pAg and pH at 7.3 and 3.0, respectively. Subsequently, solutions (A2) and (B2) were added for 90 min with controlling the pAg and pH at 8.0 and 5.5, respectively. Then, solutions (A3) and (B3) were added over 15 min. with controlling the pAg and pH at 8.0 and 5.5, respectively. The pAg was controlled in accordance with the method described in JP-A No. 59-45437 and the pH was controlled using aqueous sulfuric acid or sodium hydroxide solution.

| Solution (A1) | | |
|---|---|---|
| Sodium chloride | 3.42 | g |
| Potassium bromide | 0.03 | g |
| Water to make | 200 | ml |
| Solution (A2) | | |
| Sodium chloride | 71.9 | g |
| K₂IrCl₆ | 3.0 × 10⁻⁸ | mol/mol AgX |
| K₂IrBr₆ | 1.0 × 10⁻⁸ | mol/mol AgX |
| K₄Fe(CN)₆ | 2.0 × 10⁻⁵ | mol/mol AgX |
| Potassium bromide | 0.7 | g |
| Water to make | 420 | ml |
| Solution (A3) | | |
| Sodium chloride | 30.8 | g |
| Potassium bromide | 0.3 | g |
| Water to make | 180 | ml |
| Solution (B1) | | |
| Silver nitrate | 10 | g |
| Water to make | 200 | ml |
| Solution (B2) | | |
| Silver nitrate | 210 | g |
| Water to make | 420 | ml |
| Solution (B3) | | |
| Silver nitrate | 90 | g |
| Water to make | 180 | ml |

After completing addition, an aqueous 5% solution containing 30 g of chemically-modified gelatin (modification rate of 95%), in which an amino group of gelatin was phen-ylcarbamoylated, was added to perform desalting in accordance with the method described in JP-A No. 5-72658, and an aqueous gelatin solution was further added thereto to obtain silver halide emulsion (R-1) comprising monodisperse cubic grains having an average grain size (cubic equivalent edge length) of 0.40 μm, a coefficient of variation of grain size of 0.07, a chloride content of 99.5 mol % and a bromide content of 0.5 mol %.

In the silver halide emulsion (R-1), the grain growth portion formed by solutions (A1) and (B1) is designated “seed portion”, the growth portion formed by solutions (A2) and (B2) is designated “core portion” and the growth portion formed by solutions (A3) and (B3) is designated “shell portion”. The seed portion, core portion and shell portion accounted for 3.3%. 66.7% and 30.0% by volume, respectively.

Preparation of Silver Halide Emulsion (R-2)

Silver halide emulsion (R-2) was prepared similarly to the foregoing silver halide emulsion (R-1), except that an iridium compound of solution (A2) was varied as below.

| | |
|---|---|
| K₂IrCl₆ | 1.5 × 10⁻⁸ mol/mol AgX |
| K₂IrCl₆(H₂O) | 2.0 × 10⁻⁷ mol/mol AgX |
| K₂IrCl₆(thiazole) | 5.0 × 10⁻⁹ mol/mol AgX |

Preparation of Silver Halide Emulsion (R-3)

Silver halide emulsion (R-3) was prepared similarly to the foregoing silver halide emulsion (R-2), except that compound (S-1-4) was added to solutions (A1), (A2) and (A3) in an amount of 2.1×10⁻⁶ mol/mol·AgX, 5.3×10⁻⁵ mol/mol·AgX and 9.0×10⁻⁶ mol/mol·AgX, respectively, based on final grains.

Preparation of Silver Halide Emulsion (R-4)

Silver halide emulsion (R-4) was prepared similarly to the foregoing silver halide emulsion (R-2), except that compound (S-2-4) was added to solutions (A1), (A2) and (A3) in an amount of 2.1×10⁻⁶ mol/mol·AgX, 5.3×10⁻⁵ mol/mol·AgX and 9.0×10⁻⁶ mol/mol·AgX, respectively, based on final grains.

Preparation of Silver Halide Emulsion (R-5)

Silver halide emulsion (R-5) was prepared similarly to the foregoing silver halide emulsion (R-4), except that after forming silver halide grains by adding solutions (A1) to (A3) and solutions (B1) to (B3), an aqueous 5% solution containing 30 g of chemically-modified gelatin (modification rate of 95%), in which an amino group of gelatin was phenylcarbamoylated, was added to perform desalting in accordance with the method described in JP-A No. 5-72658 and 0.0018 mol of fine silver bromide grains (grain size of 0.02 μm) was added to form bromide-localized phases in the vicinity of the corners of the grains. The thus prepared silver halide emulsion (R-5) was comprised of monodisperse cubic grains having an average grain size (cubic equivalent edge length) of 0.40 μm, a coefficient of variation of grain size of 0.07, a chloride content of 99.4 mol % and a bromide content of 0.6 mol %.

Preparation of Silver Halide Emulsion (R-6)

Silver halide emulsion (R-6) was prepared similarly to the foregoing silver halide emulsion (R-5), except that a ruthenium compound described below was added to solution (A2); when addition of solutions (A3) and (B3) reached 65% of the total, the addition of silver nitrate and halide solutions was interrupted and 7.2 ml of aqueous 0.5 M potassium iodide solution was added; then, the addition of silver nitrate and halide solutions was restarted. The thus prepared silver halide emulsion (R-6) was comprised of monodisperse cubic grains having an average grain size (cubic equivalent edge length) of 0.40 μm, a coefficient of variation of grain size of 0.07, a chloride content of 99.0 mol %, a bromide content of 0.8 mol % and a iodide content of 0.2 mol %.

| | |
|---|---|
| K₂[Ru(NO)Cl₅] | 9.0 × 10⁻⁹ mol/mol AgX |

Preparation of Red-Sensitive Silver Halide Emulsion (R-1a)

To the foregoing silver halide emulsion (R-1), sensitizing dyes (RS-1) and (RS-2) were added at 60° C., a pH of 5.0 and a pAg of 7.1 and subsequently, sodium thiosulfate and chloroauric acid were added to perform spectral sensitization and chemical sensitization. Following the addition of chemical sensitizers and when optimally ripened, compound (S-2-5) was added to stop ripening. There was thus obtained red-sensitive silver halide emulsion (R-1a).

| | |
|---|---|
| Sodium thiosulfate | 1.2 × 10⁻⁵ mol/mol AgX |
| Chloroauric acid | 1.5 × 10⁻⁵ mol/mol AgX |
| Compound S-2-5 | 1.2 × 10⁻⁴ mol/mol AgX |
| Sensitizing dye RS-1 | 1.0 × 10⁻⁴ mol/mol AgX |
| Sensitizing dye RS-2 | 1.0 × 10⁻⁴ mol/mol AgX |

Preparation of Red-Sensitive Silver Halide Emulsion (R-1b)

Red-sensitive silver halide emulsion (R-1b) was prepared similarly to the foregoing red-sensitive silver halide emulsion (R-1a), except that the amount of sodium thiosulfate added was changed to 9.0×10⁻⁶ mol/mol·AgX and after the addition of sodium thiosulfate, 3.0×10⁻⁶ mol/mol·AgX of triphenylphosphine selenide was added and then, chloroauric acid was further added thereto.

Preparation of Red-Sensitive Silver Halide Emulsion (R-1c)

Red-sensitive silver halide emulsion (R-1c) was prepared similarly to the red-sensitive silver halide emulsion (R-1a), except that the amount of sodium thiosulfate added was changed to 9.0×10⁻⁶ mol/mol·AgX and after the addition of sodium thiosulfate, 3.0×10⁻⁶ mol/mol·AgX of trifurylphosphine selenide was added and then, chloroauric acid was further added thereto.

Preparation of Red-Sensitive Silver Halide Emulsion (R-1d)

Red-sensitive silver halide emulsion (R-1d) was prepared similarly to the red-sensitive silver halide emulsion (R-1c), except that 1.8×10⁻⁵ mol/mol·AgX of fine silver-gold sulfide particle (average particle size of 60 Å) which were prepared in accordance with JP-B No. 2929325 was added in place of the addition of sodium thiosulfate and chloroauric acid.

Preparation of Red-Sensitive Silver Halide Emulsion (R-1e)

Red-sensitive silver halide emulsion (R-1e) was prepared similarly to the red-sensitive silver halide emulsion (R-1c), except that 1.5×10⁻⁵ mol/mol·AgX of fine gold sulfide particle (average particle size of 60 Å) which were prepared in accordance with JP-B No. 2929325 was added in place of the addition of sodium thiosulfate and chloroauric acid.

Preparation of Red-Sensitive Silver Halide Emulsion (R-2a), (R-3a), (R-4a) (R-5a) and (R-6a)

Similarly to the red-sensitive silver halide emulsion (R-1d), red-sensitive silver halide emulsions (R-2a), (R-3a), (R-4a) (R-5a) and (R-6a) were prepared using the foregoing silver halide emulsions (R-2), (R-3), (R-4), (R-5) and (R-6), respectively.

Preparation of Red-Sensitive Silver Halide Emulsion (R-2b), (R-3b), (R-4b) (R-5b) and (R-6b)

Similarly to the red-sensitive silver halide emulsion (R-1e), red-sensitive silver halide emulsions (R-2b), (R-3b), (R-4b) (R-5b) and (R-6b) were prepared using silver halide emulsions (R-2), (R-3), (R-4), (R-5) and (R-6), respectively.

Preparation of Red-Sensitive Silver Halide Emulsion (R-6c)

Red-sensitive silver halide emulsion (R-6c) was prepared similarly to the red-sensitive silver halide emulsion (R-6b), except that fine gold sulfide particles (60 Å) was replaced by fine gold sulfide particles (30 Å)

Preparation of Red-Sensitive Silver Halide Emulsion (R-6d)

Red-sensitive silver halide emulsion (R-6d) was prepared similarly to the red-sensitive silver halide emulsion (R-6b), except that triphenylphosphine selenide was replaced by 3.0×10⁻⁶ mol/mol·AgX of N,N-dimethylselenourea.

In the foregoing preparation of red-sensitive silver halide emulsions, 2.0×10⁻³ mol/mol·AgX of SS-1 was added.

Preparation of Silver Halide Emulsion (G-1) to (G-4)

Silver halide emulsions (G-1) to (G-4), which were each comprised of monodisperse cubic silver halide grains having an average grain size (cubic equivalent edge length) of 0.50 μm, a coefficient of variation of grain size of 0.08, a chloride content of 99.5 mol % and a bromide content of 0.5 mol %, were respectively prepared similarly to the foregoing silver halide emulsions (R-1) to (R-4), except that the time of addition of solutions (A1), (B1), (A2), (B2), (A3) and (B3) was optimally varied.

Preparation of Silver Halide Emulsion (G-5)

A silver halide emulsion (G-5), which was comprised of monodisperse cubic silver halide grains having an average grain size (cubic equivalent edge length) of 0.50 μm, a coefficient of variation of grain size of 0.08, a chloride content of 99.4 mol % and a bromide content of 0.6 mol %, was prepared similarly to the foregoing silver halide emulsions (R-5), except that the time of addition of solutions (A1), (B1), (A2), (B2), (A3) and (B3) was optimally varied.

Preparation of Silver Halide Emulsion (G-6)

A silver halide emulsion (G-6), which was comprised of monodisperse cubic silver halide grains having an average grain size (cubic equivalent edge length) of 0.50 μm, a coefficient of variation of grain size of 0.08, a chloride content of 99.2 mol %, a bromide content of 0.6 mol % and an iodide content of 0.2 mol %, was prepared similarly to the foregoing silver halide emulsions (R-6), except that the time of addition of solutions (A1), (B1), (A2), (B2), (A3) and (B3) was optimally varied.

Preparation of Green-Sensitive Silver Halide Emulsion (G-1a)

To the foregoing silver halide emulsion (G-1), sensitizing dye (GS-1) was added at 60° C., a pH of 5.8 and a pAg of 7.5 and subsequently, sodium thiosulfate and chloroauric acid were added to perform spectral sensitization and chemical sensitization. Following the addition of chemical sensitizers and when optimally ripened, compound (S-2-5) was added to stop ripening. There was thus obtained green-sensitive silver halide emulsion (G-1a).

| | |
|---|---|
| Sensitizing dye GS-1 | 4.0 × 10⁻⁴ mol/mol AgX |
| Sodium thiosulfate | 4.5 × 10⁻⁶ mol/mol AgX |
| Chloroauric acid | 1.5 × 10⁻⁵ mol/mol AgX |
| Compound S-2-5 | 1.5 × 10⁻⁴ mol/mol AgX |

Preparation of Green-Sensitive Silver Halide Emulsion (G-1b)

Green-sensitive silver halide emulsion (G-1b) was prepared similarly to the foregoing green-sensitive silver halide emulsion (G-1a), except that the amount of sodium thiosulfate added was changed to 1.5×10⁻⁶ mol/mol·AgX and after the addition of sodium thiosulfate, 2.5×10⁻⁶ mol/mol·AgX of triphenylphosphine selenide was added and then, chloroauric acid was further added thereto.

Preparation of Green-Sensitive Silver Halide Emulsion (G-1c)

Green-sensitive silver halide emulsion (G-1c) was prepared similarly to the green-sensitive silver halide emulsion (G-1a), except that the amount of sodium thiosulfate added was changed to 1.5×10⁻⁶ mol/mol·AgX and after the addition of sodium thiosulfate, 2.5×10⁻⁶ mol/mol·AgX of trifurylphosphine selenide was added and then, chloroauric acid was further added thereto.

Preparation of Green-Sensitive Silver Halide Emulsion (G-1d)

Green-sensitive silver halide emulsion (G-1d) was prepared similarly to the green-sensitive silver halide emulsion (G-1c), except that 1.5×10⁻⁵ mol/mol·AgX of fine silver-gold sulfide particle (average particle size of 60 Å) which were prepared in accordance with JP-B No. 2929325 was added in place of the addition of sodium thiosulfate and chloroauric acid.

Preparation of Green-Sensitive Silver Halide Emulsion (G-1e)

Green-sensitive silver halide emulsion (G-1e) was prepared similarly to the green-sensitive silver halide emulsion (G-1c), except that 1.2×10⁻⁵ mol/mol·AgX of fine gold sulfide particle (average particle size of 60 Å) which were prepared in accordance with JP-B No. 2929325 was added in place of the addition of sodium thiosulfate and chloroauric acid.

Preparation of Green-Sensitive Silver Halide Emulsion (G-2a), (G-3a), (G-4a) (G-5a) and (G-6a)

Similarly to the red-sensitive silver halide emulsion (G-1d), green-sensitive silver halide emulsions (G-2a), (G-3a), (G-4a) (G-5a) and (G-6a) were prepared using the foregoing silver halide emulsions (G-2), (G-3), (G-4), (G-5) and (G-6), respectively.

Preparation of Green-Sensitive Silver Halide Emulsion (G-2b), (G-3b), (G-4b) (G-5b) and (G-6b)

Similarly to the red-sensitive silver halide emulsion (G-1e), red-sensitive silver halide emulsions (G-2b), (G-3b), (G-4b) (G-5b) and (G-6b) were prepared using silver halide emulsions (G-2), (G-3), (G-4), (G-5) and (G-6), respectively.

Preparation of Green-Sensitive Silver Halide Emulsion (G-6c)

Green-sensitive silver halide emulsion (G-6c) was prepared similarly to the green-sensitive silver halide emulsion (G-6b), except that fine gold sulfide particles (60 Å) was replaced by fine gold sulfide particles (30 Å)

Preparation of Green-Sensitive Silver Halide Emulsion (G-6d)

Geen-sensitive silver halide emulsion (G-6d) was prepared similarly to the green-sensitive silver halide emulsion (G-6b), except that triphenylphosphine selenide was replaced by 3.0×10⁻⁶ mol/mol·AgX of N,N-dimethylselenourea.

Preparation of Silver Halide Emulsion (B-1) to (B-4)

Silver halide emulsions (B-1) to (B-4), which were each comprised of monodisperse cubic silver halide grains having an average grain size (cubic equivalent edge length) of 0.65 μm, a coefficient of variation of grain size of 0.08, a chloride content of 99.5 mol % and a bromide content of 0.5 mol %, were each prepared similarly to the foregoing silver halide emulsions (R-1) to (R-4), except that the time of addition of solutions (A1), (B1), (A2), (B2), (A3) and (B3) was optimally varied.

Preparation of Silver Halide Emulsion (B-5)

A silver halide emulsion (B-5), which was comprised of monodisperse cubic silver halide grains having an average grain size (cubic equivalent edge length) of 0.65 μm, a coefficient of variation of grain size of 0.08, a chloride content of 99.4 mol % and a bromide content of 0.6 mol %, was prepared similarly to the foregoing silver halide emulsions (R-5), except that the time of addition of solutions (A1), (B1), (A2), (B2), (A3) and (B3) was optimally varied.

Preparation of Silver Halide Emulsion (B-6)

A silver halide emulsion (B-6), which was comprised of monodisperse cubic silver halide grains having an average grain size (cubic equivalent edge length) of 0.65 μm, a coefficient of variation of grain size of 0.08, a chloride content of 99.2 mol %, a bromide content of 0.6 mol % and an iodide content of 0.2 mol %, was prepared similarly to the foregoing silver halide emulsions (R-6), except that the time of addition of solutions (A1), (B1), (A2), (B2), (A3) and (B3) was optimally varied.

Preparation of Blued-Sensitive Silver Halide Emulsion (B-1a)

To the foregoing silver halide emulsion (B-1), sensitizing dyes (BS-1) and (BS-2) were added at 60° C., a pH of 5.8 and a pAg of 7.5 and subsequently, sodium thiosulfate and chloroauric acid were added to perform spectral sensitization and chemical sensitization. Following the addition of chemical sensitizers and when optimally ripened, compounds (S-2-5), (S-2-2) and (S-2-3) were added to stop ripening. There was thus obtained red-sensitive silver halide emulsion (B-1a).

| | |
|---|---|
| Sodium thiosulfate | 5.0 × 10⁻⁶ mol/mol AgX |
| Chloroauric acid | 1.5 × 10⁻⁵ mol/mol AgX |
| Compound S-2-5 | 3.0 × 10⁻⁴ mol/mol AgX |
| Compound S-2-2 | 3.0 × 10⁻⁴ mol/mol AgX |
| Compound S-2-3 | 3.0 × 10⁻⁴ mol/mol AgX |
| Sensitizing dye BS-1 | 4.0 × 10⁻⁴ mol/mol AgX |
| Sensitizing dye BS-2 | 1.0 × 10⁻⁴ mol/mol AgX |

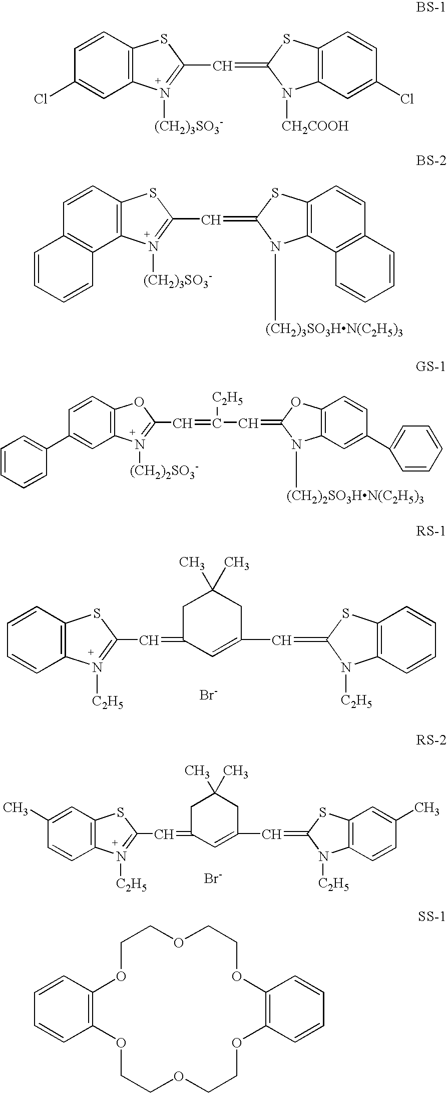

Preparation of Blue-Sensitive Silver Halide Emulsion (B-1b)

Blue-sensitive silver halide emulsion (B-1b) was prepared similarly to the foregoing blue-sensitive silver halide emulsion (B-1a), except that the amount of sodium thiosulfate added was changed to 3.0×10⁻⁶ mol/mol·AgX and after the addition of sodium thiosulfate, 2.0×10⁻⁶ mol/mol·AgX of triphenylphosphine selenide was added and then, chloroauric acid was further added thereto.

Preparation of Blue-Sensitive Silver Halide Emulsion (B-1c)

Blue-sensitive silver halide emulsion (B-1c) was prepared similarly to the blue-sensitive silver halide emulsion (B-1a), except that the amount of sodium thiosulfate added was changed to 3.0×10⁻⁶ mol/mol·AgX and after the addition of sodium thiosulfate, 2.0×10⁻⁶ mol/mol·AgX of trifurylphosphine selenide was added and then, chloroauric acid was further added thereto.

Preparation of Blue-Sensitive Silver Halide Emulsion (B-1d)

Blue-sensitive silver halide emulsion (B-1d) was prepared similarly to the blue-sensitive silver halide emulsion (B-1c), except that 1.5×10⁻⁵ mol/mol·AgX of fine silver-gold sulfide particle (average particle size of 60 Å) which were prepared in accordance with JP-B No. 2929325 was added in place of the addition of sodium thiosulfate and chloroauric acid.

Preparation of Blue-Sensitive Silver Halide Emulsion (B-1e)

Blue-sensitive silver halide emulsion (B-1e) was prepared similarly to the blue-sensitive silver halide emulsion (B-1c), except that 1.2×10⁻⁵ mol/mol·AgX of fine gold sulfide particle (average particle size of 60 Å) which were prepared in accordance with JP-B No. 2929325 was added in place of the addition of sodium thiosulfate and chloroauric acid.

Preparation of Blue-Sensitive Silver Halide Emulsion (B-2a), (B-3a), (B-4a) (B-5a) and (B-6a)

Similarly to the blue-sensitive silver halide emulsion (B-1d), blue-sensitive silver halide emulsions (B-2a), (B-3a), (B-4a) (B-5a) and (B-6a) were prepared using the foregoing silver halide emulsions (B-2), (B-3), (B-4), (B-5) and (B-6), respectively.

Preparation of Blue-Sensitive Silver Halide Emulsion (B-2b), (B-3b), (B-4b) (B-5b) and (B-6b)

Similarly to the blue-sensitive silver halide emulsion (B-1e), blue-sensitive silver halide emulsions (B-2b), (B-3b), (B-4b) (B-5b) and (B-6b) were prepared using silver halide emulsions (B-2), (B-3), (B-4), (B-5) and (B-6), respectively.

Preparation of Blue-Sensitive Silver Halide Emulsion (B-6c)

Blue-sensitive silver halide emulsion (B-6c) was prepared similarly to the blue-sensitive silver halide emulsion (B-6b), except that fine gold sulfide particles (60 Å) was replaced by fine gold sulfide particles (30 Å).

Preparation of Blue-Sensitive Silver Halide Emulsion (B-6d)

Blue-sensitive silver halide emulsion (B-6d) was prepared similarly to the blue-sensitive silver halide emulsion (B-6b), except that triphenylphosphine selenide was replaced by 3.0×10⁻⁶ mol/mol·AgX of N,N-dimethylselenourea.

Preparation of Silver Halide Color Photographic Material Preparation of Sample 1001

There was prepared a paper support laminated, on the light-sensitive layer coating side of paper having a weight of 180 g/m², with high density polyethylene, provided that the light-sensitive layer side was laminated with polyethylene melt containing surface-treated anatase type titanium oxide in an amount of 15% by weight. This reflection support was subjected to corona discharge and provided with a gelatin sublayer, and further thereon, the following component layers, as shown below were provided to prepare a silver halide color photographic material Sample 1001.

Coating solutions were prepared according to the following procedure.

1st Layer Coating Solution

To 3.34 g of yellow coupler (Y-1), 10.02 of yellow coupler (Y-2) and 1.67 g of yellow coupler (Y-3), 1,67 g of dye image stabilizer (ST-1), 1,67 g of dye image stabilizer (ST-2), 3.34 g of dye image stabilizer (ST-5), 0.167 g of antistaining agent (HQ-1), 2.67 g of image stabilizer A, 1.34 g of image stabilizer B, 5.0 g of high boiling organic solvent (DBP) and 1.67 g of high boiling solvent (DNP) was added 60 ml of ethyl acetate. Using an ultrasonic homogenizer, the resulting solution was dispersed in 320 ml of an aqueous 7% gelatin solution containing 5 ml of an aqueous 20% surfactant (SU-1) solution to obtain a yellow coupler emulsified dispersion. The obtained dispersion was mixed with the blue-sensitive silver halide emulsion (B-1a) to prepare a 1st layer coating solution.

2nd to 7th Layer Coating Solution

Coating solutions for the 2nd layer to 7th layer were each prepared similarly to the 1st layer coating solution, and the respective coating solutions were coated so as to have a coating amount as shown below.

Hardeners (H-1) and (H-2) were incorporated into the 2nd, 4th and 7th layers. There were also incorporated surfactants, (SU-2) and (SU-3) as a coating aid to adjust surface tension. Further to each layer was a fungicide (F-1) so as to have a total amount of 0.04/m². The amount of silver halide contained in the respective layers was represented by equivalent converted to silver. Additives used in sample 101 are as follows:

SU-1: Sodium tri-i-propylnaphthalenesulfonate

SU-2: Di(2-ethylhexyl) sulfosuccinate sodium salt

SU-3: 2,2,3,3,4,4,5,5-Octafluoropentyl sulfosuccinate sodium salt

DBP: Dibutyl phthalate

DNP: Dinonyl phthalate

DOP: Dioctyl phthalate

DIDP: Diisodecyl phthalate

H-1: Tetrakis(vinylsulfonylmethyl)methane

H-2: 2,4-Dichloro-6-hydroxy-s-triazine sodium salt

HQ-1: 2,5-di-t-octylhhydroquinone

HQ-2: 2,5-di-sec-dodecylhydroquinone

HQ-3: 2,5di-sec-tetradecylhydroquinone

HQ-4: 2-sec-dodecyl-5-sec-tetradecyhydroquinone

HQ-5: 2,5-di[1,1-dimethyl-4-hexyloxycarbonyl)butyl]-hydroquinone

Image stabilizer A: p-t-Octylphenol

Image stabilizer B: poly(t-butylacrylamide)

| Layer | Constitution | Amount (g/m²) |
|---|---|---|
| 7th Layer | Gelatin | 0.70 |
| (Protective layer) | DIDP | 0.002 |
| | DBP | 0.002 |
| | Silicon dioxide | 0.003 |
| 6th Layer | Gelatin | 0.40 |
| (UV absorbing layer) | AI-1 | 0.01 |
| | UV absorbent (UV-1) | 0.07 |
| | UV absorbent (UV-2) | 0.12 |
| | Antistaining agent (HQ-5) | 0.02 |
| 5th Layer | Gelatin | 1.00 |
| (Red-sensitive layer) | Red-sensitive emulsion (R-1a) | 0.17 |
| | Cyan coupler (C-1) | 0.22 |
| | Cyan coupler (C-2) | 0.06 |
| | Dye image stabilizer (ST-1) | 0.06 |
| | Antistaining agent (HQ-1) | 0.003 |
| | DBP | 0.10 |
| | DOP | 0.20 |
| 4th Layer | Gelatin | 0.94 |
| (UV absorbing layer) | AI-1 | 0.02 |
| | UV absorbent (UV-1) | 0.17 |
| | UV absorbent (UV-2) | 0.27 |
| | Antistaining agent (HQ-5) | 0.06 |
| 3rd Layer | Gelatin | 1.30 |
| (Green-sensitive layer) | AI-2 | 0.01 |
| | Green-sensitive Emulsion (G-1a) | 0.12 |
| | Magenta coupler (M-1) | 0.05 |
| | Magenta coupler (M-2) | 0.15 |
| | Dye image stabilizer (ST-3) | 0.10 |
| | Dye image stabilizer (ST-4) | 0.02 |
| | DIDP | 0.10 |
| | DBP | 0.10 |
| 2nd layer | Gelatin | 1.20 |
| (Interlayer) | AI-3 | 0.01 |
| | Antistaining agent (HQ-1) | 0.02 |
| | Antistaining agent (HQ-2) | 0.03 |
| | Antistaining agent (HQ-3) | 0.06 |
| | Antistaining agent (HQ-4) | 0.03 |
| | Antistaining agent (HQ-5) | 0.03 |
| | DIDP | 0.04 |
| | DBP | 0.02 |
| 1st layer | Gelatin | 1.10 |
| (Blue-sensitive layer) | Blue-sensitive Emulsion (B-1a) | 0.24 |
| | Yellow coupler (Y-1) | 0.10 |
| | Yellow coupler (Y-2) | 0.30 |
| | Yellow coupler (Y-3) | 0.05 |
| | Dye image stabilizer (ST-1) | 0.05 |
| | Dye image stabilizer (ST-2) | 0.05 |
| | Dye image stabilizer (ST-5) | 0.10 |
| | Antistaining agent (HQ-1) | 0.005 |
| | Image stabilizer A | 0.08 |
| | Image stabilizer B | 0.04 |
| | DNP | 0.05 |
| | DBP | 0.15 |

| | |
|---|---|
| Support | Polyethylene-laminated paper |
| | containing a small amount of colorant |

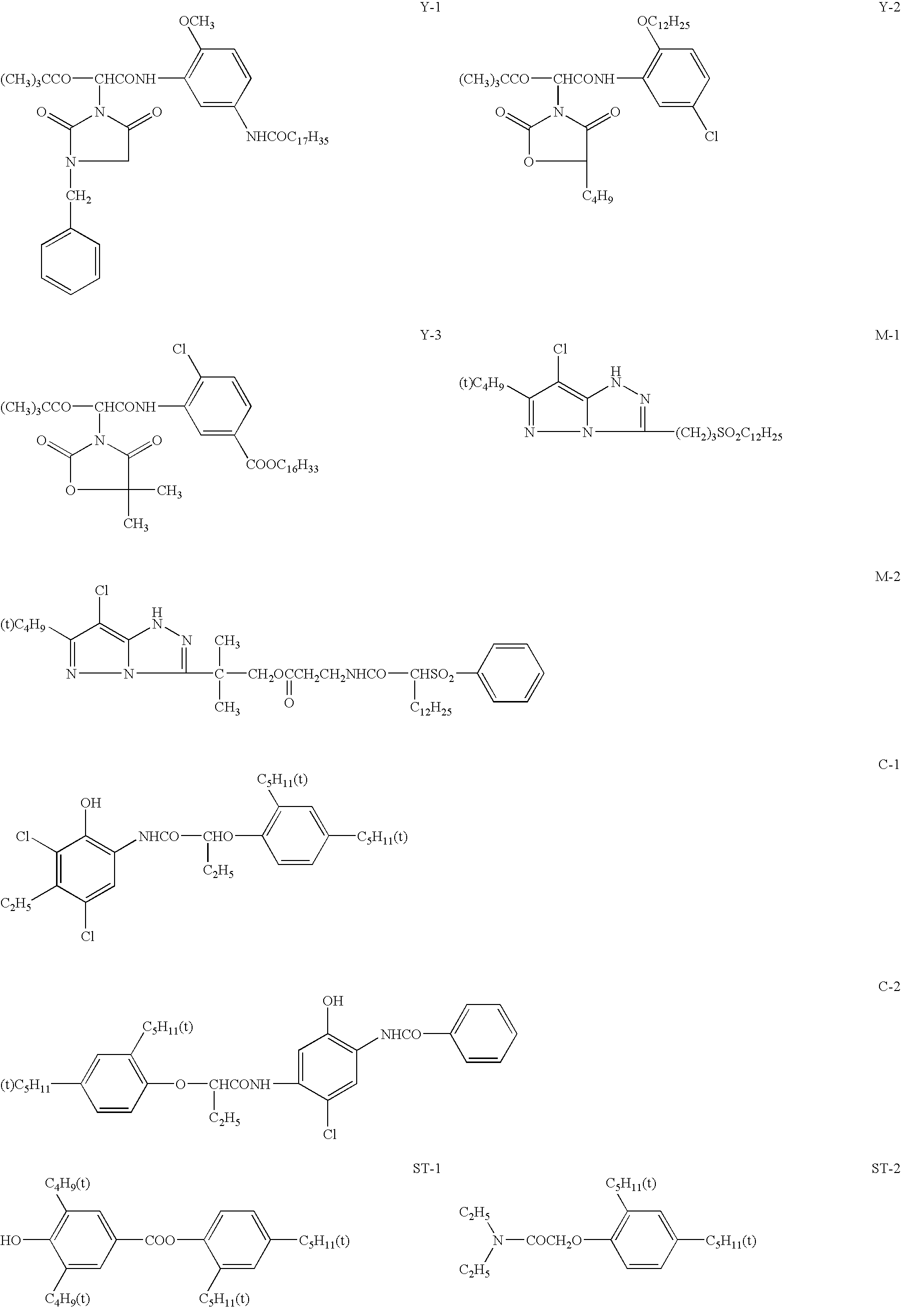

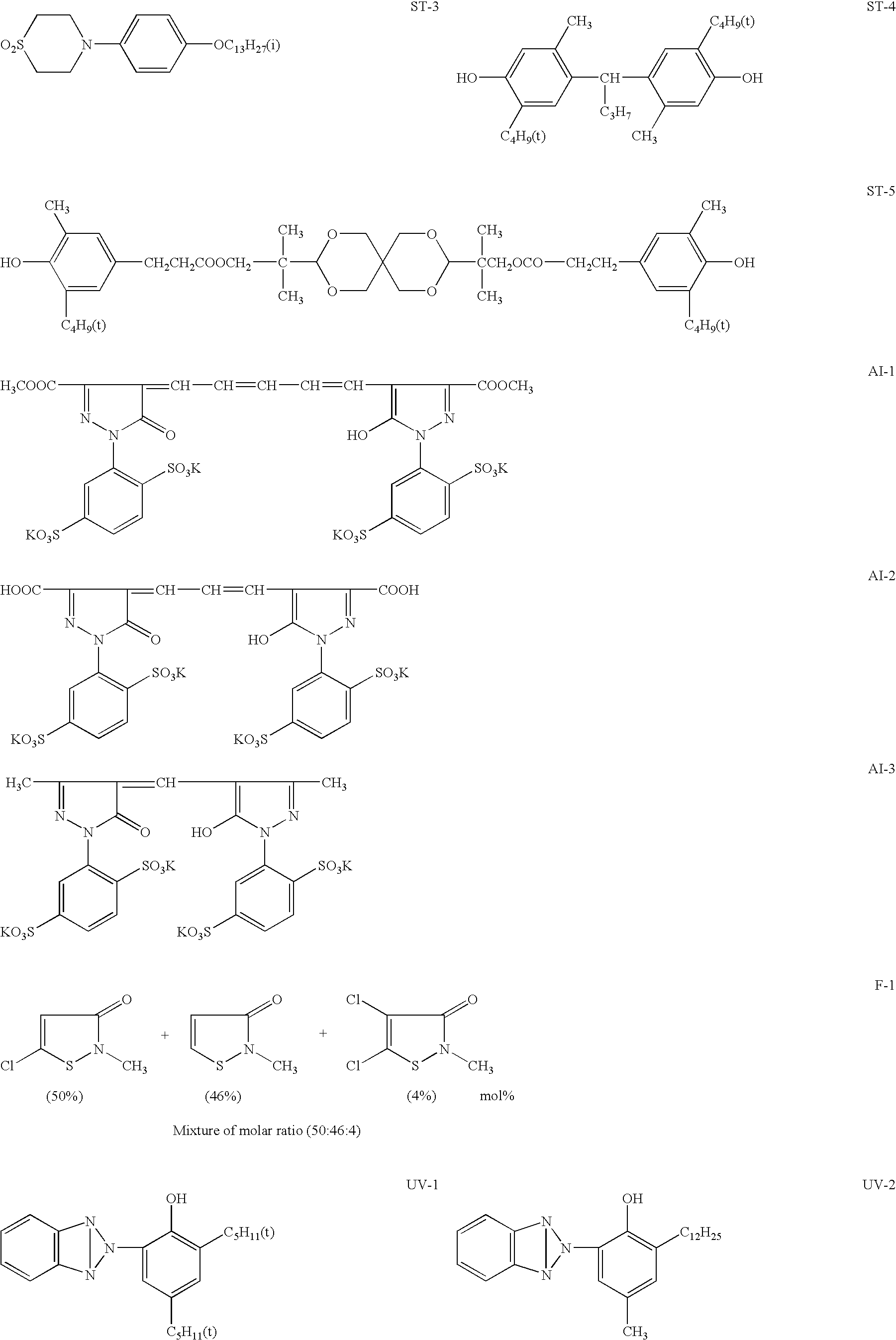

Preparation of Samples 1002 to 1017

Samples 1002 to 1017 were prepared similarly to Sample 1001, except that red-sensitive silver halide emulsion (R-1a), green-sensitive silver halide emulsion (G-1a) and blue-sensitive silver halide emulsion (B-1a) were respectively replaced by silver halide emulsions shown in Table 1.

TABLE 1

| Sample | Silver Halide Emulsion | | | |
|---|---|---|---|---|
| No. | 1st Layer | 3rd Layer | 5th Later | Remark |
| 1001 | B-1a | G-1a | R-1a | Comp. |
| 1002 | B-1b | G-1b | R-1b | Comp. |
| 1003 | B-1c | G-1c | R-1c | Comp. |
| 1004 | B-1d | G-1d | R-1d | Inv. |
| 1005 | B-1e | G-1e | R-1e | Inv. |
| 1006 | B-2a | G-2a | R-2a | Inv. |
| 1007 | B-2b | G-2b | R-2b | Inv. |
| 1008 | B-3a | G-3a | R-3a | Inv. |
| 1009 | B-3b | G-3b | R-3b | Inv. |
| 1010 | B-4a | G-4a | R-4a | Inv. |
| 1011 | B-4b | G-4b | R-4b | Inv. |
| 1012 | B-5a | G-5a | R-5a | Inv. |
| 1013 | B-5b | G-5b | R-5b | Inv. |
| 1014 | B-6a | G-6a | R-6a | Inv. |
| 1015 | B-6b | G-6b | R-6b | Inv. |
| 1016 | B-6c | G-6c | R-6c | Inv. |
| 1017 | B-6d | G-6d | R-6d | Inv. |

Evaluation of Photographic Material

The thus prepared samples 1001 to 1017 were each evaluated with respect to sensitivity, contrast (γ), coating solution stability and latent image stability in accordance with the following procedure.

Evaluation of Sensitivity Contrast (γ) and Latent Image Stability at High Intensity Exposure

Samples were each exposed through an optical wedge to a xenon flash at 10⁻⁶ sec. using a sensitometer for use in high intensity exposure (available from YAMASHITA DENSO Co., Ltd., SX-20 Type). After being allowed to stand for 5 min., exposed samples were processed according to the following color process, which is denoted as process A. Further, at 5 sec after exposed, samples were processed similarly according to the color process, which is denoted as process B. The processed samples were each subjected to densitometry using an optical densitometer(PDA-65 Type, available from Konica Corp.), with respect to magenta reflection image density. Characteristic curves for magenta images, comprising an ordinate (reflection density, D) and an abscissa (exposure, LogE) were prepared and the respective characteristic values were each evaluated as follows.

Sensitivity (or denoted as S) of each sample obtained in the process A was determined according to the equation (1) described below. Sensitivity was represented by a relative value, based on the sensitivity of sample 1001 obtained in the process A being 100.

The contrast in the process A (γa) and contrast in the process B (γb) were determined for each sample according to the equation (2) described below. The contrast was represented by a relative value, based on the contrast in the process A of sample 1001 being 100. Further, variation of contrast (Δγ) was determined according to the equation (3) described below. The value closer to 100 indicates superior latent image stability.

Sensitivity (S)=1/(exposure amount giving a density of fog plus 1.0) (1)

Contrast (γ)=1/[Log(exposure amount giving a density of fog plus 0.8)−Log(exposure amount giving a density of fog plus 1.8) (2)

Δγ=(γb/γa)×100 (3)

Evaluation of Coating Solution Stability.

In samples 1001 to 1017, those which were obtained by coating immediately after the preparation of the respective coating solutions (denoted as coating A) and those which were obtained by coating the respective coating solution after being allowed to stand for 48 hr. at 40° C. (denoted as coating B) were prepared and evaluated with respect to sensitivity and fog density. Sensitivity (S′) and fog density (Fog) for each of samples 1001 to 1017, prepared in coating B were represented by a relative value, based the sensitivity and fog density of the sample prepared in coating A for the respective samples being each 100. The sensitivity or fog density closer to 100 indicates superior coating solution stability.

Color process

| Processsing step | Temperature | Time | Repl. Amt.* |
|---|---|---|---|
| Color developing | 38.0 ± 0.3° C. | 45 sec. | 80 ml |
| Bleach-fixing | 35.0 ± 0.5° C. | 45 sec. | 120 ml |
| Stabilizing | 30-34° C. | 60 sec. | 150 ml |
| Drying | 60-80° C. | 30 sec. | |

*Replenishing amount

Color developer (Tank solution, Replenisher)

| | Tank soln. | Replenisher |
|---|---|---|
| Water | 800 ml | 800 ml |
| Triethylenediamine | 2 g | 3 g |
| Diethylene glycol | 10 g | 10 g |
| Potassium bromide | 0.01 g | — |
| Potassium chloride | 3.5 g | — |
| Potassium sulfite | 0.25 g | 0.5 g |
| N-ethyl-N(β-methanesulfonamidoethyl)- | 6.0 g | 10.0 g |
| 3-methyl-4-aminoaniline sulfate | | |
| N,N-diethylhydroxyamine | 6.8 g | 6.0 g |
| Triethanolamine | 10.0 g | 10.0 g |
| Sodium diethyltriaminepentaacetate | 2.0 g | 2.0 g |
| Brightener (4,4′-diaminostilbene- | 2.0 g | 2.5 g |
| disulfonate derivative) | | |
| Potassium carbonate | 30 g | 30 g |

Water is added to make 1 liter, and the pH of the tank solution and replenisher were respectively adjusted to 10.10 and 10.60 with sulfuric acid or potassium hydroxide.

Bleach-fixer (Tank solution, Replenisher)

| | |
|---|---|
| Ammonium ferric diethyltriaminepentaacetate | 65 g |
| dihydrate | |
| diethyltriaminepentaacetic acid | 3 g |
| Ammonium thiosulfate (70% aqueous solution) | 100 ml |
| 2-Amino-5-mercapto-1,3,4-thiadiazole | 2.0 g |
| Ammonium sulfite (40% aqueous solution) | 27.5 ml |

Water is added to make 1 liter, and the pH is adjusted to 5.0.

Stabilizer (Tank solution, Replenisher)

| | |
|---|---|
| o-Phenylphenol | 1.0 g |
| 5-Chloro-2-methyl-4-isothiazoline-3-one | 0.02 g |
| 2-Methyl-4-isothiazoline-3-one | 0.02 g |
| Diethylene glycol | 1.0 g |
| Brightener (Chinopal SFP) | 2.0 g |
| 1-Hydroxyethylidene-1,1-diphosphonic acid | 1.8 g |
| Bismuth chloride (45% aqueous solution) | 0.65 g |
| Magnesium sulfate heptahydrate | 0.2 g |
| Polyvinyl pyrrolidine (PVP) | 1.0 g |
| Ammonia water (25% aqueous | 2.5 g |
| ammonium hydroxide solution) | |
| Trisodium nitrilotriacetate | 1.5 g |

Water is added to make 1 liter, and the pH is adjusted to 7.5 with sulfuric acid or potassium hydroxide.

The thus obtained results are shown in Table 2.

TABLE 2

| | | | | Coating | | |
|---|---|---|---|---|---|---|
| | | | | Solution | | |
| | | | | Stability | | |
| Sample No. | S | γ | Δγ | S′ | Fog | Remark |
| 1001 | 100 | 100 | 119 | 86 | 123 | Comp. |
| 1002 | 116 | 103 | 118 | 86 | 126 | Comp. |
| 1003 | 121 | 102 | 119 | 88 | 125 | Comp. |
| 1004 | 126 | 112 | 112 | 91 | 113 | Inv. |
| 1005 | 130 | 114 | 112 | 92 | 112 | Inv. |
| 1006 | 131 | 122 | 110 | 92 | 110 | Inv. |
| 1007 | 135 | 122 | 108 | 93 | 110 | Inv. |
| 1008 | 136 | 125 | 108 | 95 | 107 | Inv. |
| 1009 | 140 | 126 | 107 | 95 | 106 | Inv. |
| 1010 | 142 | 129 | 107 | 97 | 103 | Inv. |
| 1011 | 146 | 129 | 106 | 98 | 103 | Inv. |
| 1012 | 147 | 132 | 105 | 98 | 102 | Inv. |
| 1013 | 150 | 132 | 104 | 98 | 102 | Inv. |
| 1014 | 155 | 134 | 103 | 98 | 102 | Inv. |
| 1015 | 158 | 136 | 102 | 99 | 101 | Inv. |
| 1016 | 165 | 137 | 102 | 99 | 101 | Inv. |
| 1017 | 163 | 136 | 102 | 99 | 101 | Inv. |

As apparent from Table 2, it was proved that samples using the silver halide emulsions relating to this invention resulted in enhanced sensitivity (S) and higher contrast (γ) when exposed at a high intensity and improved latent image stability (Δγ) and coating solution stability (S′, Fog).

Furthermore, characteristic curves of yellow and cyan images were prepared for the respective samples and evaluation was similarly made with respect sensitivity, contrast (γ), latent image stability and coating solution stability. As a result, it was proved that samples using the silver halide emulsions relating to this invention led to superior results compared to those using the comparative silver halide emulsions.

### Example 2

Using photographic materials prepared in Example 1, 127 mm wide roll form samples were prepared and evaluated with respect to suitability for digital exposure.

Thus, negative images of processed negative film (Konica Color New CENTURIA 400) were digitized using a film scanner, Q scan 1202JW (available from Konica Corp.) so as to be treatable using computer software, photoshop (Ver. 5.5, available from Adobe Co.). Further to the thus treated images, letters of various sizes and fine lines were added to form image data and operated so as to perform exposure using the following digital scanning exposure apparatus.

As light sources were used a 473 nm laser which was obtained by subjecting YAG solid laser (oscillation wavelength: 946 nm) using semiconductor laser GaAlAs (oscillation wavelength: 808.5 nm) as an exciting light to wavelength conversion by a SHG crystal of KnbO₃; a 532 nm laser which was obtained by subjecting YVO4 solid laser (oscillation wavelength: 1064 nm) using semiconductor laser GaAlAs (oscillation wavelength: 808.7 nm) as an exciting light to wavelength conversion by a SHG crystal of KTP; and AlGaInP laser (oscillation wavelength: 670 nm). There was prepared an apparatus, in which three color laser lights were each moved in the direction vertical to the scanning direction, using a polygon mirror so that scanning exposure was successively performed onto color print paper. The exposure amount was controlled by electrical adjustment of the light quantity of the semiconductor lasers. Scanning exposure was conducted at 400 dpi (dpi represents the number of dots per inch or 2.54 cm) and the exposure time per picture element (or pixel) was 5×10⁻⁸ sec. The exposure amount was adjusted so that the best print images were obtained in the respective samples. After performing scanning exposure, cabinet-size print images were obtained similarly to Example 1, provided that color processing was conducted in accordance with the following process.

Color process

| Processsing step | Temperature | Time | Repl. Amt.* |
|---|---|---|---|
| Color developing | 38.0 ± 0.3° C. | 22 sec. | 81 ml |
| Bleach-fixing | 35.0 ± 0.5° C. | 22 sec. | 54 ml |
| Stabilizing | 30-34° C. | 25 sec. | 150 ml |
| Drying | 60-80° C. | 30 sec. | |

*Replenishing amount

Color developer (Tank solution, Replenisher)

| | Tank soln. | Replenisher |
|---|---|---|
| Water | 800 ml | 800 ml |
| Diethylene glycol | 10 g | 10 g |
| Potassium bromide | 0.01 g | — |
| Potassium chloride | 3.5 g | — |
| Potassium sulfite | 0.25 g | 0.5 g |
| N-ethyl-N(β-methanesulfonamidoethyl)- | 6.0 g | 10.5 g |
| 3-methyl-4-aminoaniline sulfate | | |
| N,N-diethylhydroxyamine | 3.5 g | 6.0 g |
| N,N-bis(2-sulfoethyl)hydroxylamine | 3.5 g | 6.0 g |
| Triethanolamine | 10.0 g | 10.0 g |
| Sodium diethyltriaminepentaacetate | 2.0 g | 2.0 g |
| Brightener (4,4′-diaminostilbene- | 2.0 g | 2.5 g |
| disulfonate derivative) | | |
| Potassium carbonate | 30 g | 30 g |

Water is added to make 1 liter, and the pH of the tank solution and replenisher were respectively adjusted to 10.1 and 10.6 with sulfuric acid or potassium hydroxide.

Bleach-fixer (Tank solution, Replenisher)

| | Tank soln. | Replenisher |
|---|---|---|
| Ammonium ferric diethyltriaminepentaacetate | 100 g | 50 g |
| dihydrate | | |
| diethyltriaminepentaacetic acid | 3 g | 3 g |
| Ammonium thiosulfate (70% aqueous solution) | 200 ml | 100 ml |
| 2-Amino-5-mercapto-1,3,4-thiadiazole | 2.0 g | 1.0 g |
| ammonium sulfite (40% aqueous solution) | 50 ml | 25 ml |

Water is added to make 1 liter, and the pH is adjusted to 7.0 with potassium carbonate or glacial acetic acid.

Stabilizer (Tank solution, Replenisher)

| | |
|---|---|
| o-Phenylphenol | 1.0 g |
| 5-Chloro-2-methyl-4-isothiazoline-3-one | 0.02 g |
| 2-Methyl-4-isothiazoline-3-one | 0.02 g |
| Diethylene glycol | 1.0 g |
| Brightener (Chinopal SFP) | 2.0 g |
| 1-Hydroxyethylidene-1,1-diphosphonic acid | 1.8 g |
| PVP | 1.0 g |
| Ammonia water (25% aqueous | 2.5 g |
| ammonium hydroxide solution) | |
| Ethylenediaminetetraacetic acid | 1.0 g |
| Ammonium sulfite (40% aqueous solution) | 10 ml |

Water is added to make 1 liter, and the pH is adjusted to 7.5 with sulfuric acid or potassium hydroxide.

The thus obtained print images were visually evaluated by 20 observers with respect to clearness of fine lines and letters, human skin tone reproduction and color reproduction of green foliage. Further, 100 sheets were exposed for each sample and successively processed. The first and 100th prints were evaluated with respect to print reproducibility, based on the following criteria.

(1) Clearness of Fine Line and Letter

A: neutral fine lines and letters were clearly distinguishable

B: neutral fine lines and letters were clearly distinguishable but outlines becoming slightly blurred

C: neutral fine lines and letters were clearly distinguishable but blurred

D: neutral fine lines and letters were blurred and undistinguishable.

(2) Human Skin Tone Reproduction

A: bright and natural reproduction;

B: natural reproduction;

C: being slightly muted;

D: being muted.

(3) Color Reproduction of Green Foliage

A: bright and clear reproduction

B: clear reproduction

C: slightly muted reproduction;

D: definitely muted reproduction

(4) Print Reproducibility

A: no difference in prints ere noticed;

B: slight difference in prints were noticed but treated as the same;

C: some differences in prints were noticed and weighed;

D: clear differences in prints were noticed and unacceptable in practice

Evaluation results are shown in Table 3. As is apparent from Table 3, it was proved that samples relating to this invention exhibited superior performance with respect to clearness of fine lines and letters, human skin tone reproduction, color reproduction of green foliage and print reproducibility.

TABLE 3

| | Clearness | Skin | Re- | | |
|---|---|---|---|---|---|
| | of Fine | Tone | production | Print | |
| Sample | Line and | Re- | of Leaves | re- | |
| No. | Letter | production | Green | producibility | Remark |
| 1001 | D | D | D | D | Comp. |
| 1002 | D | D | C | D | Comp. |
| 1003 | C | D | C | C | Comp. |
| 1004 | B | C | B | B | Inv. |
| 1005 | B | C | B | B | Inv. |
| 1006 | B | B | A | A | Inv. |
| 1007 | B | B | A | A | Inv. |
| 1008 | A | B | A | A | Inv. |
| 1009 | A | B | A | A | Inv. |
| 1010 | A | B | A | A | Inv. |
| 1011 | A | B | A | A | Inv. |
| 1012 | A | B | A | A | Inv. |
| 1013 | A | B | A | A | Inv. |
| 1014 | A | B | A | A | Inv. |
| 1015 | A | B | A | A | Inv. |
| 1016 | A | B | A | A | Inv. |
| 1017 | A | B | A | A | Inv. |

### Example 3

From negative images of processed negative film (Konica Color New CENTURIA 400), positive images of processed reversal film (Konica Chrome SINBI 1200 High Quality) and photographing image data taken by a digital camera Digital Revio KD-200Z (available from Konica Corp.), print images were obtained in accordance with the following procedure.

There were prepared roll form samples of 127 mm width, using photographic materials prepared in Example 1. The samples were exposed and processed in Konica digital minilab system QD-21 SUPER (in which print processor QDP-1500 SUPER and processing chemicals ECOJET-HQA-P were employed and processing is conducted in accordance with process CPK-HQA-P). The obtained print samples were evaluated similarly to Example 2. Results thereof are shown in Table 4. Similarly to Example 2, it was proved that samples relating to this invention achieved superior effects.

TABLE 4

| | Clearness | Skin | Re- | | |
|---|---|---|---|---|---|
| | of Fine | Tone | production | Print | |
| Sample | Line and | Re- | of Leaves | re- | |
| No. | Letter | production | Green | producibility | Remark |
| 1001 | D | D | D | D | Comp. |
| 1002 | C | D | D | D | Comp. |
| 1003 | C | D | C | C | Comp. |
| 1004 | B | C | B | B | Inv. |
| 1005 | B | C | B | B | Inv. |
| 1006 | A | B | B | A | Inv. |
| 1007 | A | B | B | A | Inv. |
| 1008 | A | B | A | A | Inv. |
| 1009 | A | B | A | A | Inv. |
| 1010 | A | B | A | A | Inv. |
| 1011 | A | B | A | A | Inv. |
| 1012 | A | B | A | A | Inv. |
| 1013 | A | B | A | A | Inv. |
| 1014 | A | B | A | A | Inv. |
| 1015 | A | B | A | A | Inv. |
| 1016 | A | B | A | A | Inv. |
| 1017 | A | B | A | A | Inv. |

### Example 4

Preparation of Red-Sensitive Silver Halide Emulsion (R-11a)

To the foregoing silver halide emulsion (R-1) prepared in Example 1, sensitizing dyes (RS-1) and (RS-2) were added at 60° C., a pH of 5.0 and a pAg of 7.1 and subsequently, sodium thiosulfate and chloroauric acid were added to perform spectral sensitization and chemical sensitization. Following the addition of chemical sensitizers and when optimally ripened, compound (S-2-5) was added to stop ripening. There was thus obtained red-sensitive silver halide emulsion (R-11a).

| | |
|---|---|
| Sodium thiosulfate | 1.2 × 10⁻⁵ mol/mol AgX |
| Chloroauric acid | 1.5 × 10⁻⁵ mol/mol AgX |
| Compound S-2-5 | 1.5 × 10⁻⁴ mol/mol AgX |
| Sensitizing dye RS-1 | 1.0 × 10⁻⁴ mol/mol AgX |
| Sensitizing dye RS-2 | 1.0 × 10⁻⁴ mol/mol AgX |

Preparation of Red-Sensitive Silver Halide Emulsion (R-11b)

Red-sensitive silver halide emulsion (R-11b) was prepared similarly to the foregoing red-sensitive silver halide emulsion (R-11a), except that the amount of sodium thiosulfate added was changed to 9.0×10⁻⁶ mol/mol·AgX and after the addition of sodium thiosulfate, 3.0×10⁻⁶ mol/mol·AgX of triphenylphosphine selenide was added and then, chloroauric acid was further added thereto.

Preparation of Red-Sensitive Silver Halide Emulsion (R-11c)

Red-sensitive silver halide emulsion (R-11c) was prepared similarly to the red-sensitive silver halide emulsion (R-11a), except that the amount of sodium thiosulfate added was changed to 9.0×10⁻⁶ mol/mol·AgX and after the addition of sodium thiosulfate, 3.0×10⁻⁶ mol/mol·AgX of trifurylphosphine selenide was added and then, chloroauric acid was further added thereto.

Preparation of Red-Sensitive Silver Halide Emulsion (R-11d)

Red-sensitive silver halide emulsion (R-11d) was prepared similarly to the red-sensitive silver halide emulsion (R-11c), except that 1.0×10⁻⁴ mol/mol·AgX of compound (S-1-4) was added before adding sensitizing dyes (RS-1) and (RS-2).

Preparation of Red-Sensitive Silver Halide Emulsion (R-11e)

Red-sensitive silver halide emulsion (R-11e) was prepared similarly to the red-sensitive silver halide emulsion (R-11c), except that 1.0×10⁻⁴ mol/mol·AgX of compound (S-2-5) was added before adding sensitizing dyes (RS-1) and (RS-2).

Preparation of Red-Sensitive Silver Halide Emulsion (R-12a), (R-13a), (R-14a) (R-15a) and (R-16a)

Similarly to the red-sensitive silver halide emulsion (R-11d), red-sensitive silver halide emulsions (R-12a), (R-13a), (R-14a) (R-15a) and (R-16a) were prepared using the foregoing silver halide emulsions (R-2), (R-3), (R-4), (R-5) and (R-6), respectively, in place of emulsion (R-1).

Preparation of Red-Sensitive Silver Halide Emulsion (R-12b), (R-13b), (R-14b) (R-15b) and (R-16b)

Similarly to the red-sensitive silver halide emulsion (R-11e), red-sensitive silver halide emulsions (R-12b), (R-13b), (R-14b) (R-15b) and (R-16b) were prepared using silver halide emulsions (R-2), (R-3), (R-4), (R-5) and (R-6), respectively, in place of emulsion (R-1).

Preparation of Red-Sensitive Silver Halide Emulsion (R-16c)

Red-sensitive silver halide emulsion (R-16c) was prepared similarly to the red-sensitive silver halide emulsion (R-11a), except that silver halide emulsion (R-1) was replaced by emulsion (R-6), the amount of sodium thiosulfate was changed to 9.0×10⁻⁶ mol/mol·AgX, 3.0×10⁻⁶ mol/mol·Agx of N,N-dimethylselenourea was added after the addition of sodium thiosulfate, then chloroauric acid was added and 1.0×10⁻⁴ mol/mol·AgX of compound (S-2-5) was added before the addition of sensitizing dyes (RS-1) and (RS-2).

In the foregoing preparation of red-sensitive silver halide emulsions, 2.0×10⁻³ mol/mol·AgX of SS-1 was added.

Preparation of Green-Sensitive Silver Halide Emulsion (G-11a)

To the foregoing silver halide emulsion (G-1) prepared in Example 1, sensitizing dye (GS-1) was added at 60° C., a pH of 5.8 and a pAg of 7.5 and subsequently, sodium thiosulfate and chloroauric acid were added to perform spectral sensitization and chemical sensitization. Following the addition of chemical sensitizers and when optimally ripened, compound (S-2-5) was added to stop ripening. There was thus obtained green-sensitive silver halide emulsion (G-11a).

| | |
|---|---|
| Sensitizing dye GS-1 | 4.0 × 10⁻⁴ mol/mol AgX |
| Sodium thiosulfate | 4.0 × 10⁻⁶ mol/mol AgX |
| Chloroauric acid | 1.5 × 10⁻⁵ mol/mol AgX |
| Compound S-2-5 | 1.5 × 10⁻⁴ mol/mol AgX |

Preparation of Green-Sensitive Silver Halide Emulsion (G-11b)

Green-sensitive silver halide emulsion (G-11b) was prepared similarly to the foregoing red-sensitive silver halide emulsion (G-11a), except that the amount of sodium thiosulfate added was changed to 1.5×10⁻⁶ mol/mol·AgX and after the addition of sodium thiosulfate, 2.5×10⁻⁶ mol/mol·AgX of triphenylphosphine selenide was added and then, chloroauric acid was further added thereto.

Preparation of Green-Sensitive Silver Halide Emulsion (G-11c)

Green-sensitive silver halide emulsion (G-11c) was prepared similarly to the green-sensitive silver halide emulsion (G-11a), except that the amount of sodium thiosulfate added was changed to 1.5×10⁻⁶ mol/mol·AgX and after the addition of sodium thiosulfate, 2.5×10⁻⁶ mol/mol·AgX of trifurylphosphine selenide was added and then, chloroauric acid was further added thereto.

Preparation of Green-Sensitive Silver Halide Emulsion (G-11d)

Green-sensitive silver halide emulsion (G-11d) was prepared similarly to the green-sensitive silver halide emulsion (G-11c), except that 1.0×10⁻⁴ mol/mol·AgX of compound (S-1-4) was added before adding sensitizing dye (GS-1).

Preparation of Green-Sensitive Silver Halide Emulsion (G-11e)

Green-sensitive silver halide emulsion (G-11e) was prepared similarly to the green-sensitive silver halide emulsion (G-11c), except that 1.0×10⁻⁴ mol/mol·AgX of compound (S-2-5) was added before adding sensitizing dye (RS-1).

Preparation of Green-Sensitive Silver Halide Emulsion (G-12a), (G-13a), (G-14a) (G-15a) and (g-16a)

Similarly to the green-sensitive silver halide emulsion (G-11d), green-sensitive silver halide emulsions (G-12a), (G-13a), (G-14a) (G-15a) and (G-16a) were prepared using the foregoing silver halide emulsions (G-2), (G-3), (G-4), (G-5) and (G-6), respectively, in place of emulsion (G-1).

Preparation of Green-Sensitive Silver Halide Emulsion (G-12b), (G-13b), (G-14b) (G-15b) and (G-16b)

Similarly to the green-sensitive silver halide emulsion (G-11e), green-sensitive silver halide emulsions (G-12b), (G-13b), (G-14b) (G-15b) and (G-16b) were prepared using silver halide emulsions (G-2), (G-3), (G-4), (G-5) and (G-6), respectively, in place of emulsion (G-1).

Preparation of Green-Sensitive Silver Halide Emulsion (G-16c)

Green-sensitive silver halide emulsion (G-16c) was prepared similarly to the green-sensitive silver halide emulsion (G-11a), except that silver halide emulsion (G-1) was replaced by emulsion (G-6), the amount of sodium thiosulfate was changed to 1.5×10⁻⁶ mol/mol·AgX, 2.5×10⁻⁶ mol/mol·Agx of N,N-dimethylselenourea was added after the addition of sodium thiosulfate, then chloroauric acid was added and 1.0×10⁻⁴ mol/mol·AgX of compound (S-2-5) was added before the addition of sensitizing dye (GS-1).

Preparation of Blue-Sensitive Silver Halide Emulsion (B-11a)

To the foregoing silver halide emulsion (B-1) prepared in Example 1, sensitizing dyes (BS-1) and (BS-2) were added at 60° C., a pH of 5.8 and a pAg of 7.5 and subsequently, sodium thiosulfate and chloroauric acid were added to perform spectral sensitization and chemical sensitization. Following the addition of chemical sensitizers and when optimally ripened, compounds (S-2-5), (S-2-2) and (S-2-3) were added to stop ripening. There was thus obtained red-sensitive silver halide emulsion (B-11a).

| | |
|---|---|
| Sodium thiosulfate | 5.0 × 10⁻⁶ mol/mol AgX |
| Chloroauric acid | 1.5 × 10⁻⁵ mol/mol AgX |
| Compound S-2-5 | 2.0 × 10⁻⁴ mol/mol AgX |
| Compound S-2-2 | 3.0 × 10⁻⁴ mol/mol AgX |
| Compound S-2-3 | 3.0 × 10⁻⁴ mol/mol AgX |
| Sensitizing dye BS-1 | 4.0 × 10⁻⁴ mol/mol AgX |
| Sensitizing dye BS-2 | 1.0 × 10⁻⁴ mol/mol AgX |

Preparation of Blue-Sensitive Silver Halide Emulsion (B-11b)

Blue-sensitive silver halide emulsion (B-11b) was prepared similarly to the foregoing blue-sensitive silver halide emulsion (B-11a), except that the amount of sodium thiosulfate added was changed to 3.0×10⁻⁶ mol/mol·AgX and after the addition of sodium thiosulfate, 2.0×10⁻⁶ mol/mol·AgX of triphenylphosphine selenide was added and then, chloroauric acid was further added thereto.

Preparation of Blue-Sensitive Silver Halide Emulsion (B-11c)

Blue-sensitive silver halide emulsion (B-11c) was prepared similarly to the blue-sensitive silver halide emulsion (B-11a), except that the amount of sodium thiosulfate added was changed to 3.0×10⁻⁶ mol/mol·AgX and after the addition of sodium thiosulfate, 2.0×10⁻⁶ mol/mol·AgX of trifurylphosphine selenide was added and then, chloroauric acid was further added thereto.

Preparation of Blue-Sensitive Silver Halide Emulsion (B-11d)

Blue-sensitive silver halide emulsion (B-11d) was prepared similarly to the blue-sensitive silver halide emulsion (B-11c), except that 1.0×10⁻⁴ mol/mol·AgX of compound (S-1-4) was added before adding sensitizing dyes (BS-1) and (BS-2).

Preparation of Blue-Sensitive Silver Halide Emulsion (B-11e)

Blue-sensitive silver halide emulsion (B-11e) was prepared similarly to the blue-sensitive silver halide emulsion (B-llc), except that 1.0×10⁻⁴ mol/mol·AgX of compound (S-2-5) was added before adding sensitizing dyes (BS-1) and (BS-2).

Preparation of Blue-Sensitive Silver Halide Emulsion (B-12a), (B-13a), (B-14a) (B-15a) and (B-16a)

Similarly to the blue-sensitive silver halide emulsion (B-11d), blue-sensitive silver halide emulsions (B-12a), (B-13a), (B-14a) (B-15a) and (B-16a) were prepared using the foregoing silver halide emulsions (B-2), (B-3), (B-4), (B-5) and (B-6), respectively, in place of emulsion (B-1).

Preparation of Blue-Sensitive Silver Halide Emulsion (B-12b), (B-13b), (B-14b) (B-15b) and (B-16b)

Similarly to the blue-sensitive silver halide emulsion (B-11e), blue-sensitive silver halide emulsions (B-12b), (B-13b), (B-14b) (B-15b) and (B-16b) were prepared using silver halide emulsions (B-2), (B-3), (B-4), (B-5) and (B-6), respectively, in place of emulsion (B-1).

Preparation of Blue-Sensitive Silver Halide Emulsion (B-16c)

Blue-sensitive silver halide emulsion (B-16c) was prepared similarly to the blue-sensitive silver halide emulsion (B-11a), except that silver halide emulsion (B-1) was replaced by emulsion (B-6), the amount of sodium thiosulfate was changed to 3.0×10⁻⁶ mol/mol·AgX, 2.0×10⁻⁶ mol/mol·Agx of N,N-dimethylselenourea was added after the addition of sodium thiosulfate, then chloroauric acid was added and 1.0×10⁻⁴ mol/mol·AgX of compound (S-2-5) was added before the addition of sensitizing dyes (BS-1) and (BS-2).

Photographic material samples 1101 to 1116 were prepared similarly to sample 1001 of Example 1, provided that silver halide emulsion (B-1a) of the 1st layer, silver halide emulsion (G-1a) of the 3rd layer and silver halide emulsion (R-1a) of the 7th layer were respectively replaced by silver halide emulsions as shown in Table 5. The thus prepared samples were evaluated similarly. Results thereof are shown in Table 6.

TABLE 5

| Sample | Silver Halide Emulsion | | | |
|---|---|---|---|---|
| No. | 1st Layer | 3rd Layer | 5th Layer | Remark |
| 1101 | B-11a | G-11a | R-11a | Comp. |
| 1102 | B-11b | G-11b | R-11b | Comp. |
| 1103 | B-11c | G-11c | R-11c | Comp. |
| 1104 | B-11d | G-11d | R-11d | Inv. |
| 1105 | B-11e | G-11e | R-11e | Inv. |
| 1106 | B-12a | G-12a | R-12a | Inv. |
| 1107 | B-12b | G-12b | R-12b | Inv. |
| 1108 | B-13a | G-13a | R-13a | Inv. |
| 1109 | B-13b | G-13b | R-13b | Inv. |
| 1110 | B-14a | G-14a | R-14a | Inv. |
| 1111 | B-14b | G-14b | R-14b | Inv. |
| 1112 | B-15a | G-15a | R-15a | Inv. |
| 1113 | B-15b | G-15b | R-15b | Inv. |
| 1114 | B-16a | G-16a | R-16a | Inv. |
| 1115 | B-16b | G-16b | R-16b | Inv. |
| 1116 | B-16c | G-16c | R-16c | Inv. |

TABLE 6

| | | | | Coating | | |
|---|---|---|---|---|---|---|
| | | | | Solution | | |
| | | | | Stability | | |
| Sample No. | S | γ | Δγ | S′ | Fog | Remark |
| 1101 | 100 | 100 | 120 | 82 | 123 | Comp. |
| 1102 | 116 | 102 | 122 | 81 | 125 | Comp. |
| 1103 | 119 | 101 | 122 | 83 | 122 | Comp. |
| 1104 | 125 | 107 | 115 | 91 | 112 | Inv. |
| 1105 | 127 | 110 | 113 | 92 | 110 | Inv. |
| 1106 | 130 | 114 | 109 | 92 | 110 | Inv. |
| 1107 | 133 | 117 | 108 | 92 | 109 | Inv. |
| 1108 | 135 | 116 | 106 | 94 | 106 | Inv. |
| 1109 | 137 | 118 | 105 | 94 | 106 | Inv. |
| 1110 | 138 | 117 | 105 | 95 | 105 | Inv. |
| 1111 | 140 | 120 | 105 | 97 | 104 | Inv. |
| 1112 | 145 | 123 | 105 | 97 | 104 | Inv. |
| 1113 | 147 | 125 | 104 | 98 | 104 | Inv. |
| 1114 | 154 | 127 | 104 | 98 | 102 | Inv. |
| 1115 | 158 | 132 | 102 | 99 | 101 | Inv. |
| 1116 | 155 | 130 | 103 | 98 | 101 | Inv. |

As apparent from Table 6, it was proved that samples using the silver halide emulsions relating to this invention resulted in enhanced sensitivity and higher contrast when exposed at a high intensity and improved latent image stability and coating solution stability.

### Example 5

Samples 1101 to 1116 prepared in Example 4 were evaluated similarly to Example 2. Results thereof are shown in Table 7. As can be seen from Table 7, the inventive samples superior results to the comparative samples.

TABLE 7

| | Clearness | Skin | Re- | | |
|---|---|---|---|---|---|
| | of Fine | Tone | production | Print | |
| Sample | Line and | Re- | of Leaves | re- | |
| No. | Letter | production | Green | producibility | Remark |
| 1101 | D | D | D | D | Comp. |
| 1102 | D | D | C | D | Comp. |
| 1103 | C | D | C | C | Comp. |
| 1104 | B | C | B | B | Inv. |
| 1105 | B | C | B | B | Inv. |
| 1106 | B | B | A | A | Inv. |
| 1107 | B | B | A | A | Inv. |
| 1108 | A | B | A | A | Inv. |
| 1109 | A | B | A | A | Inv. |
| 1110 | A | B | A | A | Inv. |
| 1111 | A | B | A | A | Inv. |
| 1112 | A | B | A | A | Inv. |
| 1113 | A | B | A | A | Inv. |
| 1114 | A | B | A | A | Inv. |
| 1115 | A | B | A | A | Inv. |
| 1116 | A | B | A | A | Inv. |

### Example 6

Samples 1101 to 1116 prepared in Example 4 were evaluated similarly to Example 3. Results thereof are shown in Table 8. As can be seen from Table 8, the inventive samples led superior results to the comparative samples.

TABLE 8

| | Clearness | Skin | Re- | | |
|---|---|---|---|---|---|
| | of Fine | Tone | production | Print | |
| Sample | Line and | Re- | of Leaves | re- | |
| No. | Letter | production | Green | producibility | Remark |
| 1101 | D | D | D | D | Comp. |
| 1102 | C | D | D | D | Comp. |
| 1103 | C | D | C | C | Comp. |
| 1104 | B | C | B | B | Inv. |
| 1105 | B | C | B | B | Inv. |
| 1106 | A | B | B | A | Inv. |
| 1107 | A | B | B | A | Inv. |
| 1108 | A | B | A | A | Inv. |
| 1109 | A | B | A | A | Inv. |
| 1110 | A | B | A | A | Inv. |
| 1111 | A | B | A | A | Inv. |
| 1112 | A | B | A | A | Inv. |
| 1113 | A | B | A | A | Inv. |
| 1114 | A | B | A | A | Inv. |
| 1115 | A | B | A | A | Inv. |
| 1116 | A | B | A | A | Inv. |

### Example 7

Preparation of Red-Sensitive Silver Halide Emulsion (R-21a)

To the foregoing silver halide emulsion (R-1) prepared in Example 1, sensitizing dyes (RS-1) and (RS-2) were added at 60° C., a pH of 5.0 and a pAg of 7.1 and subsequently, sodium thiosulfate and chloroauric acid were added to perform spectral sensitization and chemical sensitization. Following the addition of chemical sensitizers and when optimally ripened, compound (S-2-5) was added to stop ripening. There was thus obtained red-sensitive silver halide emulsion (R-21a).

| | |
|---|---|
| Sodium thiosulfate | 1.2 × 10⁻⁵ mol/mol AgX |
| Chloroauric acid | 1.3 × 10⁻⁵ mol/mol AgX |
| Compound S-2-5 | 1.8 × 10⁻⁴ mol/mol AgX |
| Sensitizing dye RS-1 | 1.0 × 10⁻⁴ mol/mol AgX |
| Sensitizing dye RS-2 | 1.0 × 10⁻⁴ mol/mol AgX |

Preparation of Red-Sensitive Silver Halide Emulsion (R-21b)

Red-sensitive silver halide emulsion (R-21b) was prepared similarly to the foregoing red-sensitive silver halide emulsion (R-21a), except that the amount of sodium thiosulfate added was changed to 9.0×10⁻⁶ mol/mol·AgX and after the addition of sodium thiosulfate, 3.0×10⁻⁶ mol/mol·AgX of triphenylphosphine selenide was added and then, chloroauric acid was further added thereto.

Preparation of Red-Sensitive Silver Halide Emulsion (R-21c)

Red-sensitive silver halide emulsion (R-21c) was prepared similarly to the red-sensitive silver halide emulsion (R-21a), except that the amount of sodium thiosulfate added was changed to 9.0×10⁻⁶ mol/mol·AgX and after the addition of sodium thiosulfate, 3.0×10⁻⁶ mol/mol·AgX of trifurylphosphine selenide was added and then, chloroauric acid was further added thereto.

Preparation of Red-Sensitive Silver Halide Emulsion (R-21d)

Red-sensitive silver halide emulsion (R-21d) was prepared similarly to the red-sensitive silver halide emulsion (R-21c), except that 1.0×10⁻⁴ mol/mol·AgX of compound (1-21) was added before adding sensitizing dyes (RS-1) and (RS-2).

Preparation of Red-Sensitive Silver Halide Emulsion (R-21e)

Red-sensitive silver halide emulsion (R-21e) was prepared similarly to the red-sensitive silver halide emulsion (R-21c), except that 1.0×10⁻⁴ mol/mol·AgX of compound (1-2) was added before adding sensitizing dyes (RS-1) and (RS-2).

Preparation of Red-Sensitive Silver Halide Emulsion (R-22a), (R-23a), (R-24a) (R-25a) and (R-26a)

Similarly to the red-sensitive silver halide emulsion (R-21d), red-sensitive silver halide emulsions (R-22a), (R-23a), (R-24a) (R-25a) and (R-26a) were prepared using the foregoing silver halide emulsions (R-2), (R-3), (R-4), (R-5) and (R-6), respectively, in place of emulsion (R-1).

Preparation of Red-Sensitive Silver Halide Emulsion (R-22b), (R-23b), (R-24b) (R-25b) and (R-26b)

Similarly to the red-sensitive silver halide emulsion (R-21e), red-sensitive silver halide emulsions (R-22b), (R-23b), (R-24b) (R-25b) and (R-26b) were prepared using silver halide emulsions (R-2), (R-3), (R-4), (R-5) and (R-6), respectively, in place of emulsion (R-1).

Preparation of Red-Sensitive Silver Halide Emulsion (R-26c)

Red-sensitive silver halide emulsion (R-26c) was prepared similarly to the red-sensitive silver halide emulsion (R-21a), except that silver halide emulsion (R-1) was replaced by emulsion (R-6), the amount of sodium thiosulfate was changed to 9.0×10⁻⁶ mol/mol·AgX, 3.0×10⁻⁶ mol/mol·Agx of N,N-dimethylselenourea was added after the addition of sodium thiosulfate, then chloroauric acid was added and 1.0×10⁻⁴ mol/mol·AgX of compound (1-2) was added before the addition of sensitizing dyes (RS-1) and (RS-2).

Preparation of Red-Sensitive Silver Halide Emulsion (R-26d)

Red-sensitive silver halide emulsion (R-26d) was prepared similarly to the red-sensitive silver halide emulsion (R-26a), except that 1.3×10⁻⁴ mol/mol·AgX of compound (1-2) was added at the time when completing 90% of the chemical ripening time of from the addition of sodium thiosulfate to the addition of compound (S-2-5).

Preparation of Red-Sensitive Silver Halide Emulsion (R-26e)

Red-sensitive silver halide emulsion (R-26e) was prepared similarly to the red-sensitive silver halide emulsion (R-26b), except that 1.3×10⁻⁴ mol/mol·AgX of compound (1-2) was added at the time when completing 90% of the chemical ripening time of from the addition of sodium thiosulfate to the addition of compound (S-2-5).

In the foregoing preparation of red-sensitive silver halide emulsions, 2.0×10⁻³ mol/mol·AgX of SS-1 was added.

Preparation of Green-Sensitive Silver Halide Emulsion (G-21a)

To the foregoing silver halide emulsion (G-1) prepared in Example 1, sensitizing dye (GS-1) was added at 60° C., a pH of 5.8 and a pAg of 7.5 and subsequently, sodium thiosulfate and chloroauric acid were added to perform spectral sensitization and chemical sensitization. Following the addition of chemical sensitizers and when optimally ripened, compound (S-2-5) was added to stop ripening. There was thus obtained green-sensitive silver halide emulsion (G-21a).

| | |
|---|---|
| Sensitizing dye GS-1 | 4.0 × 10⁻⁴ mol/mol AgX |
| Sodium thiosulfate | 4.0 × 10⁻⁶ mol/mol AgX |
| Chloroauric acid | 1.2 × 10⁻⁵ mol/mol AgX |
| Compound S-2-5 | 1.5 × 10⁻⁴ mol/mol AgX |

Preparation of Green-Sensitive Silver Halide Emulsion (G-21b)

Green-sensitive silver halide emulsion (G-21b) was prepared similarly to the foregoing red-sensitive silver halide emulsion (G-21a), except that the amount of sodium thiosulfate added was changed to 1.5×10⁻⁶ mol/mol·AgX and after the addition of sodium thiosulfate, 2.5×10⁻⁶ mol/mol·AgX of triphenylphosphine selenide was added and then, chloroauric acid was further added thereto.

Preparation of Green-Sensitive Silver Halide Emulsion (G-21c)

Green-sensitive silver halide emulsion (G-21c) was prepared similarly to the green-sensitive silver halide emulsion (G-21a), except that the amount of sodium thiosulfate added was changed to 1.5×10⁻⁶ mol/mol·AgX and after the addition of sodium thiosulfate, 2.5×10⁻⁶ mol/mol·AgX of trifurylphosphine selenide was added and then, chloroauric acid was further added thereto.

Preparation of Green-Sensitive Silver Halide Emulsion (G-21d)

Green-sensitive silver halide emulsion (G-21d) was prepared similarly to the green-sensitive silver halide emulsion (G-21c), except that 1.2×10⁻⁴ mol/mol·AgX of compound (1-21) was added before adding sensitizing dye (GS-1).

Preparation of Green-Sensitive Silver Halide Emulsion (G-21e)

Green-sensitive silver halide emulsion (G-21e) was prepared similarly to the green-sensitive silver halide emulsion (G-21c), except that 1.2×10⁻⁴ mol/mol·AgX of compound (1-2) was added before adding sensitizing dye (RS-1).

Preparation of Green-Sensitive Silver Halide Emulsion (G-22a), (G-23a), (G-24a) (G-25a) and (g-26a)

Similarly to the green-sensitive silver halide emulsion (G-21d), green-sensitive silver halide emulsions (G-22a), (G-23a), (G-24a) (G-25a) and (G-26a) were prepared using the foregoing silver halide emulsions (G-2), (G-3), (G-4), (G-5) and (G-6), respectively, in place of emulsion (G-1).

Preparation of Green-Sensitive Silver Halide Emulsion (G-22b), (G-23b), (G-24b) (G-25b) and (G-26b)

Similarly to the green-sensitive silver halide emulsion (G-21e), green-sensitive silver halide emulsions (G-22b), (G-23b), (G-24b) (G-25b) and (G-26b) were prepared using silver halide emulsions (G-2), (G-3), (G-4), (G-5) and (G-6), respectively, in place of emulsion (G-1).

Preparation of Green-Sensitive Silver Halide Emulsion (G-26c)

Green-sensitive silver halide emulsion (G-26c) was prepared similarly to the green-sensitive silver halide emulsion (G-21a), except that silver halide emulsion (G-1) was replaced by emulsion (G-6), the amount of sodium thiosulfate was changed to 1.5×10⁻⁶ mol/mol·AgX, 2.5×10⁻⁶ mol/mol·Agx of N,N-dimethylselenourea was added after the addition of sodium thiosulfate, then chloroauric acid was added and 1.0×10⁻⁴ mol/mol·AgX of compound (1-2) was added before the addition of sensitizing dye (GS-1).

Preparation of Green-Sensitive Silver Halide Emulsion (G-26d)

Green-sensitive silver halide emulsion (G-26d) was prepared similarly to the green-sensitive silver halide emulsion (G-26a), except that 1.0×10⁻⁴ mol/mol·AgX of compound (1-2) was added at the time when completing 90% of the chemical ripening time of from the addition of sodium thiosulfate to the addition of compound (S-2-5).

Preparation of Green-Sensitive Silver Halide Emulsion (G-26e)

Green-sensitive silver halide emulsion (G-26e) was prepared similarly to the green-sensitive silver halide emulsion (G-26b), except that 1.0×10⁻⁴ mol/mol·AgX of compound (1-2) was added at the time when completing 90% of the chemical ripening time of from the addition of sodium thiosulfate to the addition of compound (S-2-5).

Preparation of Blue-Sensitive Silver Halide Emulsion (B-21a)

To the foregoing silver halide emulsion (B-1) prepared in Example 1, sensitizing dyes (BS-1) and (BS-2) were added at 60° C., a pH of 5.8 and a pAg of 7.5 and subsequently, sodium thiosulfate and chloroauric acid were added to perform spectral sensitization and chemical sensitization. Following the addition of chemical sensitizers and when optimally ripened, compounds (S-2-5), (S-2-2) and (S-2-3) were added to stop ripening. There was thus obtained red-sensitive silver halide emulsion (B-21a).

| | |
|---|---|
| Sodium thiosulfate | 5.0 × 10⁻⁶ mol/mol AgX |
| Chloroauric acid | 1.5 × 10⁻⁵ mol/mol AgX |
| Compound S-2-5 | 2.0 × 10⁻⁴ mol/mol AgX |
| Compound S-2-2 | 2.0 × 10⁻⁴ mol/mol AgX |
| Compound S-2-3 | 3.0 × 10⁻⁴ mol/mol AgX |
| Sensitizing dye BS-1 | 4.0 × 10⁻⁴ mol/mol AgX |
| Sensitizing dye BS-2 | 1.0 × 10⁻⁴ mol/mol AgX |

Preparation of Blue-Sensitive Silver Halide Emulsion (B-21b)

Blue-sensitive silver halide emulsion (B-21b) was prepared similarly to the foregoing blue-sensitive silver halide emulsion (B-21a), except that the amount of sodium thiosulfate added was changed to 3.0×10⁻⁶ mol/mol·AgX and after the addition of sodium thiosulfate, 2.0×10⁻⁶ mol/mol·AgX of triphenylphosphine selenide was added and then, chloroauric acid was further added thereto.

Preparation of Blue-Sensitive Silver Halide Emulsion (B-21c)

Blue-sensitive silver halide emulsion (B-21c) was prepared similarly to the blue-sensitive silver halide emulsion (B-21a), except that the amount of sodium thiosulfate added was changed to 3.0×10⁻⁶ mol/mol·AgX and after the addition of sodium thiosulfate, 2.0×10⁻⁶ mol/mol·AgX of trifurylphosphine selenide was added and then, chloroauric acid was further added thereto.

Preparation of Blue-Sensitive Silver Halide Emulsion (B-21d)

Blue-sensitive silver halide emulsion (B-21d) was prepared similarly to the blue-sensitive silver halide emulsion (B-21c), except that 1.0×10⁻⁴ mol/mol·AgX of compound (1-21) was added before adding sensitizing dyes (BS-1) and (BS-2).

Preparation of Blue-Sensitive Silver Halide Emulsion (B-21e)

Blue-sensitive silver halide emulsion (B-21e) was prepared similarly to the blue-sensitive silver halide emulsion (B-21c), except that 1.0×10⁻⁴ mol/mol·AgX of compound (1-2) was added before adding sensitizing dyes (BS-1) and (BS-2).

Preparation of Blue-Sensitive Silver Halide Emulsion (B-22a), (B-23a), (B-24a) (B-25a) and (B-26a)

Similarly to the blue-sensitive silver halide emulsion (B-21d), blue-sensitive silver halide emulsions (B-22a), (B-23a), (B-24a) (B-25a) and (B-26a) were prepared using the foregoing silver halide emulsions (B-2), (B-3), (B-4), (B-5) and (B-6), respectively, in place of emulsion (B-1).

Preparation of Blue-Sensitive Silver Halide Emulsion (B-22b), (B-23b), (B-24b) (B-25b) and (B-26b)

Similarly to the blue-sensitive silver halide emulsion (B-21e), blue-sensitive silver halide emulsions (B-22b), (B-23b), (B-24b) (B-25b) and (B-26b) were prepared using silver halide emulsions (B-2), (B-3), (B-4), (B-5) and (B-6), respectively, in place of emulsion (B-1).

Preparation of Blue-Sensitive Silver Halide Emulsion (B-26c)

Blue-sensitive silver halide emulsion (B-26c) was prepared similarly to the blue-sensitive silver halide emulsion (B-21a), except that silver halide emulsion (B-1) was replaced by emulsion (B-6), the amount of sodium thiosulfate was changed to 3.0×10⁻⁶ mol/mol·AgX, 2.0×10⁻⁶ mol/mol·Agx of N,N-dimethylselenourea was added after the addition of sodium thiosulfate, then chloroauric acid was added and 1.0×10⁻⁴ mol/mol·AgX of compound (1-2) was added before the addition of sensitizing dyes (BS-1) and (BS-2).

Preparation of Blue-Sensitive Silver Halide Emulsion (B-26d)

Blue-sensitive silver halide emulsion (B-26d) was prepared similarly to the blue-sensitive silver halide emulsion (B-26a), except that 1.0×10⁻⁴ mol/mol·AgX of compound (1-2) was added at the time when completing 90% of the chemical ripening time of from the addition of sodium thiosulfate to the addition of compound (S-2-5).

Preparation of Blue-Sensitive Silver Halide Emulsion (B-26e)

Blue-sensitive silver halide emulsion (B-26e) was prepared similarly to the blue-sensitive silver halide emulsion (B-26b), except that 1.0×10⁻⁴ mol/mol·AgX of compound (1-2) was added at the time when completing 90% of the chemical ripening time of from the addition of sodium thiosulfate to the addition of compound (S-2-5).

Photographic material samples 1201 to 1218 were prepared similarly to sample 1001 of Example 1, provided that silver halide emulsion (B-1a) of the 1st layer, silver halide emulsion (G-1a) of the 3rd layer and silver halide emulsion (R-1a) of the 7th layer were respectively replaced by silver halide emulsions as shown in Table 9. The thus prepared samples were similarly evaluated. Results thereof are shown in Table 10.

TABLE 9

| Sample | Silver Halide Emulsion | | | |
|---|---|---|---|---|
| No. | 1st Layer | 3rd Layer | 5th Layer | Remark |
| 1201 | B-21a | G-21a | R-21a | Comp. |
| 1202 | B-21b | G-21b | R-21b | Comp. |
| 1203 | B-21c | G-21c | R-21c | Comp. |
| 1204 | B-21d | G-21d | R-21d | Inv. |
| 1205 | B-21e | G-21e | R-21e | Inv. |
| 1206 | B-22a | G-22a | R-22a | Inv. |
| 1207 | B-22b | G-22b | R-22b | Inv. |
| 1208 | B-23a | G-23a | R-23a | Inv. |
| 1209 | B-23b | G-23b | R-23b | Inv. |
| 1210 | B-24a | G-24a | R-24a | Inv. |
| 1211 | B-24b | G-24b | R-24b | Inv. |
| 1212 | B-25a | G-25a | R-25a | Inv. |
| 1213 | B-25b | G-25b | R-25b | Inv. |
| 1214 | B-26a | G-26a | R-26a | Inv. |
| 1215 | B-26b | G-26b | R-26b | Inv. |
| 1216 | B-26c | G-26c | R-26c | Inv. |
| 1217 | B-26d | G-26d | R-26d | Inv. |
| 1218 | B-26e | G-26e | R-26e | Inv. |

TABLE 10

| | | | | Coating | | |
|---|---|---|---|---|---|---|
| | | | | Solution | | |
| | | | | Stability | | |
| Sample No. | S | γ | Δγ | S′ | Fog | Remark |
| 1201 | 100 | 100 | 127 | 79 | 120 | Comp. |
| 1202 | 114 | 100 | 129 | 79 | 122 | Comp. |
| 1203 | 118 | 102 | 129 | 81 | 119 | Comp. |
| 1204 | 131 | 116 | 112 | 90 | 108 | Inv. |
| 1205 | 130 | 114 | 114 | 90 | 109 | Inv. |
| 1206 | 134 | 117 | 109 | 92 | 108 | Inv. |
| 1207 | 134 | 117 | 110 | 92 | 107 | Inv. |
| 1208 | 136 | 120 | 107 | 93 | 106 | Inv. |
| 1209 | 137 | 119 | 107 | 92 | 106 | Inv. |
| 1210 | 142 | 122 | 105 | 95 | 106 | Inv. |
| 1211 | 142 | 122 | 104 | 95 | 105 | Inv. |
| 1212 | 148 | 124 | 102 | 97 | 104 | Inv. |
| 1213 | 147 | 123 | 103 | 96 | 105 | Inv. |
| 1214 | 153 | 127 | 101 | 98 | 103 | Inv. |
| 1215 | 156 | 128 | 101 | 98 | 103 | Inv. |
| 1216 | 151 | 125 | 103 | 97 | 103 | Inv. |
| 1217 | 162 | 132 | 101 | 99 | 101 | Inv. |
| 1218 | 163 | 133 | 101 | 99 | 101 | Inv. |

As apparent from Table 10, it was proved that samples using the silver halide emulsions relating to this invention resulted in enhanced sensitivity and higher contrast when exposed at a high intensity and improved latent image stability and coating solution stability.

### Example 8

Samples 1201 to 1218 prepared in Example 7 were evaluated similarly to Example 2. Results thereof are shown in Table 11. As can be seen from Table 11, the inventive samples led superior results to the comparative samples.

TABLE 11

| | Clearness | Skin | Re- | | |
|---|---|---|---|---|---|
| | of Fine | Tone | production | Print | |
| Sample | Line and | Re- | of Leaves | re- | |
| No. | Letter | production | Green | producibility | Remark |
| 1201 | D | D | D | D | Comp. |
| 1202 | D | D | C | C | Comp. |
| 1203 | C | D | C | C | Comp. |
| 1204 | B | C | B | B | Inv. |
| 1205 | B | C | B | B | Inv. |
| 1206 | B | B | A | A | Inv. |
| 1207 | B | B | A | A | Inv. |
| 1208 | A | B | A | A | Inv. |
| 1209 | A | B | A | A | Inv. |
| 1210 | A | B | A | A | Inv. |
| 1211 | A | B | A | A | Inv. |
| 1212 | A | B | A | A | Inv. |
| 1213 | A | B | A | A | Inv. |
| 1214 | A | B | A | A | Inv. |
| 1215 | A | B | A | A | Inv. |
| 1216 | A | B | A | A | Inv. |
| 1217 | A | B | A | A | Inv. |
| 1218 | A | B | A | A | Inv. |

### Example 9

Samples 1201 to 1218 prepared in Example 7 were evaluated similarly to Example 3. Results thereof are shown in Table 12. As can be seen from Table 12, the inventive samples led superior results to the comparative samples.

TABLE 12

| | Clearness | Skin | Re- | | |
|---|---|---|---|---|---|
| | of Fine | Tone | production | Print | |
| Sample | Line and | Re- | of Leaves | re- | |
| No. | Letter | production | Green | producibility | Remark |
| 1201 | D | D | D | D | Comp. |
| 1202 | C | D | C | D | Comp. |
| 1203 | C | D | C | C | Comp. |
| 1204 | B | C | B | B | Inv. |
| 1205 | B | C | B | B | Inv. |
| 1206 | A | C | A | B | Inv. |
| 1207 | A | C | A | B | Inv. |
| 1208 | A | B | A | A | Inv. |
| 1209 | A | B | A | A | Inv. |
| 1210 | A | B | A | A | Inv. |
| 1211 | A | B | A | A | Inv. |
| 1212 | A | B | A | A | Inv. |
| 1213 | A | B | A | A | Inv. |
| 1214 | A | B | A | A | Inv. |
| 1215 | A | B | A | A | Inv. |
| 1216 | A | B | A | A | Inv. |
| 1217 | A | B | A | A | Inv. |
| 1218 | A | B | A | A | Inv. |

### Example 10

Preparation of Red-Sensitive Silver Halide Emulsion (R-31a)

To the foregoing silver halide emulsion (R-1) prepared in Example 1, sensitizing dyes (RS-1) and (RS-2) were added at 60° C., a pH of 5.0 and a pAg of 7.1 and subsequently, sodium thiosulfate and chloroauric acid were added to perform spectral sensitization and chemical sensitization. Following the addition of chemical sensitizers and when optimally ripened, compound (S-2-5) was added to stop ripening. There was thus obtained red-sensitive silver halide emulsion (R-31a).

| | |
|---|---|
| Sodium thiosulfate | 1.2 × 10⁻⁵ mol/mol AgX |
| Chloroauric acid | 1.3 × 10⁻⁵ mol/mol AgX |
| Compound S-2-5 | 1.2 × 10⁻⁴ mol/mol AgX |
| Sensitizing dye RS-1 | 1.0 × 10⁻⁴ mol/mol AgX |
| Sensitizing dye RS-2 | 1.0 × 10⁻⁴ mol/mol AgX |

Preparation of Red-Sensitive Silver Halide Emulsion (R-31b)

Red-sensitive silver halide emulsion (R-31b) was prepared similarly to the foregoing red-sensitive silver halide emulsion (R-31a), except that the amount of sodium thiosulfate added was changed to 9.0×10⁻⁶ mol/mol·AgX and after the addition of sodium thiosulfate, 3.0×10⁻⁶ mol/mol·AgX of triphenylphosphine selenide was added and then, chloroauric acid was further added thereto.

Preparation of Red-Sensitive Silver Halide Emulsion (R-31c)

Red-sensitive silver halide emulsion (R-31c) was prepared similarly to the red-sensitive silver halide emulsion (R-31a), except that the amount of sodium thiosulfate added was changed to 9.0×10⁻⁶ mol/mol·AgX and after the addition of sodium thiosulfate, 3.0×10⁻⁶ mol/mol·AgX of trifurylphosphine selenide was added and then, chloroauric acid was further added thereto.

Preparation of Red-Sensitive Silver Halide Emulsion (R-31d)

Red-sensitive silver halide emulsion (R-31d) was prepared similarly to the red-sensitive silver halide emulsion (R-31c), except that 1.0×10⁻⁴ mol/mol·AgX of compound (4-6) was added before adding sensitizing dyes (RS-1) and (RS-2).

Preparation of Red-Sensitive Silver Halide Emulsion (R-31e)

Red-sensitive silver halide emulsion (R-21e) was prepared similarly to the red-sensitive silver halide emulsion (R-31c), except that 1.6×10⁻⁴ mol/mol·AgX of compound (4-0) was added before adding sensitizing dyes (RS-1) and (RS-2).

Preparation of Red-Sensitive Silver Halide Emulsion (R-32a), (R-33a), (R-34a) (R-35a) and (R-36a)

Similarly to the red-sensitive silver halide emulsion (R-31d), red-sensitive silver halide emulsions (R-32a), (R-33a), (R-34a) (R-35a) and (R-36a) were prepared using the foregoing silver halide emulsions (R-2), (R-3), (R-4), (R-5) and (R-6), respectively, in place of emulsion (R-1).

Preparation of Red-Sensitive Silver Halide Emulsion (R-32b), (R-33b), (R-34b) (R-35b) and (R-36b)

Similarly to the red-sensitive silver halide emulsion (R-31e), red-sensitive silver halide emulsions (R-32b), (R-33b), (R-34b) (R-35b) and (R-36b) were prepared using silver halide emulsions (R-2), (R-3), (R-4), (R-5) and (R-6), respectively, in place of emulsion (R-1).

Preparation of Red-Sensitive Silver Halide Emulsion (R-36c)

Red-sensitive silver halide emulsion (R-36c) was prepared similarly to the red-sensitive silver halide emulsion (R-31a), except that silver halide emulsion (R-1) was replaced by emulsion (R-6), the amount of sodium thiosulfate was changed to 9.0×10⁻⁶ mol/mol·AgX, 3.0×10⁻⁶ mol/mol·Agx of N,N-dimethylselenourea was added after the addition of sodium thiosulfate, then chloroauric acid was added and 1.6×10⁻⁴ mol/mol·AgX of compound (4-0) was added before the addition of sensitizing dyes (RS-1) and (RS-2).

Preparation of Red-Sensitive Silver Halide Emulsion (R-36d)

Red-sensitive silver halide emulsion (R-36d) was prepared similarly to the red-sensitive silver halide emulsion (R-36a), except that 1.0×10⁻⁴ mol/mol·AgX of compound (4-0) was added at the time when completing 90% of the chemical ripening time of from the addition of sodium thiosulfate to the addition of compound (S-2-5).

Preparation of Red-Sensitive Silver Halide Emulsion (R-36e)

Red-sensitive silver halide emulsion (R-36e) was prepared similarly to the red-sensitive silver halide emulsion (R-36b), except that 1.3×10⁻⁴ mol/mol·AgX of compound (4-0) was added at the time when completing 90% of the chemical ripening time of from the addition of sodium thiosulfate to the addition of compound (S-2-5).

In the foregoing preparation of red-sensitive silver halide emulsions, 2.0×10⁻³ mol/mol·AgX of SS-1 was added.

Preparation of Green-Sensitive Silver Halide Emulsion (G-31a)

To the foregoing silver halide emulsion (G-1) prepared in Example 1, sensitizing dye (GS-1) was added at 60° C., a pH of 5.8 and a pAg of 7.5 and subsequently, sodium thiosulfate and chloroauric acid were added to perform spectral sensitization and chemical sensitization. Following the addition of chemical sensitizers and when optimally ripened, compound (S-2-5) was added to stop ripening. There was thus obtained green-sensitive silver halide emulsion (G-31a).

| | |
|---|---|
| Sensitizing dye GS-1 | 4.0 × 10⁻⁴ mol/mol AgX |
| Sodium thiosulfate | 4.0 × 10⁻⁶ mol/mol AgX |
| Chloroauric acid | 1.2 × 10⁻⁵ mol/mol AgX |
| Compound S-2-5 | 1.7 × 10⁻⁴ mol/mol AgX |

Preparation of Green-Sensitive Silver Halide Emulsion (G-31b)

Green-sensitive silver halide emulsion (G-31b) was prepared similarly to the foregoing red-sensitive silver halide emulsion (G-31a), except that the amount of sodium thiosulfate added was changed to 1.5×10⁻⁶ mol/mol·AgX and after the addition of sodium thiosulfate, 2.5×10⁻⁶ mol/mol·AgX of triphenylphosphine selenide was added and then, chloroauric acid was further added thereto.

Preparation of Green-Sensitive Silver Halide Emulsion (G-31c)

Green-sensitive silver halide emulsion (G-31c) was prepared similarly to the green-sensitive silver halide emulsion (G-31a), except that the amount of sodium thiosulfate added was changed to 1.5×10⁻⁶ mol/mol·AgX and after the addition of sodium thiosulfate, 2.5×10⁻⁶ mol/mol·AgX of trifurylphosphine selenide was added and then, chloroauric acid was further added thereto.

Preparation of Green-Sensitive Silver Halide Emulsion (G-31d)

Green-sensitive silver halide emulsion (G-31d) was prepared similarly to the green-sensitive silver halide emulsion (G-31c), except that 1.2×10⁻⁴ mol/mol·AgX of compound (4-6) was added before adding sensitizing dye (GS-1).

Preparation of Green-Sensitive Silver Halide Emulsion (G-31e)

Green-sensitive silver halide emulsion (G-31e) was prepared similarly to the green-sensitive silver halide emulsion (G-31c), except that 1.2×10⁻⁴ mol/mol·AgX of compound (4-0) was added before adding sensitizing dye (RS-1).

Preparation of Green-Sensitive Silver Halide Emulsion (G-32a), (G-33a), (G-34a) (G-35a) and (g-36a).

Similarly to the green-sensitive silver halide emulsion (G-31d), green-sensitive silver halide emulsions (G-32a), (G-33a), (G-34a) (G-35a) and (G-36a) were prepared using the foregoing silver halide emulsions (G-2), (G-3), (G-4), (G-5) and (G-6), respectively, in place of emulsion (G-1).

Preparation of Green-Sensitive Silver Halide Emulsion (G-32b), (G-33b), (G-34b) (G-35b) and (G-36b)

Similarly to the green-sensitive silver halide emulsion (G-31e), green-sensitive silver halide emulsions (G-32b), (G-33b), (G-34b) (G-35b) and (G-36b) were prepared using silver halide emulsions (G-2), (G-3), (G-4), (G-5) and (G-6), respectively, in place of emulsion (G-1).

Preparation of Green-Sensitive Silver Halide Emulsion (G-36c)

Green-sensitive silver halide emulsion (G-36c) was prepared similarly to the green-sensitive silver halide emulsion (G-31a), except that silver halide emulsion (G-1) was replaced by emulsion (G-6), the amount of sodium thiosulfate was changed to 1.5×10⁻⁶ mol/mol·AgX, 2.5×10⁻⁶ mol/mol·Agx of N,N-dimethylselenourea was added after the addition of sodium thiosulfate, then chloroauric acid was added and 1.0×10⁻⁴ mol/mol·AgX of compound (4-0) was added before the addition of sensitizing dye (GS-1).

Preparation of Green-Sensitive Silver Halide Emulsion (G-36d)

Green-sensitive silver halide emulsion (G-36d) was prepared similarly to the green-sensitive silver halide emulsion (G-36a), except that 7.0×10⁻⁴ mol/mol·AgX of compound (4-0) was added at the time when completing 90% of the chemical ripening time of from the addition of sodium thiosulfate to the addition of compound (S-2-5).

Preparation of Green-Sensitive Silver Halide Emulsion (G-36e)

Green-sensitive silver halide emulsion (G-36e) was prepared similarly to the green-sensitive silver halide emulsion (G-36b), except that 7.0×10⁻⁴ mol/mol·AgX of compound (4-0) was added at the time when completing 90% of the chemical ripening time of from the addition of sodium thiosulfate to the addition of compound (S-2-5).

Preparation of Blue-sensitive Silver Halide Emulsion (B-31a)

To the foregoing silver halide emulsion (B-1) prepared in Example 1, sensitizing dyes (BS-1) and (BS-2) were added at 60° C., a pH of 5.8 and a pAg of 7.5 and subsequently, sodium thiosulfate and chloroauric acid were added to perform spectral sensitization and chemical sensitization. Following the addition of chemical sensitizers and when optimally ripened, compounds (S-2-5), (S-2-2) and (S-2-3) were added to stop ripening. There was thus obtained red-sensitive silver halide emulsion (B-31a).

| | |
|---|---|
| Sodium thiosulfate | 5.0 × 10⁻⁶ mol/mol AgX |
| Chloroauric acid | 1.9 × 10⁻⁵ mol/mol AgX |
| Compound S-2-5 | 2.0 × 10⁻⁴ mol/mol AgX |
| Compound S-2-2 | 2.0 × 10⁻⁴ mol/mol AgX |
| Compound S-2-3 | 2.0 × 10⁻⁴ mol/mol AgX |
| Sensitizing dye BS-1 | 4.0 × 10⁻⁴ mol/mol AgX |
| Sensitizing dye BS-2 | 1.0 × 10⁻⁴ mol/mol AgX |

Preparation of Blue-Sensitive Silver Halide Emulsion (B-31b)

Blue-sensitive silver halide emulsion (B-31b) was prepared similarly to the foregoing blue-sensitive silver halide emulsion (B-31a), except that the amount of sodium thiosulfate added was changed to 3.0×10⁻⁶ mol/mol·AgX and after the addition of sodium thiosulfate, 2.0×10⁻⁶ mol/mol·AgX of triphenylphosphine selenide was added and then, chloroauric acid was further added thereto.

Preparation of Blue-Sensitive Silver Halide Emulsion (B-31c)

Blue-sensitive silver halide emulsion (B-31c) was prepared similarly to the blue-sensitive silver halide emulsion (B-31a), except that the amount of sodium thiosulfate added was changed to 3.0×10⁻⁶ mol/mol·AgX and after the addition of sodium thiosulfate, 2.0×10⁻⁶ mol/mol·AgX of trifurylphosphine selenide was added and then, chloroauric acid was further added thereto.

Preparation of Blue-Sensitive Silver Halide Emulsion (B-31d)

Blue-sensitive silver halide emulsion (B-31d) was prepared similarly to the blue-sensitive silver halide emulsion (B-31c), except that 8.0×10⁻⁶ mol/mol·AgX of compound (4-6) was added before adding sensitizing dyes (BS-1) and (BS-2).

Preparation of Blue-Sensitive Silver Halide Emulsion (B-31e)

Blue-sensitive silver halide emulsion (B-31e) was prepared similarly to the blue-sensitive silver halide emulsion (B-31c), except that 7.0×10⁻⁶ mol/mol·AgX of compound (4-0) was added before adding sensitizing dyes (BS-1) and (BS-2).

Preparation of Blue-Sensitive Silver Halide Emulsion (B-32a), (B-33a), (B-34a) (B-35a) and (B-36a)

Similarly to the blue-sensitive silver halide emulsion (B-31d), blue-sensitive silver halide emulsions (B-32a), (B-33a), (B-34a) (B-35a) and (B-36a) were prepared using the foregoing silver halide emulsions (B-2), (B-3), (B-4), (B-5) and (B-6), respectively, in place of emulsion (B-1).

Preparation of Blue-Sensitive Silver Halide Emulsion (B-32b), (B-33b), (B-34b) (B-35b) and (B-36b)

Similarly to the blue-sensitive silver halide emulsion (B-31e), blue-sensitive silver halide emulsions (B-32b), (B-33b), (B-34b) (B-35b) and (B-36b) were prepared using silver halide emulsions (B-2), (B-3), (B-4), (B-5) and (B-6), respectively, in place of emulsion (B-1).

Preparation of Blue-Sensitive Silver Halide Emulsion (B-36c)

Blue-sensitive silver halide emulsion (B-36c) was prepared similarly to the blue-sensitive silver halide emulsion (B-31a), except that silver halide emulsion (B-1) was replaced by emulsion (B-6), the amount of sodium thiosulfate was changed to 3.0×10⁻⁶ mol/mol·AgX, 2.0×10⁻⁶ mol/mol·Agx of N,N-dimethylselenourea was added after the addition of sodium thiosulfate, then chloroauric acid was added and 7.0×10⁻⁶ mol/mol·AgX of compound (4-0) was added before the addition of sensitizing dyes (BS-1) and (BS-2).

Preparation of Blue-Sensitive Silver Halide Emulsion (B-36d)

Blue-sensitive silver halide emulsion (B-36d) was prepared similarly to the blue-sensitive silver halide emulsion (B-36a), except that 1.0×10⁻⁶ mol/mol·AgX of compound (4-0) was added at the time when completing 90% of the chemical ripening time of from the addition of sodium thiosulfate to the addition of compound (S-2-5).

Preparation of Blue-Sensitive Silver Halide Emulsion (B-36e)

Blue-sensitive silver halide emulsion (B-36e) was prepared similarly to the blue-sensitive silver halide emulsion (B-36b), except that 1.0×10⁻⁶ mol/mol·AgX of compound (4-0) was added at the time when completing 90% of the chemical ripening time of from the addition of sodium thiosulfate to the addition of compound (S-2-5).

Photographic material samples 1301 to 1318 were prepared similarly to sample 1001 of Example 1, provided that silver halide emulsion (B-1a) of the 1st layer, silver halide emulsion (G-1a) of the 3rd layer and silver halide emulsion (R-1a) of the 7th layer were respectively replaced by silver halide emulsions as shown in Table 13. The thus prepared samples were similarly evaluated. Results thereof are shown in Table 14.

TABLE 13

| Sample | Silver Halide Emulsion | | | |
|---|---|---|---|---|
| No. | 1st Layer | 3rd Layer | 5th Layer | Remark |
| 1301 | B-31a | G-31a | R-31a | Comp. |
| 1302 | B-31b | G-31b | R-31b | Comp. |
| 1303 | B-31c | G-31c | R-31c | Comp. |
| 1304 | B-31d | G-31d | R-31d | Inv. |
| 1305 | B-31e | G-31e | R-31e | Inv. |
| 1306 | B-32a | G-32a | R-32a | Inv. |
| 1307 | B-32b | G-32b | R-32b | Inv. |
| 1308 | B-33a | G-33a | R-33a | Inv. |
| 1309 | B-33b | G-33b | R-33b | Inv. |
| 1310 | B-34a | G-34a | R-34a | Inv. |
| 1311 | B-34b | G-34b | R-34b | Inv. |
| 1312 | B-35a | G-35a | R-35a | Inv. |
| 1313 | B-35b | G-35b | R-35b | Inv. |
| 1314 | B-36a | G-36a | R-36a | Inv. |
| 1315 | B-36b | G-36b | R-36b | Inv. |
| 1316 | B-36c | G-36c | R-36c | Inv. |
| 1317 | B-36d | G-36d | R-36d | Inv. |
| 1318 | B-36e | G-36e | R-36e | Inv. |

TABLE 14

| | | | | Coating | | |
|---|---|---|---|---|---|---|
| | | | | Solution | | |
| | | | | Stability | | |
| Sample No. | S | γ | Δγ | S′ | Fog | Remark |
| 1301 | 100 | 100 | 125 | 77 | 122 | Comp. |
| 1302 | 116 | 101 | 127 | 77 | 125 | Comp. |
| 1303 | 120 | 101 | 127 | 78 | 122 | Comp. |
| 1304 | 131 | 116 | 113 | 87 | 108 | Inv. |
| 1305 | 132 | 115 | 113 | 89 | 108 | Inv. |
| 1306 | 135 | 122 | 112 | 88 | 107 | Inv. |
| 1307 | 135 | 121 | 111 | 88 | 107 | Inv. |
| 1308 | 139 | 122 | 108 | 92 | 106 | Inv. |
| 1309 | 140 | 123 | 108 | 90 | 105 | Inv. |
| 1310 | 143 | 123 | 108 | 96 | 104 | Inv. |
| 1311 | 143 | 123 | 107 | 97 | 104 | Inv. |
| 1312 | 148 | 125 | 104 | 97 | 104 | Inv. |
| 1313 | 149 | 126 | 105 | 96 | 103 | Inv. |
| 1314 | 157 | 131 | 102 | 99 | 102 | Inv. |
| 1315 | 157 | 130 | 102 | 99 | 102 | Inv. |
| 1316 | 153 | 127 | 103 | 98 | 102 | Inv. |
| 1317 | 165 | 132 | 101 | 99 | 101 | Inv. |
| 1318 | 164 | 132 | 101 | 99 | 101 | Inv. |

As apparent from Table 14, it was proved that samples using the silver halide emulsions relating to this invention resulted in enhanced sensitivity and higher contrast when exposed at a high intensity and improved latent image stability and coating solution stability.

### Example 11

Samples 1301 to 1318 prepared in Example 10 were evaluated similarly to Example 2. Results thereof are shown in Table 15. As can be seen from Table 15, the inventive samples led superior results to the comparative samples.

TABLE 15

| | Clearness | | Reproduc- | | |
|---|---|---|---|---|---|
| | of Fine | Skin Tone | tion | | |
| Sample | Line and | Reproduc- | of Leaves | Print | |
| No. | Letter | tion | Green | reproducibility | Remark |
| 1301 | D | D | D | D | Comp. |
| 1302 | C | D | C | D | Comp. |
| 1303 | C | D | C | C | Comp. |
| 1304 | B | C | B | B | Inv. |
| 1305 | B | C | B | B | Inv. |
| 1306 | A | B | A | A | Inv. |
| 1307 | A | B | A | A | Inv. |
| 1308 | A | B | A | A | Inv. |
| 1309 | A | B | A | A | Inv. |
| 1310 | A | B | A | A | Inv. |
| 1311 | A | B | A | A | Inv. |
| 1312 | A | B | A | A | Inv. |
| 1313 | A | B | A | A | Inv. |
| 1314 | A | B | A | A | Inv. |
| 1315 | A | B | A | A | Inv. |
| 1316 | A | B | A | A | Inv. |
| 1317 | A | B | A | A | Inv. |
| 1318 | A | B | A | A | Inv. |

### Example 12

Samples 1301 to 1318 prepared in Example 10 were evaluated similarly to Example 3. Results thereof are shown in Table 16. As can be seen from Table 16, the inventive samples led superior results to the comparative samples.

TABLE 16

| | Clearness | | Reproduc- | | |
|---|---|---|---|---|---|
| | of Fine | Skin Tone | tion | | |
| Sample | Line and | Reproduc- | of Leaves | Print | |
| No. | Letter | tion | Green | reproducibility | Remark |
| 1301 | D | D | D | D | Comp. |
| 1302 | C | D | C | D | Comp. |
| 1303 | C | D | C | C | Comp. |
| 1304 | B | C | B | B | Inv. |
| 1305 | B | C | B | B | Inv. |
| 1306 | A | B | A | A | Inv. |
| 1307 | A | B | A | A | Inv. |
| 1308 | A | B | A | A | Inv. |
| 1309 | A | B | A | A | Inv. |
| 1310 | A | B | A | A | Inv. |
| 1311 | A | B | A | A | Inv. |
| 1312 | A | B | A | A | Inv. |
| 1313 | A | B | A | A | Inv. |
| 1314 | A | B | A | A | Inv. |
| 1315 | A | B | A | A | Inv. |
| 1316 | A | B | A | A | Inv. |
| 1317 | A | B | A | A | Inv. |
| 1318 | A | B | A | A | Inv. |

What is claimed is:

1. A method of preparing a silver halide emulsion comprising silver halide grains containing at least 90 mol % chloride, 0.02 to 5.0 mol % bromide and 0 to 2.0 mol % iodide, based on silver and occluding at least one Group 8 metal compounds and at least one iridium compound, the method comprising the steps of:
(i) forming the silver halide grains by mixing a silver salt and a halide salt in a dispersing medium and
(ii) subjecting the silver formed silver halide grains to selenium sensitization,
wherein in the step (ii), the selenium sensitization is performed in the presence of at least one selected from the group of a compound represented by formula (1), (2) or (3), a compound represented by formula (4), fine grains of at least one of silver sulfide, gold sulfide and silver-gold sulfide, and a compound represented by formula (S):
R—SO₂S—M formula (1)
R₁—SO₂S—R₂ formula (2)
R₃—SO₂S—Lₘ—SSO₂—R₄ formula (3)
wherein R, R₁, R₂, R₃, and R₄ are each an aliphatic group, an aromatic group or a heterocyclic group; M is a cation; L is a divalent linkage group; and m is 0 or 1;
R₁₁—(S)ₘ₁—R₁₂ formula (4)
wherein R₁₁ and R₁₂ are each an aliphatic group, an aromatic group or a heterocyclic group, or R₁₁ and R₁₂ combine with each other to form a ring; m1 is an integer of 2 to 6; 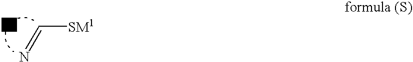
wherein Q is an atomic group necessary to form a 5- or 6-membered nitrogen-containing ring; M¹ is a hydrogen atom, an alkali metal or a cation group.

2. The method of claim 1, wherein the selenium sensitization is performed in the presence of at least one selected from the group of a compound represented by formula (1), (2) or (3).

3. The method of claim 1, wherein the selenium sensitization is performed in the presence of at least one selected from the group of a compound represented by formula (4).

4. The method of claim 1, wherein the selenium sensitization is performed in the presence of fine grains of at least one of silver sulfide, gold sulfide and silver-gold sulfide.

5. The method of claim 1, wherein the selenium sensitization is performed in the presence of a compound represented by formula (S).

6. The method of claim 1, wherein in the step (i), the silver salt and the halide salt are mixed with an iridium coordination complex containing an aqua ligand or an organic ligand.

7. The method of claim 1, wherein in the step (i), the silver salt and the halide salt are mixed with a Group 8 metal compound represented by the following formula (A):
R²¹ₙₐ[M²¹X²¹ₘₐY²¹₆₋ₘₐ] formula (A)
wherein M²¹ is a metal selected from the group consisting of iron, cobalt, ruthenium, iridium, rhodium, osmium and platinum; R²¹ is an alkali metal; “ma” is an integer of 0 to 6 and “na” is an integer of 0 to 4; X²¹ and Y²¹ are each a ligand.

8. The method of claim 1, wherein in the step (i), the silver salt and the halide salt are mixed with a compound represented by the formula (S).

9. The method of claim 8, wherein the compound represented by the formula (S) is a compound represented by the following formula (S-2): 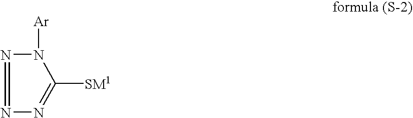
wherein Ar is a group represent by the following formula: 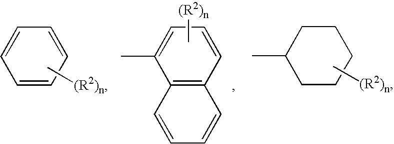
wherein R² is an alkyl group, an alkoxyl group, a carboxyl group or its salt, a sulfo group or its salt, a hydroxyl group, an amino group, an acylamino group, a carbamoyl group or a sulfonamido group; n is an integer of 0 to 2; M¹ is the same as defined in formula (S).

10. A silver halide emulsion comprising silver halide grains
(a) containing at least 90 mol % chloride, 0.02 to 5.0 mol % bromide and 0 to 2.0 mol % iodide, based on silver,
(b) occluding at least one Group 8 metal compound and at least one iridium compound and
(c) the silver halide emulsion being prepared by a process comprising
(i) forming the silver halide grains and
(ii) subjecting the silver halide grains to selenium sensitization, wherein in the step (ii), the selenium sensitization is performed in the presence of at least one selected from the group of a compound represented by formula (1), (2) or (3), a compound represented by formula (4), fine grains of at least one of silver sulfide, gold sulfide and silver-gold sulfide, and a compound represented by formula (S):
R—SO₂S—M formula (1)
R₁—SO₂S—R₂ formula (2)
R₃—SO₂S—Lₘ—SSO₂—R₄ formula (3)
wherein R, R₁, R₂, R₃, and R₄ are each an aliphatic group, an aromatic group or a heterocyclic group; M is a cation; L is a divalent linkage group; and m is 0 or 1;
R₁₁—(S)ₘ₁—R₁₂ formula (4)
wherein R₁₁ and R₁₂ are each an aliphatic group, an aromatic group or a heterocyclic group, or R₁₁ and R₁₂ combine with each other to form a ring; m1 is an integer of 2 to 6; 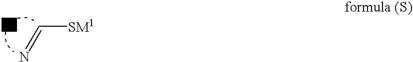
wherein Q is an atomic group necessary to form a 5- or 6-membered nitrogen-containing ring; M¹ is a hydrogen atom, an alkali metal or a cation group.

11. The silver halide emulsion of claim 10, wherein the selenium sensitization is performed in the presence of at least one selected from the group of a compound represented by formula (1), (2) or (3).

12. The silver halide emulsion of claim 10, wherein the selenium sensitization is performed in the presence of at least one selected from the group of a compound represented by formula (4).

13. The silver halide emulsion of claim 10, wherein the selenium sensitization is performed in the presence of fine grains of at least one of silver sulfide, gold sulfide and silver-gold sulfide.

14. The silver halide emulsion of claim 10, wherein the selenium sensitization is performed in the presence of a compound represented by formula (S).

15. The silver halide emulsion of claim 10, wherein the iridium compound is an iridium coordination complex containing an aqua ligand or an organic ligand.

16. The silver halide emulsion of claim 10, wherein the Group 8 metal compound is a compound represented by the following formula (A):
R²¹ₙₐ[M²¹X²¹ₘₐY²¹₆₋ₘₐ] formula (A)
wherein M²¹ is a metal selected from the group consisting of iron, cobalt, ruthenium, iridium, rhodium, osmium and platinum; R²¹ is an alkali metal; “ma” is an integer of 0 to 6 and “na” is an integer of 0 to 4; X²¹ and Y²¹ are each a ligand.

17. The method of claim 1, wherein the silver halide grains each comprise a core and one or more shells and an outermost shell comprises a bromide-localized silver halide phase.

18. The silver halide emulsion of claim 10, wherein the silver halide grain each include an iodide-localized silver halide phase in the interior of the grains.

19. The method of claim 10, wherein the silver halide grains each occlude a compound represented by formula (S).

20. A silver halide photographic material comprising on a support at least one image forming layer, wherein the image forming layer comprises a silver halide emulsion as claimed in claim 10.
